(19) United States
(12) Patent Application Publication
(10) Pub. No.: US 2026/0061627 A1
(43) Pub. Date: Mar. 5, 2026

(54) SCOOP FOR TIDYING ROBOT

(71) Applicant: Clutterbot, Inc., Claymont, DE (US)

(72) Inventor: Justin David Hamilton, Wellington (NZ)

(73) Assignee: Clutterbot, Inc., Claymont, DE (US)

(21) Appl. No.: 19/313,806

(22) Filed: Aug. 28, 2025

Related U.S. Application Data
(60) Provisional application No. 63/688,549, filed on Aug. 29, 2024.

(51) Int. Cl. B25J 11/00; A47L 7/00; A47L 11/28

(52) U.S. Cl. CPC B25J 11/0085; A47L 7/0085; A47L 11/28

(57) ABSTRACT

A scoop for a tidying robot including a scoop base, scoop back, scoop bottom, and scoop bottom linear actuator. The scoop bottom is expandable and includes at least one side that can be extended or retracted using the scoop bottom linear actuator. The scoop can also include foldable walls, a scoop lip, and a front pushing linear actuator to push the scoop bottom forward. The method for using the scoop includes extending the scoop bottom outwards or forwards, loading objects, transporting and unloading the objects, and retracting the scoop bottom.

This application claims the benefit of U.S. provisional patent application Ser. No. 63/688,549, filed on Aug. 29, 2024, the contents of which are incorporated herein by reference in their entirety.

### BACKGROUND

Obstructions or objects underfoot represent not only a nuisance but also a safety hazard. Thousands of people each year are injured in a fall at home. A floor cluttered with loose objects may represent a danger, but many people have limited time in which to address the clutter in their homes. Automated cleaning or tidying robots may represent an effective solution.

Tidying robots conventionally organize objects into standard categories based on an object's type and other attributes that may be determined with classification. However, conventional robotic tidying solutions may be limited in their capabilities, and may be unable to autonomously complete a comprehensive cleaning operation without additional manual work by the user.

There is, therefore, a need for a general purpose tidying robot capable of complex and comprehensive housework operations.

A scoop for a tidying robot, in some embodiments, includes a scoop base that attaches to a scoop arm, a scoop back secured to the base, and a scoop bottom with an expandable section attached to the base. A linear actuator is also provided to extend or retract one side of the expandable scoop bottom.

A method for using this scoop, in some embodiments, involves extending the scoop bottom by activating the linear actuator, which is part of a tidying robot's scoop. The robot's scoop may include a base, a back, and a scoop bottom with an expandable section, and the linear actuator controls the movement of one side of the expandable scoop bottom.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A and FIG. 1B illustrate a tidying robot 100 in accordance with one embodiment. FIG. 1A shows a side view and FIG. 1B shows a top view.

FIG. 2A and FIG. 2B illustrate a simplified side view and top view of a chassis 102 of the tidying robot 100, respectively.

FIG. 3A-FIG. 3D illustrate a tidying robot with a scoop support wheel 300 in accordance with several embodiments.

FIG. 4 illustrates a tidying robot with pad end grippers and an expanding scoop 400 in accordance with one embodiment.

FIG. 5 illustrates an expanding scoop in a collapsed position 500 in accordance with one embodiment.

FIG. 6 illustrates a routine for raising the scoop sides from the collapsed position 600 in accordance with one embodiment.

FIG. 7 illustrates a routine for expanding the scoop capacity from the collapsed position 700 in accordance with one embodiment.

FIG. 8A-FIG. 8H illustrate an expanding scoop 800 in accordance with one embodiment.

FIG. 9 illustrates an expanding scoop 900 in accordance with one embodiment.

FIG. 10 illustrates an expanding scoop 1000 in accordance with one embodiment.

FIG. 11 illustrates an expanding scoop 1100 in accordance with one embodiment.

FIG. 12 illustrates an expanding scoop 1200 in accordance with one embodiment.

FIG. 13 illustrates an expanding scoop 1300 in accordance with one embodiment.

FIG. 14 illustrates a method 1400 in accordance with one embodiment.

FIG. 15 illustrates a method 1500 in accordance with one embodiment.

FIG. 16A and FIG. 16B illustrate a left side view and a top view of a base station 1600, respectively, in accordance with one embodiment.

FIG. 17A illustrates a lowered scoop position and lowered pusher position 1700a for the tidying robot 100 in accordance with one embodiment.

FIG. 17B illustrates a lowered scoop position and raised pusher position 1700b for the tidying robot 100 in accordance with one embodiment.

FIG. 17C illustrates a raised scoop position and raised pusher position 1700c for the tidying robot 100 in accordance with one embodiment.

FIG. 17D illustrates a tidying robot 100 with pusher pads extended 1700d in accordance with one embodiment.

FIG. 17E illustrates a tidying robot 100 with pusher pads retracted 1700e in accordance with one embodiment.

FIG. 18A illustrates a lowered scoop position and lowered pusher position 1800a for the tidying robot 100 in accordance with one embodiment.

FIG. 18B illustrates a lowered scoop position and raised pusher position 1800b for the tidying robot 100 in accordance with one embodiment.

FIG. 18C illustrates a raised scoop position and raised pusher position 1800c for the tidying robot 100 in accordance with one embodiment.

FIG. 19A illustrates a lowered scoop position and lowered pusher position 1900a for the tidying robot 100 in accordance with one embodiment.

FIG. 19B illustrates a lowered scoop position and raised pusher position 1900b for the tidying robot 100 in accordance with one embodiment.

FIG. 19C illustrates a raised scoop position and raised pusher position 1900c for the tidying robot 100 in accordance with one embodiment.

FIG. 20 illustrates a front dump action 2100 for the tidying robot 100 in accordance with one embodiment.

FIG. 21 illustrates a tidying robot 100 performing a front dump in accordance with one embodiment.

FIG. 22 illustrates a tidying robotic system interaction 2200 in accordance with one embodiment.

FIG. 23 illustrates an embodiment of a robotic control system 2300 to implement components and process steps of the system described herein.

FIG. 24 illustrates sensor input analysis 2400 in accordance with one embodiment.

FIG. 25A-FIG. 25E illustrate an obstruction placement procedure 2500 in accordance with one embodiment.

FIG. 26A-FIG. 26E illustrate an obstruction placement procedure 2600 in accordance with one embodiment.

FIG. 27A-FIG. 27D illustrate a process for tidying tidyable objects from a table into a bin 2700 in accordance with one embodiment.

FIG. 28A-FIG. 28D illustrate a portable bin placement procedure 2800 in accordance with one embodiment.

FIG. 29A-FIG. 29C illustrate a process for emptying tidyable objects from a bin and sorting them on the floor 2900 in accordance with one embodiment.

FIG. 30A-FIG. 30H illustrate a process for pre-sweeping a floor 3000 in accordance with one embodiment.

FIG. 31A and FIG. 31B illustrate a process for sweeping in an inverted wedge configuration 3100 in accordance with one embodiment.

FIG. 32A-FIG. 32D illustrate a tidying robot with movable scoop walls 3200 in various configurations in accordance with one embodiment.

FIG. 33A and FIG. 33B illustrate a tidying robot with movable scoop walls 3300 in various configurations in accordance with one embodiment.

FIG. 34A and FIG. 34B illustrate a tidying robot with movable scoop walls 3400 in various configurations in accordance with one embodiment.

FIG. 35A and FIG. 35B illustrate a tidying robot with movable scoop walls 3500 in accordance with one embodiment.

FIG. 36 illustrates a portable bin 3600 in accordance with one embodiment.

FIG. 37 illustrates a portable bin 3700 in accordance with one embodiment.

FIG. 38 illustrates a portable bin 3800 in accordance with one embodiment.

FIG. 39 illustrates a portable bin 3900 in accordance with one embodiment.

FIG. 40 illustrates a portable bin 4000 in accordance with one embodiment.

FIG. 41 illustrates a portable bin 4100 in accordance with one embodiment.

FIG. 42 illustrates a portable bin 4200 in accordance with one embodiment.

FIG. 43 illustrates a portable bin 4300 in accordance with one embodiment.

FIG. 44 illustrates a bin 4400 in accordance with one embodiment.

FIG. 45 illustrates a portable bin 4500 in accordance with one embodiment.

FIG. 46 illustrates a portable bin 4600 in accordance with one embodiment.

FIG. 47 illustrates a portable bin 4700 in accordance with one embodiment.

FIG. 48 illustrates an exemplary multi-stage tidying routine 4800 in accordance with one embodiment.

FIG. 49 illustrates a robot operation state diagram 4900 in accordance with one embodiment.

FIG. 50 depicts another robotic process 5000 in accordance with one embodiment.

FIG. 51 depicts a state space map 5100 for a robotic system in accordance with one embodiment.

FIG. 52 illustrates a routine 5200 in accordance with one embodiment.

FIG. 53 illustrates a basic routine 5300 in accordance with one embodiment.

FIG. 54 illustrates an action plan to move object(s) aside 5400 in accordance with one embodiment.

FIG. 55 illustrates an action plan to pick up objects in path 5500 in accordance with one embodiment.

FIG. 56 illustrates an action plan to drop object(s) at a drop location 5600 in accordance with one embodiment.

FIG. 57 illustrates an action plan to drive around object(s) 5700 in accordance with one embodiment.

FIG. 58 illustrates a capture process 5800 portion of the disclosed algorithm in accordance with one embodiment.

FIG. 59 illustrates a deposition process 5900 portion of the disclosed algorithm in accordance with one embodiment.

FIG. 60A-FIG. 60E illustrate an execution of a vacuuming strategy and tidying strategy 6000 in accordance with one embodiment.

FIG. 61A through FIG. 61D illustrate a pickup strategy for a large, slightly deformable object 6100 in accordance with one embodiment.

FIG. 62 illustrates a video-feed segmentation routine 6200 in accordance with one embodiment.

FIG. 63 illustrates a main navigation, collection, and deposition process 6300 in accordance with one embodiment.

FIG. 64 illustrates strategy steps for isolation strategy, pickup strategy, and drop strategy 6400 in accordance with one embodiment.

FIG. 65 illustrates process for determining an action from a policy 6500 in accordance with one embodiment.

FIG. 66 depicts a robotics system 6600 in accordance with one embodiment.

FIG. 67 depicts a robotic control algorithm 6700 for a robotic system in accordance with one embodiment.

FIG. 68 depicts a robotic control algorithm 6800 for a robotic system in accordance with one embodiment.

FIG. 69 illustrates a system environment 6900 in accordance with one embodiment.

FIG. 70 illustrates a computing environment 7000 in accordance with one embodiment.

FIG. 71 illustrates a set of functional abstraction layers 7100 in accordance with one embodiment.

### DETAILED DESCRIPTION

The disclosed solution illustrated herein and described in detail with respect to the figures referenced below is a general purpose tidying robot. This tidying robot may be configured to open and close cabinets and appliances, move bins and other objects off of and onto shelves and countertops, tidy and organize toys and other objects, vacuum, mop, and perform combinations of these tasks in an order determined by conditions detected in an environment to be tidied. In this disclosure, “configured to” perform a task refers to something physical, such as a device, circuit, memory storing program instructions executable to implement the task, etc.

The drawings in this disclosure may not be to scale, and are not intended to be limiting in size or location of specific elements of the tidying robot unless otherwise specified or claimed herein. One of ordinary skill in the art will realize that various elements may be larger, smaller, further forward, further back, higher, lower, or otherwise sized and located than is shown in the exemplary embodiments provided while remaining capable of performing the functions described herein.

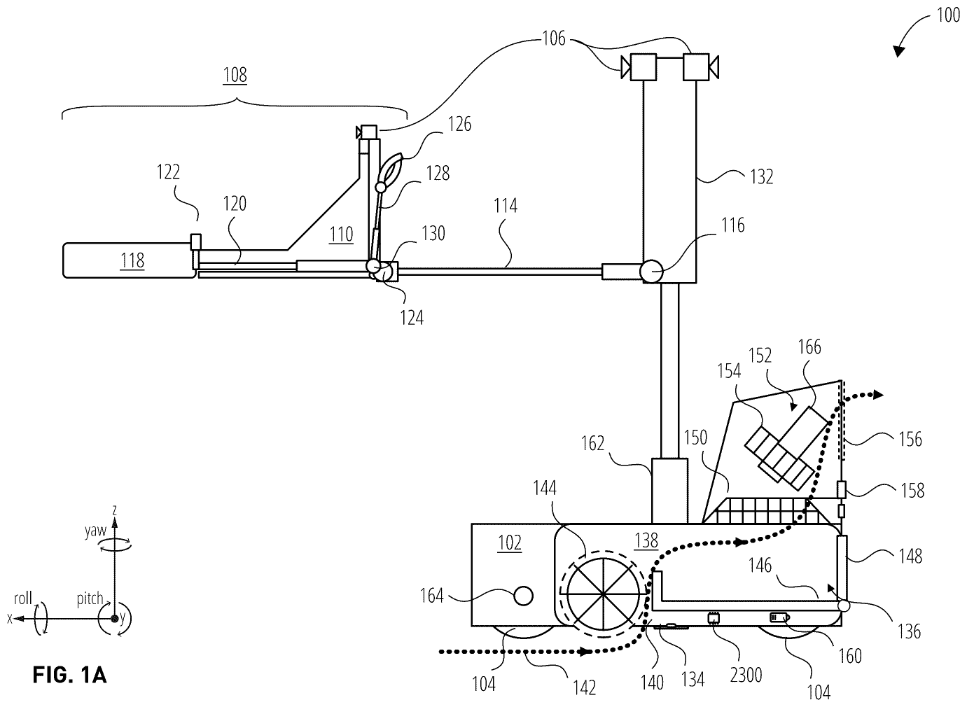

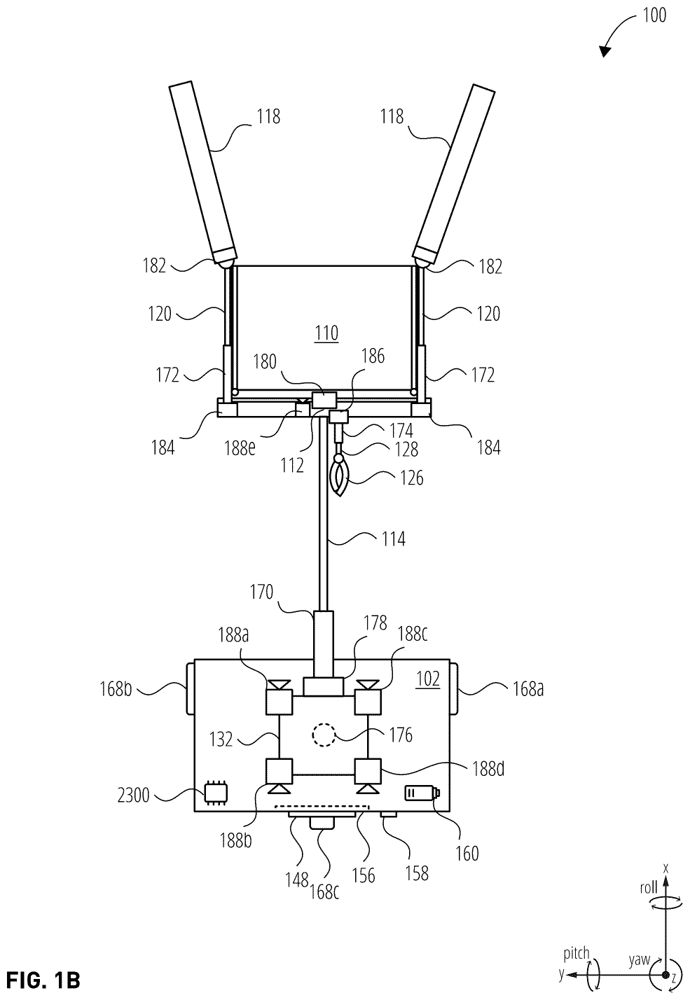

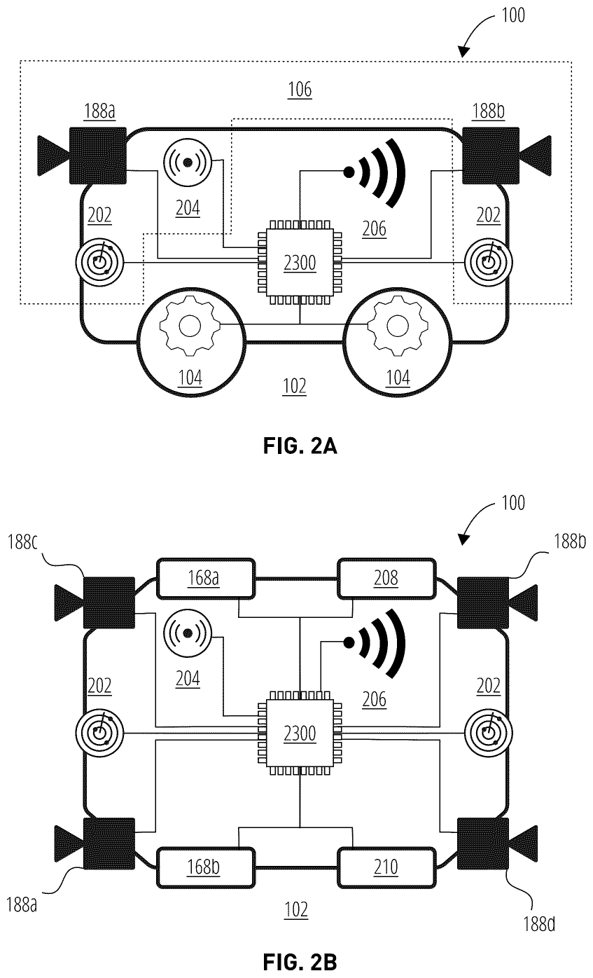

FIG. 1A-FIG. 2B illustrate a tidying robot 100 in accordance with one embodiment. FIG. 1A shows a side view and FIG. 1B shows a top view. The tidying robot 100 may comprise a chassis 102, a mobility system 104, a sensing system 106, a capture and containment system 108, and a robotic control system 2300. The capture and containment system 108 may further comprise a scoop 110, a scoop pivot point 112, a scoop arm 114, a scoop arm pivot point 116, two pusher pads 118 with pad pivot points 122, two pusher pad arms 120 with pad arm pivot points 124, an actuated gripper 126, a gripper arm 128 with a gripper pivot point 130, and a lifting column 132 to raise and lower the capture and containment system 108 to a desired height. In one embodiment, the gripper arm 128 may include features for gripping and/or gripping surfaces in lieu of or in addition to an actuated gripper 126.

The tidying robot 100 may further include a mop pad 134, and robot vacuum system 136. The robot vacuum system 136 may include a vacuum compartment 138, a vacuum compartment intake port 140, a cleaning airflow 142, a rotating brush 144, a dirt collector 146, a dirt release latch 148, a vacuum compartment filter 150, and a vacuum generating assembly 152 that includes a vacuum compartment fan 154, a vacuum compartment motor 166, and a vacuum compartment exhaust port 156. The tidying robot 100 may include a robot charge connector 158, a battery 160, and number of motors, actuators, sensors, and mobility components as described in greater detail below, and a robotic control system 2300 providing actuation signals based on sensor signals and user inputs.

The chassis 102 may support and contain the other components of the tidying robot 100. The mobility system 104 may comprise wheels as indicated, as well as caterpillar tracks, conveyor belts, etc., as is well understood in the art. The mobility system 104 may further comprise motors, servos, or other sources of rotational or kinetic energy to impel the tidying robot 100 along its desired paths. Mobility system 104 components may be mounted on the chassis 102 for the purpose of moving the entire robot without impeding or inhibiting the range of motion needed by the capture and containment system 108. Elements of a sensing system 106, such as cameras, lidar sensors, or other components, may be mounted on the chassis 102 in positions giving the tidying robot 100 clear lines of sight around its environment in at least some configurations of the chassis 102, scoop 110, pusher pad 118, and pusher pad arm 120 with respect to each other.

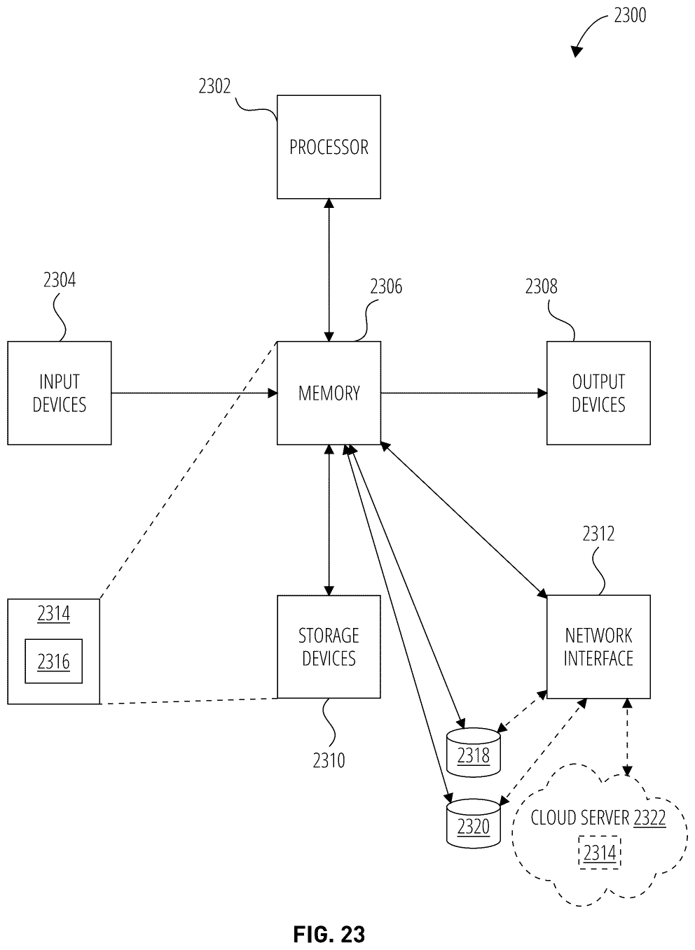

The chassis 102 may house and protect all or portions of the robotic control system 2300, (portions of which may also be accessed via connection to a cloud server) comprising in some embodiments a processor, memory, and connections to the mobility system 104, sensing system 106, and capture and containment system 108. The chassis 102 may contain other electronic components such as batteries 160, wireless communications 206 devices, etc., as is well understood in the art of robotics. The robotic control system 2300 may function as described in greater detail with respect to FIG. 23. The mobility system 104 and or the robotic control system 2300 may incorporate motor controllers used to control the speed, direction, position, and smooth movement of the motors. Such controllers may also be used to detect force feedback and limit maximum current (provide overcurrent protection) to ensure safety and prevent damage.

The capture and containment system 108 may comprise a scoop 110 with an associated scoop motor 180 to rotate the scoop 110 into different positions at the scoop pivot point 112. The capture and containment system 108 may also include a scoop arm 114 with an associated scoop arm motor 178 to rotate the scoop arm 114 into different positions around the scoop arm pivot point 116, and a scoop arm linear actuator 170 to extend the scoop arm 114. Pusher pads 118 of the capture and containment system 108 may have pusher pad motors 182 to rotate them into different positions around the pad pivot points 122. Pusher pad arms 120 may be associated with pusher pad arm motors 184 that rotate them around pad arm pivot points 124, as well as pusher pad arm linear actuators 172 to extend and retract the pusher pad arms 120. The gripper arm 128 may include a gripper arm motor 186 to move the gripper arm 128 around a gripper pivot point 130, as well as a gripper arm linear actuator 174 to extend and retract the gripper arm 128. In this manner the gripper arm 128 may be able to move and position itself and/or the actuated gripper 126 to perform the tasks disclosed herein.

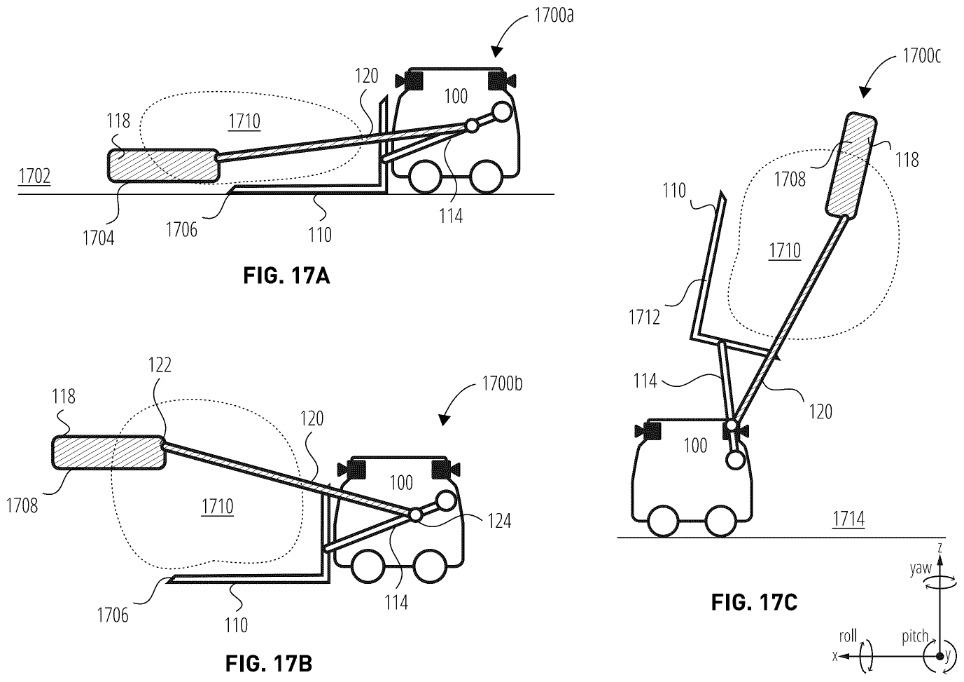

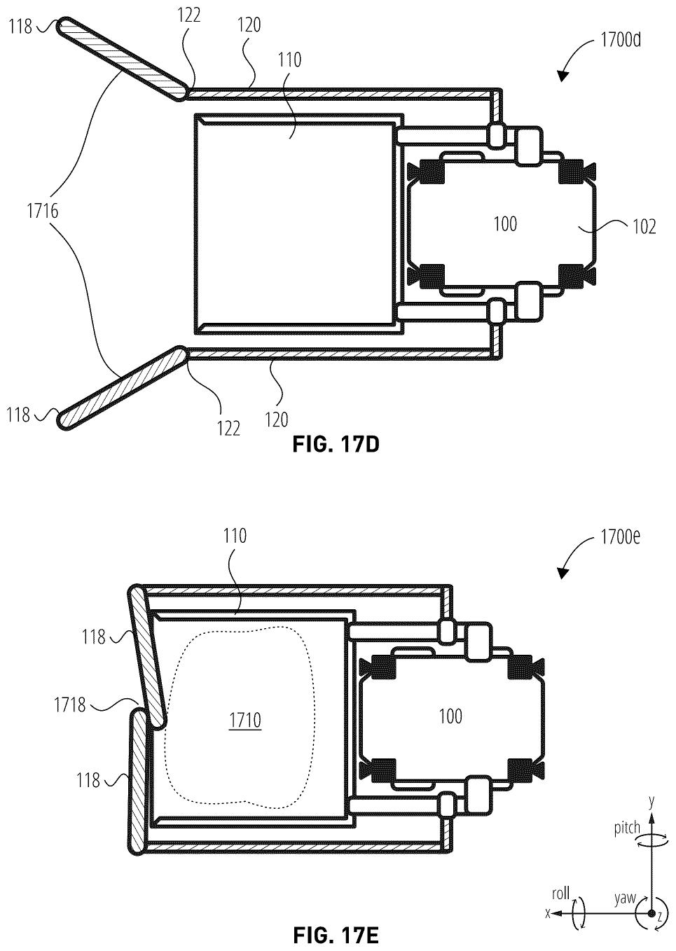

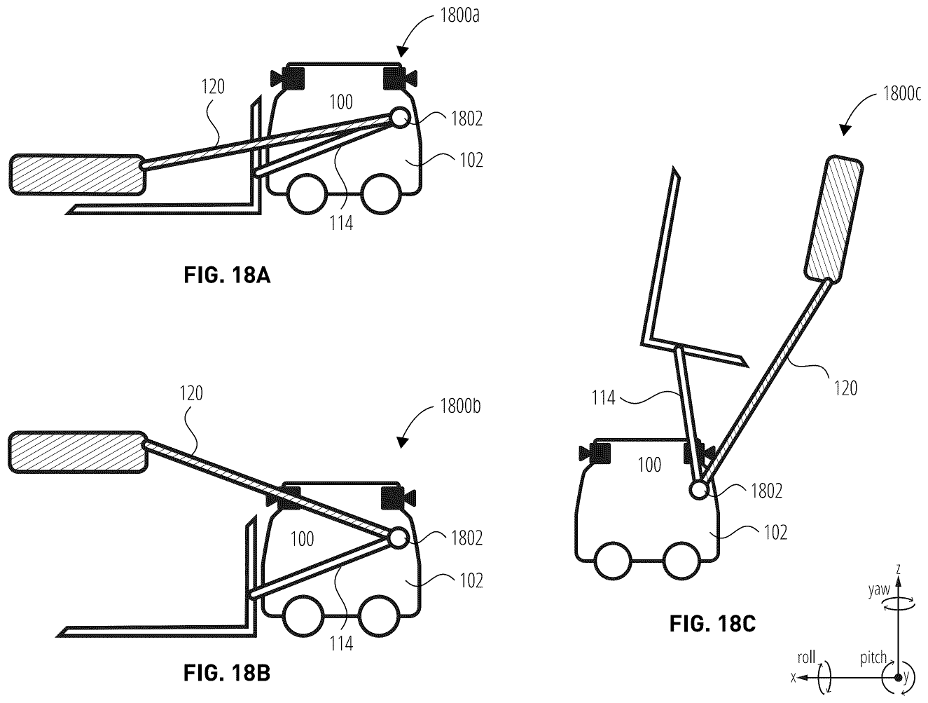

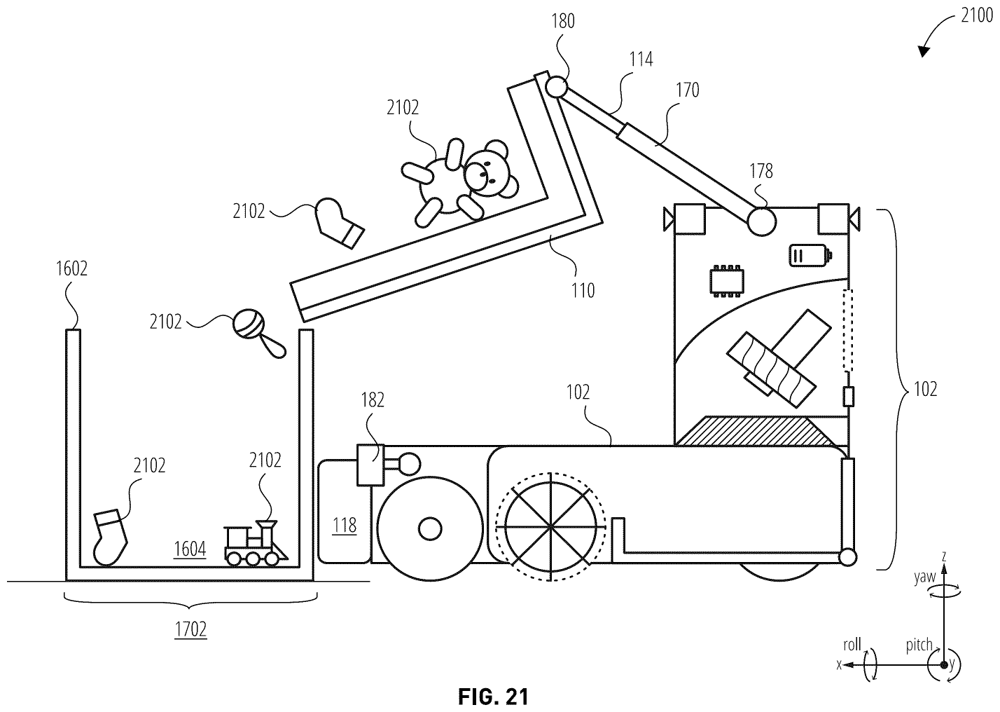

Points of connection shown herein between the scoop arms and pusher pad arms are exemplary positions and are not intended to limit the physical location of such points of connection. Such connections may be made in various locations as appropriate to the construction of the chassis and arms, and the applications of intended use. In some embodiments, the pusher pad arms 120 may attach to the scoop 110, as shown here. In other embodiments, the pusher pad arm 120 may attach to the chassis 102 as shown, for example, in FIG. 18A or FIG. 21. It will be well understood by one of ordinary skill in the art that the configurations illustrated may be designed to perform the basic motions described with respect to FIG. 17A-FIG. 22 and the processes illustrated elsewhere herein.

The geometry of the scoop 110 and the disposition of the pusher pads 118 and pusher pad arms 120 with respect to the scoop 110 may describe a containment area, illustrated more clearly in FIG. 17A-FIG. 17E, in which objects may be securely carried. Servos, direct current (DC) motors, or other actuators at the scoop arm pivot point 116, pad pivot points 122, and pad arm pivot points 124 may be used to adjust the disposition of the scoop 110, pusher pads 118, and pusher pad arms 120 between fully lowered scoop and grabber positions and raised scoop and grabber positions, as illustrated with respect to FIG. 17A-FIG. 17C.

In some embodiments, gripping surfaces may be configured on the sides of the pusher pads 118 facing inward toward objects to be lifted. These gripping surfaces may provide cushion, grit, elasticity, or some other feature that increases friction between the pusher pads 118 and objects to be captured and contained. In some embodiments, the pusher pad 118 may include suction cups in order to better grasp objects having smooth, flat surfaces. In some embodiments, the pusher pads 118 may be configured with sweeping bristles. These sweeping bristles may assist in moving small objects from the floor up onto the scoop 110. In some embodiments, the sweeping bristles may angle down and inward from the pusher pads 118, such that, when the pusher pads 118 sweep objects toward the scoop 110, the sweeping bristles form a ramp, allowing the foremost bristles to slide beneath the object, and direct the object upward toward the pusher pads 118, facilitating capture of the object within the scoop and reducing a tendency of the object to be pressed against the floor, increasing its friction and making it more difficult to move.

The capture and containment system 108, as well as some portions of the sensing system 106, may be mounted atop a lifting column 132, such that these components may be raised and lowered with respect to the ground to facilitate performance of complex tasks. A lifting column linear actuator 162 may control the elevation of the capture and containment system 108 by extending and retracting the lifting column 132. A lifting column motor 176 may allow the lifting column 132 to rotate so that the capture and containment system 108 may be moved with respect to the tidying robot 100 base or chassis 102 in all three dimensions.

The tidying robot 100 may include floor cleaning components such as a mop pad 134 and a vacuuming system. The mop pad 134 may be able to raise and lower with respect to the bottom of the tidying robot 100 chassis 102, so that it may be placed in contact with the floor when desired. The mop pad 134 may include a drying element to dry wet spots detected on the floor. In one embodiment, the tidying robot 100 may include a fluid reservoir, which may be in contact with the mop pad 134 and able to dampen the mop pad 134 for cleaning. In one embodiment, the tidying robot 100 may be able to spray cleaning fluid from a fluid reservoir onto the floor in front of or behind the tidying robot 100, which may then be absorbed by the mop pad 134.

The vacuuming system may include a vacuum compartment 138, which may have a vacuum compartment intake port 140 allowing cleaning airflow 142 into the vacuum compartment 138. The vacuum compartment intake port 140 may be configured with a rotating brush 144 to impel dirt and dust into the vacuum compartment 138. Cleaning airflow 142 may be induced to flow by a vacuum compartment fan 154 powered by a vacuum compartment motor 166. cleaning airflow 142 may pass through the vacuum compartment 138 from the vacuum compartment intake port 140 to a vacuum compartment exhaust port 156, exiting the vacuum compartment 138 at the vacuum compartment exhaust port 156. The vacuum compartment exhaust port 156 may be covered by a grating or other element permeable to cleaning airflow 142 but able to prevent the ingress of objects into the chassis 102 of the tidying robot 100.

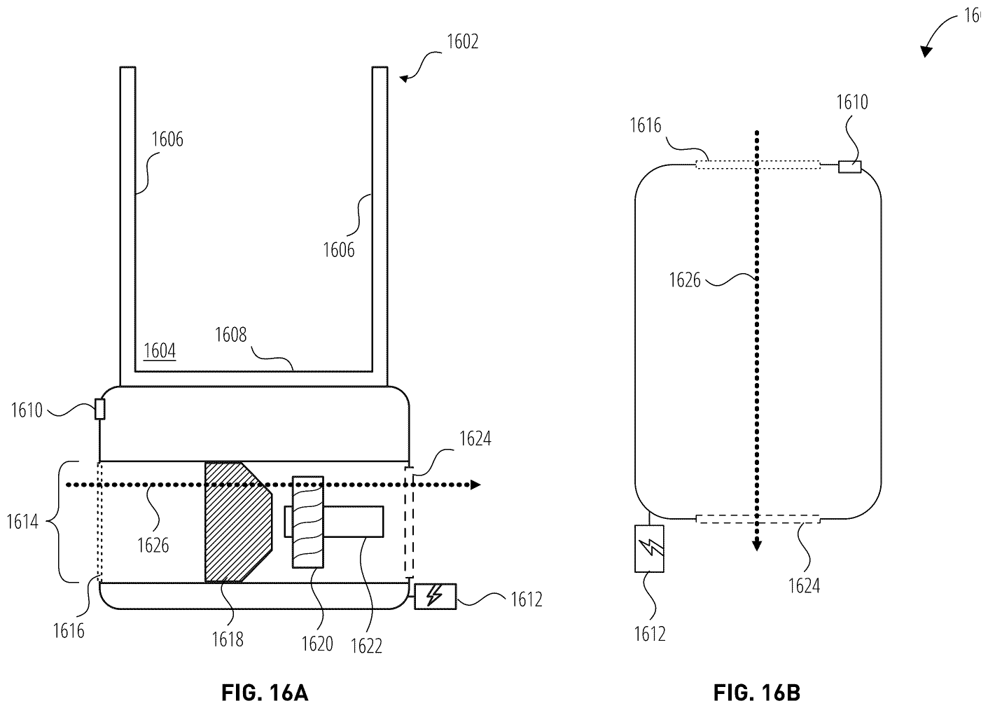

A vacuum compartment filter 150 may be disposed between the vacuum compartment intake port 140 and the vacuum compartment exhaust port 156. The vacuum compartment filter 150 may prevent dirt and dust from entering and clogging the vacuum compartment fan 154. The vacuum compartment filter 150 may be disposed such that blocked dirt and dust are deposited within a dirt collector 146. The dirt collector 146 may be closed off from the outside of the chassis 102 by a dirt release latch 148. The dirt release latch 148 may be configured to open when the tidying robot 100 is docked at a base station 1600 with a vacuum emptying system 1614, as is illustrated in FIG. 16A and FIG. 16B and described below. A robot charge connector 158 may connect the tidying robot 100 to a base station charge connector 1610, allowing power from the base station 1600 to charge the tidying robot 100 battery 160.

FIG. 2A and FIG. 2B illustrate a simplified side view and top view of a chassis 102, respectively, in order to show in more detail aspects of the mobility system 104, the sensing system 106, and the communications 206, in connection with the robotic control system 2300. In some embodiments, the communications 206 may include the network interface 2312 described in greater detail with respect to robotic control system 2300.

In one embodiment, the mobility system 104 may comprise a left front wheel 168b and a right front wheel 168a powered by mobility system motor 164, and a single rear wheel 168c, as illustrated in FIG. 1A and FIG. 1B. The single rear wheel 168c may be actuated or may be a passive roller or caster providing support and reduced friction with no driving force.

In one embodiment, the mobility system 104 may comprise a right front wheel 168a, a left front wheel 168b, a right rear wheel 208, and a left rear wheel 210. The tidying robot 100 may have front-wheel drive, where right front wheel 168a and left front wheel 168b are actively driven by one or more actuators or motors, while the right rear wheel 208 and left rear wheel 210 spin on an axle passively while supporting the rear portion of the chassis 102. In another embodiment, the tidying robot 100 may have rear-wheel drive, where the right rear wheel 208 and left rear wheel 210 are actuated and the front wheels turn passively. In another embodiment, the tidying robot 100 may have additional motors to provide all-wheel drive, may use a different number of wheels, or may use caterpillar tracks or other mobility devices in lieu of wheels.

The sensing system 106 may further comprise cameras such as the front left camera 188a, rear left camera 188b, front right camera 188c, rear right camera 188d, and scoop camera 188c, light detecting and ranging (LIDAR) sensors such as lidar sensors 202, and inertial measurement unit (IMU) sensors, such as IMU sensors 204. In some embodiments, there may be a single front camera and a single rear camera.

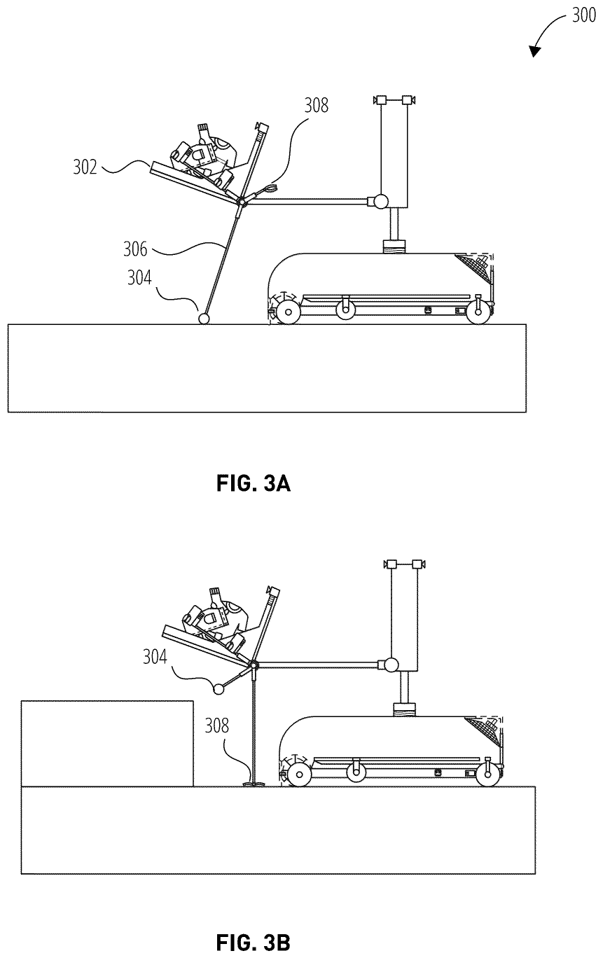

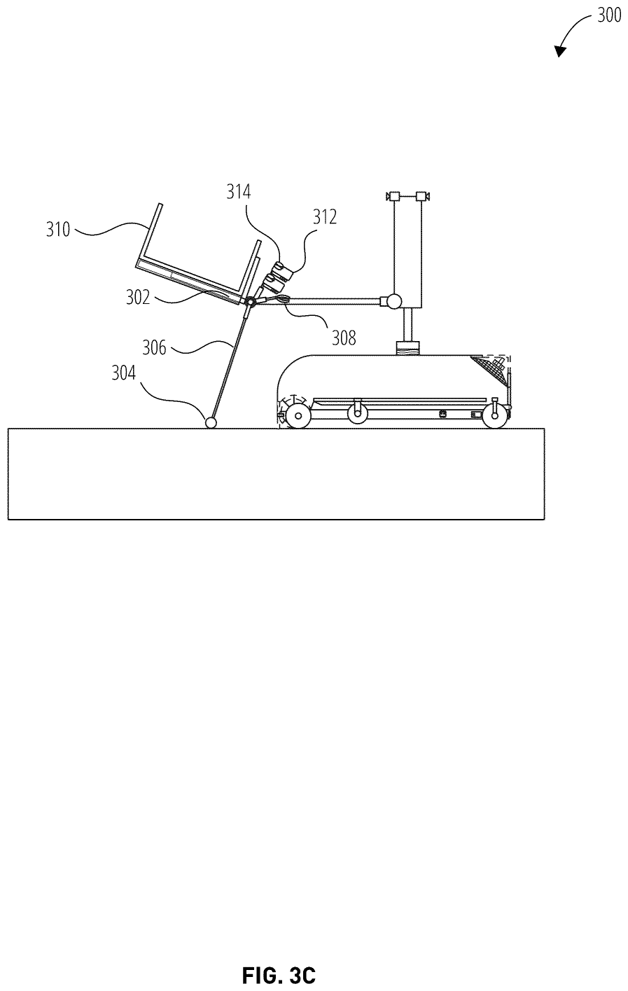

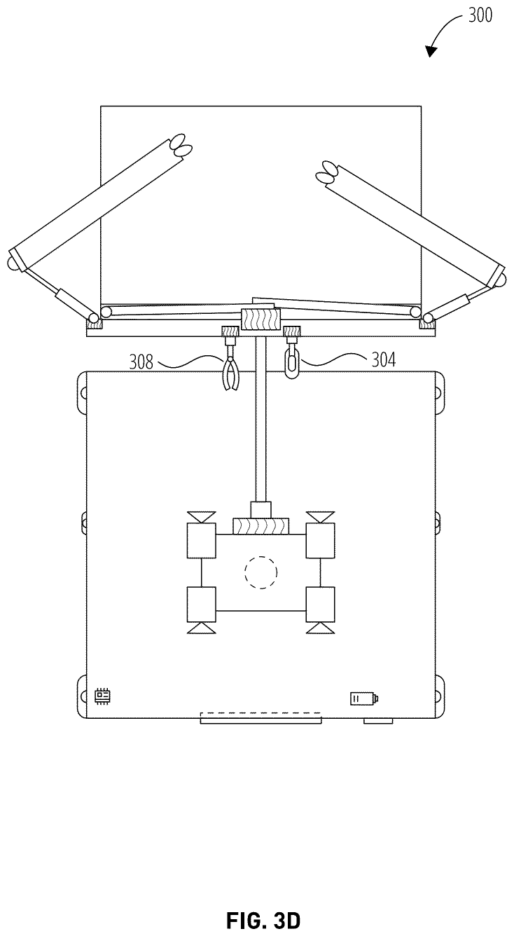

FIG. 3A-FIG. 3D illustrate a tidying robot with a scoop support wheel 300 in accordance with several embodiments. The tidying robot with a scoop support wheel 300 comprises a scoop 302, a scoop support wheel 304, a scoop support wheel telescoping arm 306, an accessory gripper 308, a storage bin 310, a pusher arm 312, and a pusher arm gripper 314. At times when it is desired to carry significant weight in the scoop 302 such as with a pile of laundry, the robot may become unbalanced if the scoop 302 is elevated and extended forwards too far.

In some embodiments, it may be useful to incorporate a scoop support wheel 304 with a scoop support wheel telescoping arm that folds in behind the back of the scoop 302 similar to how the accessory gripper 308 folds in behind the back of the scoop 302.

In an embodiment, the scoop support wheel 304 may be extended down towards the floor (or another surface) in order to help support the weight of the scoop 302 and its contents while keeping the robot balanced. In some embodiments, the scoop 302 is carrying a storage bin 310 with heavy contents and may use the scoop support wheel 304 to stabilize the load.

The accessory gripper 308 may be used together with the scoop support wheel 304 to assist with floor or surface transitions when carrying a heavy load in the scoop 302.

For example, when climbing stairs the accessory gripper 308 may support the weight of the scoop 302 on the lower stair while the scoop support wheel 304 moves from the lower stair to the higher stair.

Similarly, the accessory gripper 308 may support the scoop weight on the floor while the scoop support wheel 304 transitions from the floor to a countertop, table or another elevated surface.

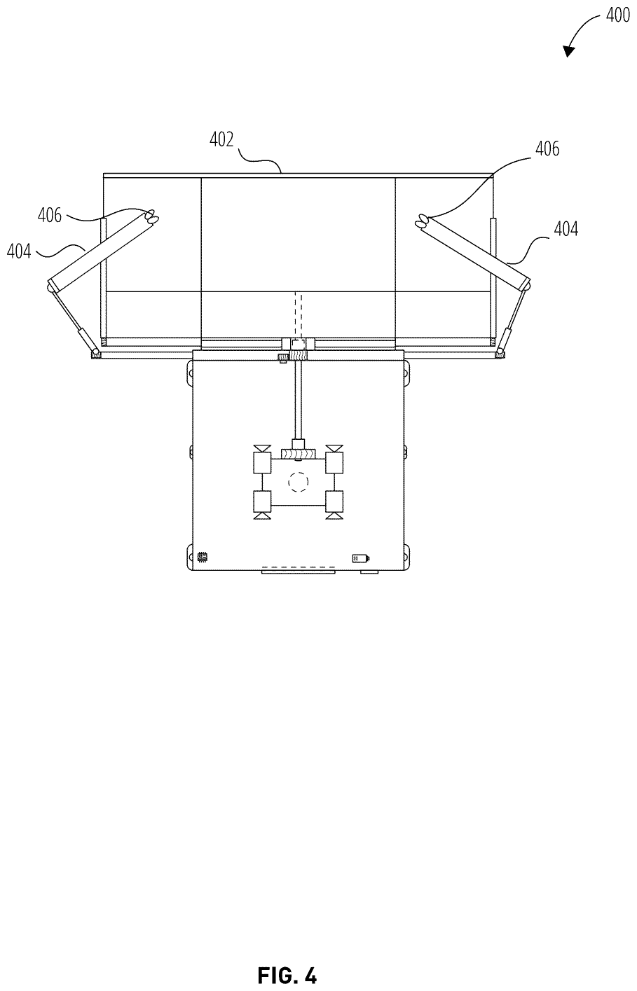

As illustrated in FIG. 4, a tidying robot with pad end grippers and an expanding scoop 400 comprises an expanding scoop 402, pusher arms 404, and pusher arm grippers 406 in accordance with some embodiments.

In some embodiments, with certain manipulation tasks such as folding clothes, it may be desirable for a scoop to be wider when folding larger clothing items, carrying a large object, or simply carrying a higher volume of objects such as with laundry. Accordingly, it may be desirable to have an expanding scoop 402 that can expand in width or shrink in width on demand to handle these varying situations. In some embodiments, scoop walls on the left and right may be desired. In other embodiments, walls disappear or fold away.

In exemplary embodiments, it may be desirable to have an expanding scoop 402 that allows both the widening/shrinking of the scoop, and for the scoop walls to disappear on demand. In an embodiment, a narrow scoop without scoop side walls may be used when a narrow scoop may be too small for a task, for example to carry laundry from the dryer, but the expanded scoop may be too wide to fit into the shelf/cabinet space. In some embodiments, a rigid scoop is used so that it may evenly support weight or be used in tasks such as folding clothes.

In some embodiments an expanded scoop with a scoop side wall may be useful in carrying laundry from a dryer. In another embodiment an expanded scoop without a scoop side wall may be useful in folding laundry, for example when folding larger clothing items.

In some embodiments, key points may be generated on the expanding scoop 402, pusher arms 404 and pusher arm grippers 406 to assist with the execution of tasks that require alignment.

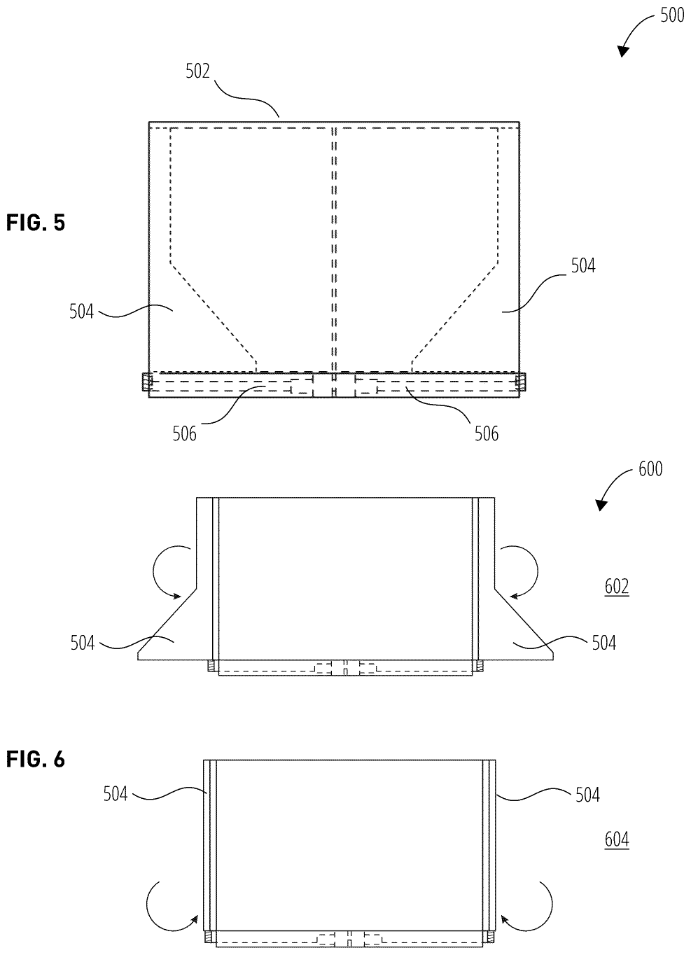

FIG. 5 illustrates an expanding scoop in a collapsed position 500 in accordance with one embodiment. The expanding scoop in a collapsed position 500 is collapsed with side movable scoop walls 504 hidden under the bottom of the scoop.

This scoop design incorporates telescoping scoop extensions, referred to as scoop bottom and back expanding linear actuators 506, and side movable scoop walls 504 that are folded under the base of the expanding scoop 502. In some embodiments, the scoop bottom and back expanding linear actuators 506 are hidden in the back wall of the scoop and the back wall also telescopes to expand ensuring the scoop doesn't have any gaps in the back.

FIG. 6 illustrates a routine for raising the scoop sides from the collapsed position 600 in accordance with one embodiment. In step 602, the side movable scoop walls 504 rotate out from beneath the scoop. In step 604, the side movable scoop walls 504 rotate up into a vertical position.

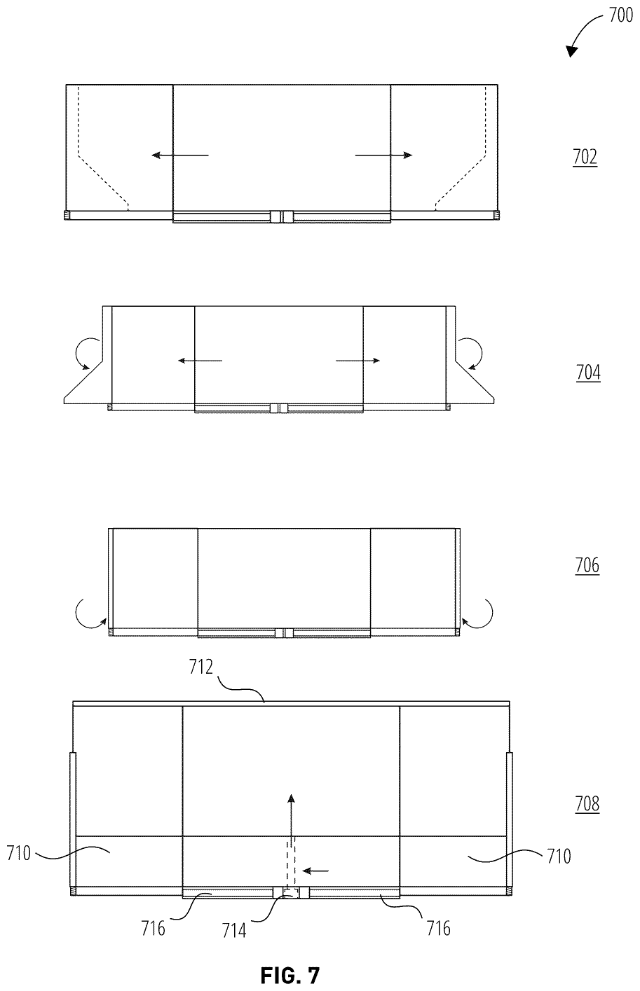

FIG. 7 illustrates a routine for expanding the scoop capacity from the collapsed position 700 in accordance with some embodiments.

In step 702, the scoop is expanded with side walls hidden. In step 704, the side walls are rotated out from beneath the scoop, and in step 706 the side walls are raised.

It may also be desirable to deepen or reduce the depth of the scoop on demand as shown in step 708, and this may be accomplished by further incorporating a front-telescoping capability in addition to the side-telescoping capability.

In some embodiments, the rear scoop expansion 710 is occurring at the back of the scoop with the front portion of the scoop including the scoop lip 712 moving forward. In some embodiments, for simplicity, in most situations the scoop walls may remain unchanged, but it is possible that the scoop walls may also extend towards the front.

In some embodiments, a rack and pinion mechanism may be used to telescope multiple segments in and towards the front, such as the central scoop base actuator 714, the left scoop base, the right scoop base, the left scoop arm and the right scoop arm. In some embodiments, scoop back and sides actuators 716 may be used to expand the sides of the scoop. This may be accomplished by having multiple pinion gears connected to the same motor shaft, and racks for each telescoping segment that mesh with the corresponding pinion gear. In some embodiments, guides or tracks may be used to ensure linear movement.

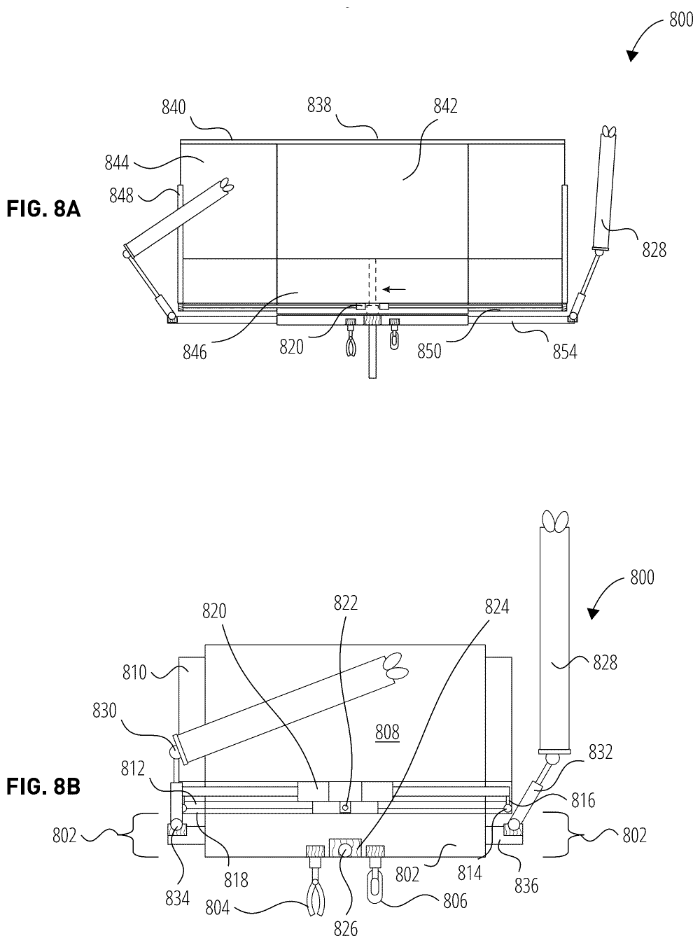

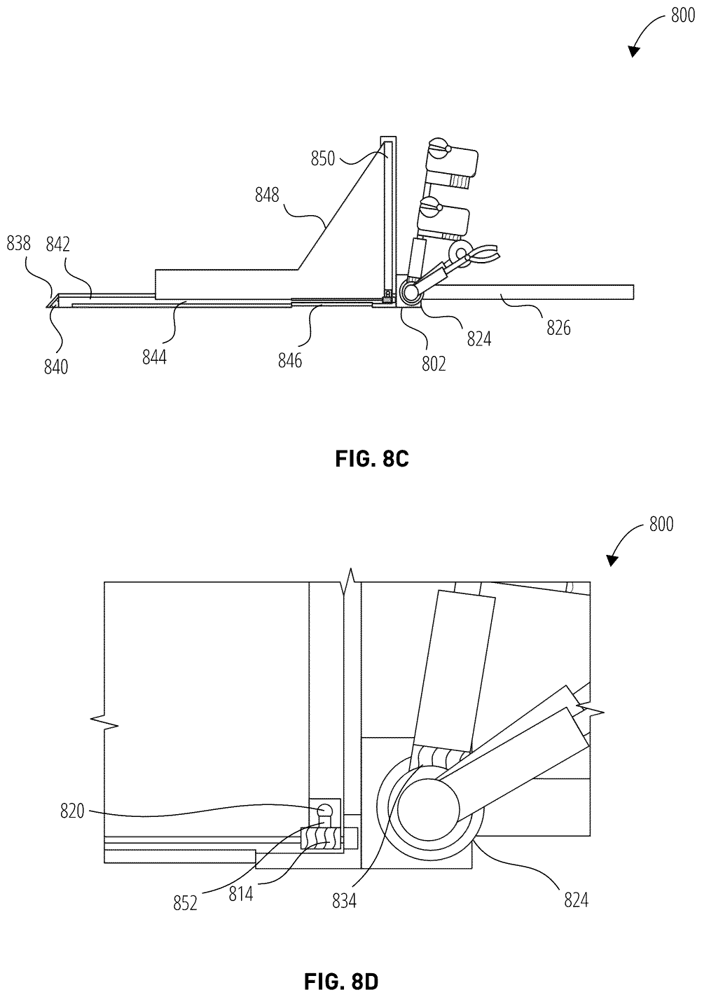

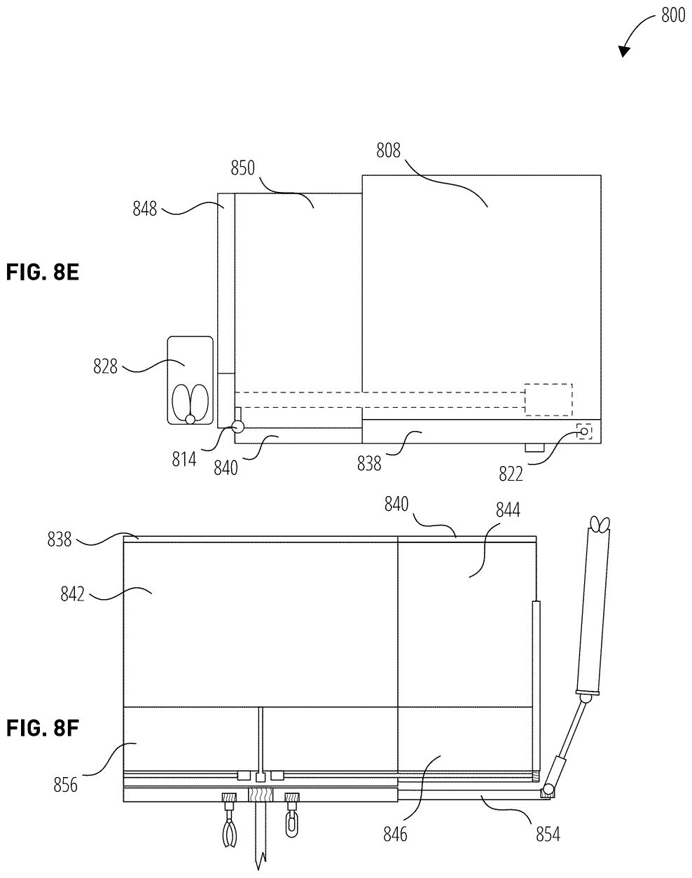

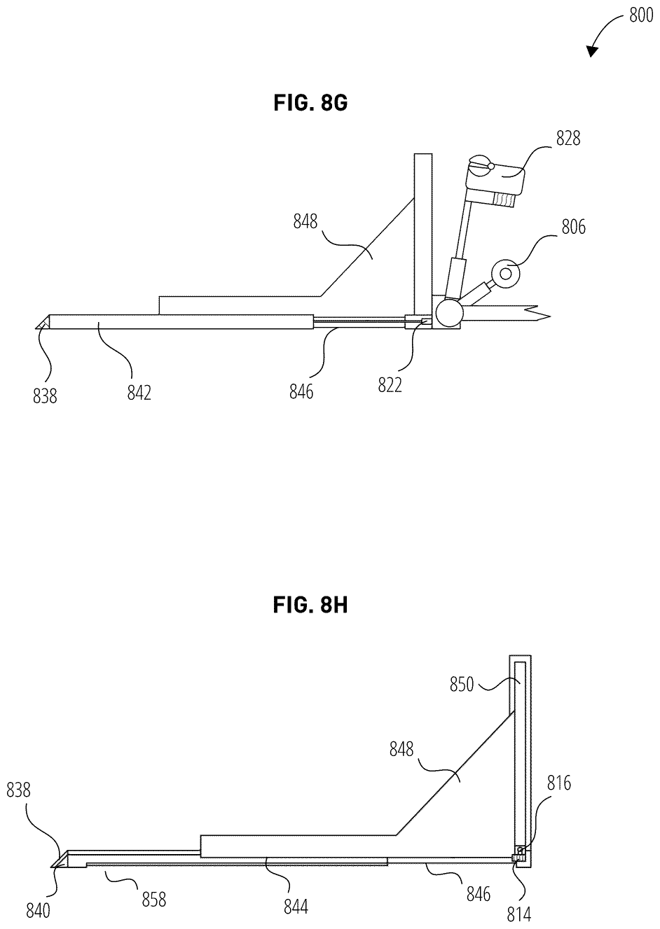

FIG. 8A-FIG. 8H illustrate an expanding scoop 800 in accordance with several embodiments. The expanding scoop 800 comprises a scoop base connection 802, an accessory gripper 804, a scoop support wheel 806, a back of scoop 808, an expanded back of scoop 810, an expanded bottom of scoop 812, an actuator to rotate scoop side up 814, a connection between linear actuator and expanding scoop 816, a scoop side folded under 818, a scoop bottom and back expanding linear actuator 820, a scoop front forward pushing linear actuator 822, a scoop dump angle actuator 824, a linear actuator connecting scoop with main robot 826, a pusher arm 828, a rotational actuator for pusher arm 830, a linear actuator for pusher arm 832, a shoulder actuator for pusher arm 834, and an expanded base connection for pusher arm 836. The expanding scoop 800 comprises a scoop bottom and back expanding linear actuator 820, a pusher arm 828, a scoop lip 838, an expanded scoop lip 840, an expanded bottom of scoop moving forward with scoop lip 842, an expanded bottom of scoop widening to sides 844, an expanded bottom of scoop exposed by scoop lip moving forward 846, a scoop side folded up 848, an expanded back of scoop 850, a connection between linear actuator and expanding scoop 852, an expanded base connection for pusher arm when scoop expands 854, a structural bottom support under scoop 856, and space under scoop 858.

In some embodiments, a scoop for a tidying robot includes a scoop base configured to couple to a scoop arm on the tidying robot, a scoop back secured to the scoop base, a scoop bottom including an expandable scoop bottom, secured to the scoop base, and a scoop bottom linear actuator configured to extend or retract at least one side of the expandable scoop bottom.

In some embodiments, the scoop additionally includes at least one foldable scoop wall, attached to the expandable scoop bottom, and a scoop side actuator configured to rotate the at least one foldable scoop wall to a position above or below the expandable scoop bottom.

In some embodiments, the scoop additionally includes a scoop lip along at least a portion of the front of the scoop bottom.

In some embodiments, the scoop further includes a scoop front forward pushing linear actuator configured to push at least a front portion of the expandable scoop bottom toward the front of the scoop.

In further embodiments, the scoop bottom further includes a structural scoop bottom, and a central expandable scoop bottom, the structural scoop bottom attached to the scoop base, wherein the structural scoop bottom is configured to slidably interface with the central expandable scoop bottom and the at least one side expandable scoop bottom. In some embodiments, the scoop front forward pushing linear actuator is configured to push the central expandable scoop bottom and the at least one side expandable scoop bottom toward the front of the scoop. In further embodiments, the central expandable scoop bottom and the at least one side expandable scoop bottom include a rack and pinion gear system allowing the central expandable scoop bottom and the at least one side expandable scoop bottom to be pushed forward toward the front of the scoop.

In some embodiments, the scoop back is an expandable scoop back, the scoop bottom linear actuator configured to also extend or retract at least one side of the expandable scoop back. In an additional embodiment, the scoop back including a static scoop back and the expandable scoop back, the static scoop back secured to the scoop base, wherein the static scoop back is configured to slidably interface with the expandable scoop back.

FIG. 8A illustrates an overhead view of the expanding scoop 800, including an expanded bottom of scoop moving forward with scoop lip 842 with the scoop side folded up 848. Additionally, after the scoop has been moved forward, one can see the expanded bottom of scoop exposed by scoop lip moving forward 846.

FIG. 8B illustrates a rear view of the expanding scoop 800 with the scoop side folded under 818 the scoop. The expanding scoop 800 comprises in some embodiments a scoop base connection 802 including an accessory gripper 804 and a scoop support wheel 806. The back of scoop 808 includes an expanded back of scoop 810 and an expanded bottom of scoop 812. A scoop side folded under 818 and an actuator to rotate scoop side up 814 is also illustrated as well as a connection between linear actuator and expanding scoop 816. A scoop bottom and back expanding linear actuator 820 may be used to create an expanded back of scoop 810 and expanded bottom of scoop 812 condition. A scoop front forward pushing linear actuator 822 may be, in some embodiments, a rack and pinion with guided track (shown as a telescoping liner actuator). Other items shown with respect to the scoop base connection and pusher arms are a scoop dump angle actuator 824, a linear actuator connecting scoop with main robot 826, a pusher arm 828, a rotational actuator for pusher arm 830, a linear actuator for pusher arm 832, a shoulder actuator for pusher arm 834, and an expanded base connection for pusher arm 836.

FIG. 8C illustrates a side view of the 800 with the scoop side folded up 848. The expanding scoop 800 includes in some embodiments a scoop lip 838, an expanded scoop lip 840 at the forward part of the scoop. As a portion of the bottom of the scoop is moved forward, an expanded bottom of scoop moving forward with scoop lip 842 may be seen. An expanded bottom of scoop widening to sides 844 may also be revealed if the scoop sides are also expanded. After the scoop bottom has been expanded forward, on can see an expanded bottom of scoop exposed by scoop lip moving forward 846.

FIG. 8D illustrates a side view of actuators. The expanding scoop 800 comprises in some embodiments an actuator to rotate scoop side up 814, a scoop bottom and back expanding linear actuator 820, a scoop dump angle actuator 824, a shoulder actuator for pusher arm 834, and a connection between linear actuator and expanding scoop 852.

FIG. 8E illustrates a partial front view of the expanding scoop 800. The expanding scoop 800 in some embodiments comprises a back of scoop 808, an expanded back of scoop 850 and a scoop side folded up 848. An actuator to rotate scoop side up 814 is shown as will as the scoop lip 838, and the expanded scoop lip 840.

FIG. 8F illustrates a partial top view of the expanding scoop 800. The expanding scoop 800 in some embodiments comprises a structural bottom support under scoop 856 and an expanded bottom of scoop moving forward with scoop lip 842 along with an expanded bottom of scoop widening to sides 844. After the bottom is moved forward, an expanded bottom of scoop exposed by scoop lip moving forward 846.

FIG. 8G illustrates a side view of the expanding scoop 800. The expanding scoop 800 comprises in some embodiments a scoop front forward pushing linear actuator 822. An expanded bottom of scoop moving forward with scoop lip 842 is shown resulting in an expanded bottom of scoop exposed by scoop lip moving forward 846.

FIG. 8H illustrates a side view of the expanding scoop 800. The expanding scoop 800 comprises in certain embodiments a scoop side folded up 848. As the bottom is expanded forward and outward, an expanded bottom of scoop widening to sides 844 is revealed, and an expanded bottom of scoop exposed by scoop lip moving forward 846 is shown. Resulting space under scoop 858 is also revealed.

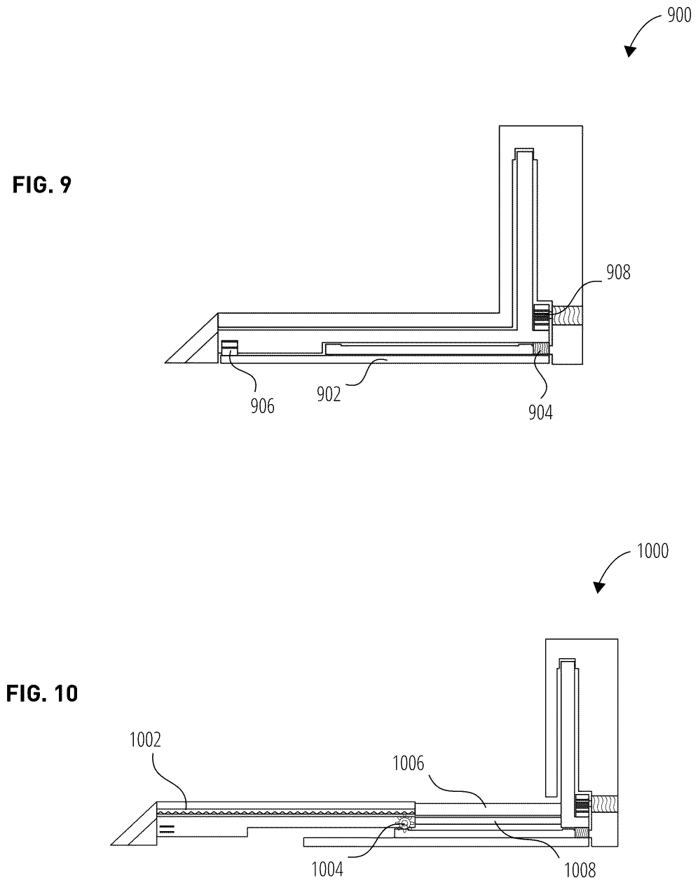

FIG. 9 illustrates an expanding scoop 900 in accordance with one embodiment. The expanding scoop 900 comprises a folded side wall 902 underneath the scoop, a hinged actuator to fold side wall 904, a hinge to stabilize side wall 906, and a pinion gear and rack to widen scoop 908.

In some embodiments, the scoop may be expanded by using, for example, springs and cables. In a preferred embodiment, the pinion gear and rack with linear sliders may be used.

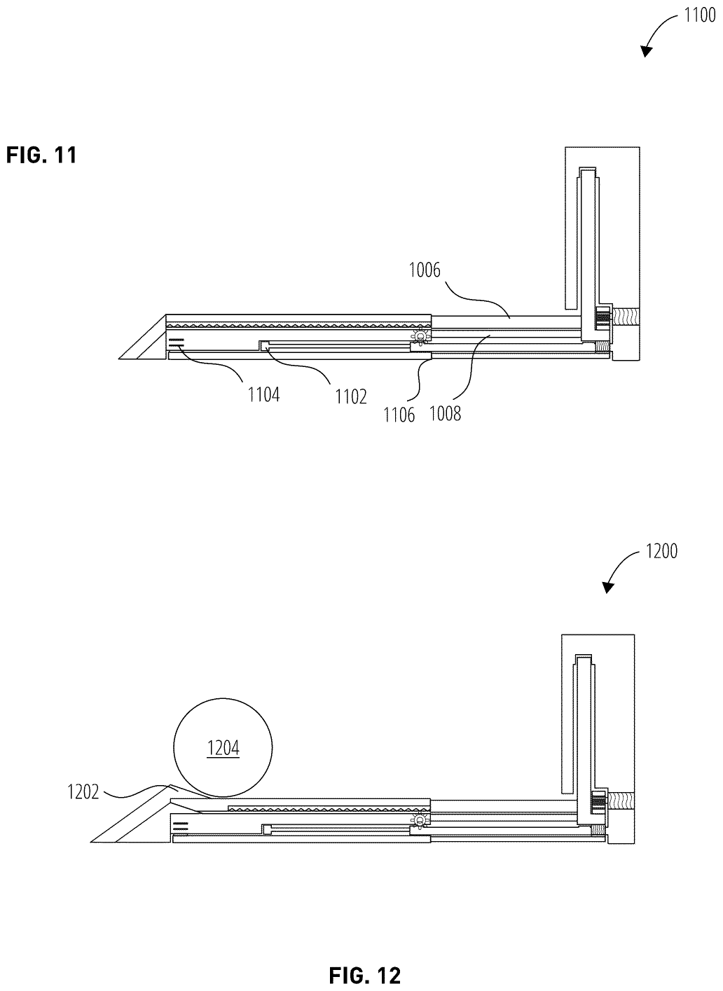

FIG. 10-FIG. 11 illustrate an expanding scoop in accordance with several embodiments. The expanding scoop 1000 comprises a rack to expand scoop base forward 1002, a pinion gear for scoop base rack 1004, a bottom of scoop center at back 1006, and shows the bottom of scoop sides at back 1008.

In addition to the expanding sides of expanding scoop 900, the expanding scoop 1000 also expands to deepen the bottom section of the scoop. The rack and pinion gear may be used to deepen the scoop by thrusting a portion of the bottom forward. In some embodiments, pinion gear for scoop base rack 1004 may be located at the center section of the bottom of the scoop, between expanding sections. In some embodiments, gears or a belt may be used to move the actuator further back behind the back of the scoop.

FIG. 11 illustrates an expanding scoop 1100 that deepens and includes an extending scoop side wall 1106. In some embodiments, as the scoop extends with the scoop side wall in a folded under the scoop bottom position, the extending scoop side wall 1106 also extends. Additionally, in some embodiments, there is a support for expansion of bottom 1102 to help with stability of the scoop. Further, in some embodiments, there is a hinge to stabilize scoop side wall 1104 and stabilize the scoop side wall when it folds into a position above the bottom of the scoop. In some embodiments, gears or a belt may be used to move the actuator further back behind the back of the scoop.

FIG. 12 illustrates an expanding scoop 1200 in accordance with one embodiment.

In an embodiment, the scoop lip may angle up near the edge of the front of the scoop and then change to a downward scoop lip transition 1202. In an embodiment, a scoop lip angles up at the front of the scoop and then has the downward transition in order to help retain objects 1204 from rolling out.

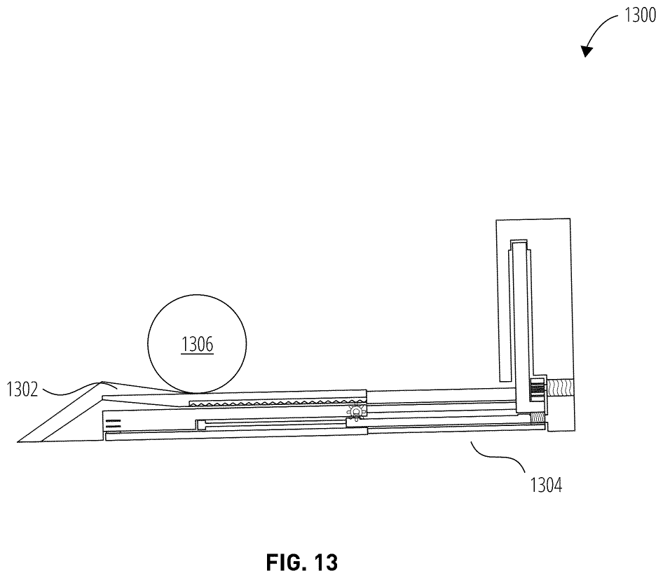

FIG. 13 illustrates an expanding scoop 1300 in accordance with one embodiment.

In some embodiments, the scoop may tilt downwards slightly. In some embodiments, the scoop may tilt downwards slightly and be a little bit higher towards the back, provided that the scoop lip has an upward and gradual downward scoop lip transition 1302 to keep small/medium objects from rolling out. There may be a natural resting point after the scoop lip were objects 1306 do not roll forward out of the scoop even if the scoop is tilted downward slightly.

In some embodiments, there may be additional space towards the back of the scoop, extra space under scoop 1304, and behind the scoop where the motors and actuators (e.g., pinion gear, rack and linear sliders) that are needed may be placed. In some embodiments, the side wall is folding up before the scoop lip and so the side wall is slightly back from the front of the scoop. This may ensure that there is room to fold up the side wall.

In some embodiments, a typical scoop lip will often be 2 cm or 3 cm in height from the floor, but the thickness of the scoop, particularly if it is made of plastic, is less than 0.5 cm. In some embodiments, many of the sliding and folding mechanisms need to fit in a space of approximately 1 cm of height.

In an embodiment, gears and/or timing belts may be used to transmit power from motors to hard-to-reach areas, enabling motion where there is limited room for a motor.

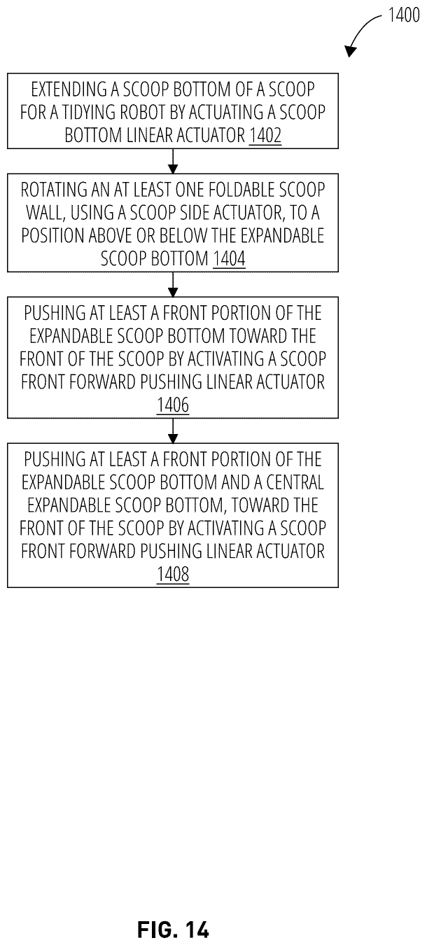

FIG. 14 illustrates an example method 1400 for using an expanding scoop. Although the example method 1400 depicts a particular sequence of operations, the sequence may be altered without departing from the scope of the present disclosure. For example, some of the operations depicted may be performed in parallel or in a different sequence that does not materially affect the function of the method 1400. In other examples, different components of an example device or system that implements the method 1400 may perform functions at substantially the same time or in a specific sequence.

According to some embodiments, the method includes extending a scoop bottom of a scoop for a tidying robot by actuating a scoop bottom linear actuator at block 1402.

According to some embodiments, the method includes rotating an at least one foldable scoop wall, using a scoop side actuator, to a position above or below the expandable scoop bottom at block 1404.

According to some embodiments, the method includes pushing at least a front portion of the expandable scoop bottom toward the front of the scoop by activating a scoop front forward pushing linear actuator at block 1406.

According to some embodiments, the method includes pushing at least a front portion of the expandable scoop bottom and a central expandable scoop bottom, toward the front of the scoop by activating a scoop front forward pushing linear actuator at block 1408.

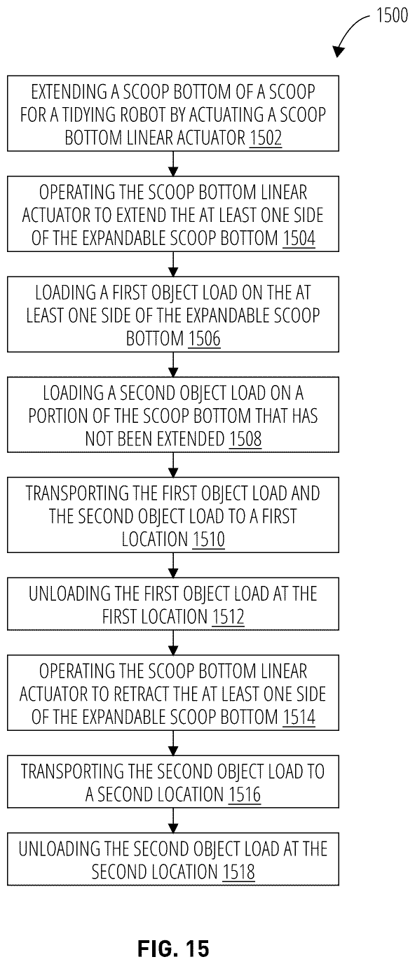

FIG. 15 illustrates an example method 1500 for using an expanding scoop. Although the example method 1500 depicts a particular sequence of operations, the sequence may be altered without departing from the scope of the present disclosure. For example, some of the operations depicted may be performed in parallel or in a different sequence that does not materially affect the function of the method 1500. In other examples, different components of an example device or system that implements the method 1500 may perform functions at substantially the same time or in a specific sequence.

According to some embodiments, the method includes extending a scoop bottom of a scoop for a tidying robot by actuating a scoop bottom linear actuator at block 1502 and operating the scoop bottom linear actuator to extend the at least one side of the expandable scoop bottom at block 1504. Next, according to some embodiments, the method includes loading a first object load on the at least one side of the expandable scoop bottom at block 1506 followed by loading a second object load on a portion of the scoop bottom that has not been extended at block 1508. According to some embodiments, the method further includes transporting the first object load and the second object load to a first location at block 1510 and unloading the first object load at the first location at block 1512. According to some embodiments, the method further includes operating the scoop bottom linear actuator to retract the at least one side of the expandable scoop bottom at block 1514. According to some embodiments, the method additionally includes transporting the second object load to a second location at block 1516. According to some embodiments, the method further includes unloading the second object load at the second location at block 1518.

In some embodiments, the method may further include operating a pusher pad on the tidying robot to unload the first object load at the first location.

FIG. 16A and FIG. 16B illustrate a base station 1600 in accordance with one embodiment. FIG. 16A shows a left side view and FIG. 16B shows a top view. The base station 1600 may comprise an object collection bin 1602 with a storage compartment 1604 to hold tidyable objects, heavy dirt and debris, or other obstructions. The storage compartment 1604 may be formed by bin sides 1606 and a bin base 1608. “Tidyable objects” in this disclosure are elements detected in the environment that may be moved by the robot and put away in a home location. These objects may be of a type and size such that the robot may autonomously put them away, such as toys, clothing, books, stuffed animals, soccer balls, garbage, remote controls, keys, cellphones, etc. The base station 1600 may further comprise a base station charge connector 1610, a power source connection 1612, and a vacuum emptying system 1614 including a vacuum emptying system intake port 1616, a vacuum emptying system filter bag 1618, a vacuum emptying system fan 1620, a vacuum emptying system motor 1622, and a vacuum emptying system exhaust port 1624.

The object collection bin 1602 may be configured on top of the base station 1600 so that a tidying robot 100 may deposit objects from the scoop 110 into the object collection bin 1602. The base station charge connector 1610 may be electrically coupled to the power source connection 1612. The power source connection 1612 may be a cable connector configured to couple through a cable to an alternating current (AC) or direct current (DC) source, a battery, or a wireless charging port, as will be readily apprehended by one of ordinary skill in the art. In one embodiment, the power source connection 1612 is a cable and male connector configured to couple with 120V AC power, such as may be provided by a conventional U. S. home power outlet.

The vacuum emptying system 1614 may include a vacuum emptying system intake port 1616 allowing vacuum emptying airflow 1626 into the vacuum emptying system 1614. The vacuum emptying system intake port 1616 may be configured with a flap or other component to protect the interior of the vacuum emptying system 1614 when a tidying robot 100 is not docked. A vacuum emptying system filter bag 1618 may be disposed between the vacuum emptying system intake port 1616 and a vacuum emptying system fan 1620 to catch dust and dirt carried by the vacuum emptying airflow 1626 into the vacuum emptying system 1614. The vacuum emptying system fan 1620 may be powered by a vacuum emptying system motor 1622. The vacuum emptying system fan 1620 may pull the vacuum emptying airflow 1626 from the vacuum emptying system intake port 1616 to the vacuum emptying system exhaust port 1624, which may be configured to allow the vacuum emptying airflow 1626 to exit the vacuum emptying system 1614. The vacuum emptying system exhaust port 1624 may be covered with a grid to protect the interior of the vacuum emptying system 1614.

FIG. 17A illustrates a tidying robot 100 such as that introduced with respect to FIG. 1A disposed in a lowered scoop position and lowered pusher position 1700a. In this configuration, the pusher pads 118 and pusher pad arms 120 rest in a lowered pusher position 1704, and the scoop 110 and scoop arm 114 rest in a lowered scoop position 1706 at the front 1702 of the tidying robot 100. In this position, the scoop 110 and pusher pads 118 may roughly describe a containment area 1710 as shown.

FIG. 17B illustrates a tidying robot 100 with a lowered scoop position and raised pusher position 1700b. Through the action of servos or other actuators at the pad pivot points 122 and pad arm pivot points 124, the pusher pads 118 and pusher pad arms 120 may be raised to a raised pusher position 1708 while the scoop 110 and scoop arm 114 maintain a lowered scoop position 1706. In this configuration, the pusher pads 118 and scoop 110 may roughly describe a containment area 1710 as shown, in which an object taller than the scoop 110 height may rest within the scoop 110 and be held in place through pressure exerted by the pusher pads 118.

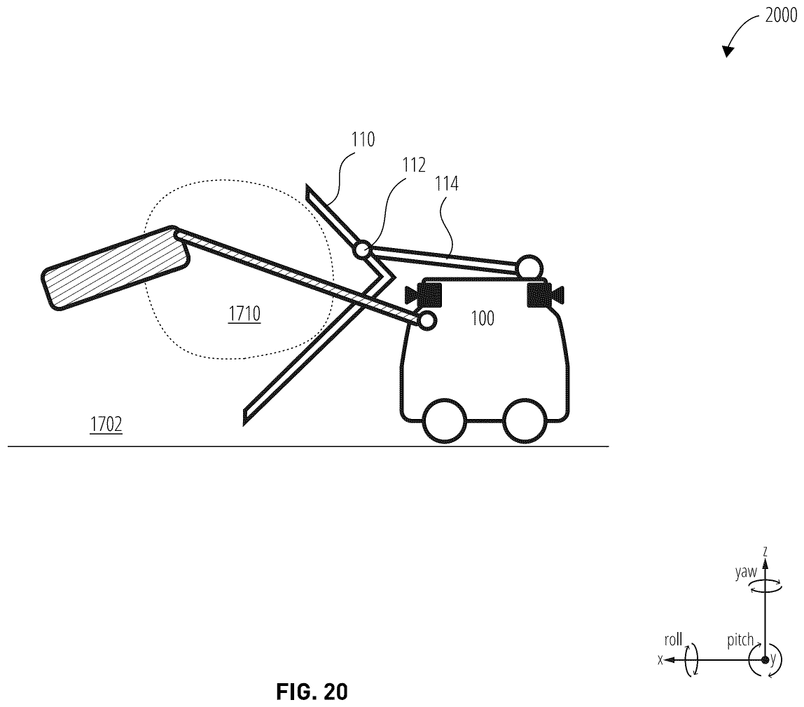

Pad arm pivot points 124, pad pivot points 122, scoop arm pivot points 116 and scoop pivot points 112 (as shown in FIG. 20) may provide the tidying robot 100 a range of motion of these components beyond what is illustrated herein. The positions shown in the disclosed figures are illustrative and not meant to indicate the limits of the robot's component range of motion.

FIG. 17C illustrates a tidying robot 100 with a raised scoop position and raised pusher position 1700c. The pusher pads 118 and pusher pad arms 120 may be in a raised pusher position 1708 while the scoop 110 and scoop arm 114 are in a raised scoop position 1712. In this position, the tidying robot 100 may be able to allow objects drop from the scoop 110 and pusher pad arms 120 to an area at the rear 1714 of the tidying robot 100.

The carrying position may involve the disposition of the pusher pads 118, pusher pad arms 120, scoop 110, and scoop arm 114, in relative configurations between the extremes of lowered scoop position and lowered pusher position 1700a and raised scoop position and raised pusher position 1700c.

FIG. 17D illustrates a tidying robot 100 with pusher pads extended 1700d. By the action of servos or other actuators at the pad pivot points 122, the pusher pads 118 may be configured as extended pusher pads 1716 to allow the tidying robot 100 to approach objects as wide or wider than the robot chassis 102 and scoop 110. In some embodiments, the pusher pads 118 may be able to rotate through almost three hundred and sixty degrees, to rest parallel with and on the outside of their associated pusher pad arms 120 when fully extended.

FIG. 17E illustrates a tidying robot 100 with pusher pads retracted 1700e. The closed pusher pads 1718 may roughly define a containment area 1710 through their position with respect to the scoop 110. In some embodiments, the pusher pads 118 may be able to rotate farther than shown, through almost three hundred and sixty degrees, to rest parallel with and inside of the side walls of the scoop 110.

FIG. 18A-FIG. 18C illustrate a tidying robot 100 such as that introduced with respect to FIG. 1A. In such an embodiment, the pusher pad arms 120 may be controlled by a servo or other actuator at the same point of connection 1802 with the chassis 102 as the scoop arms 114. The tidying robot 100 may be seen disposed in a lowered scoop position and lowered pusher position 1800a, a lowered scoop position and raised pusher position 1800b, and a raised scoop position and raised pusher position 1800c. This tidying robot 100 may be configured to perform the algorithms disclosed herein.

The point of connection shown between the scoop arms 114/pusher pad arms 120 and the chassis 102 is an exemplary position and is not intended to limit the physical location of this point of connection. Such connection may be made in various locations as appropriate to the construction of the chassis 102 and arms, and the applications of intended use.

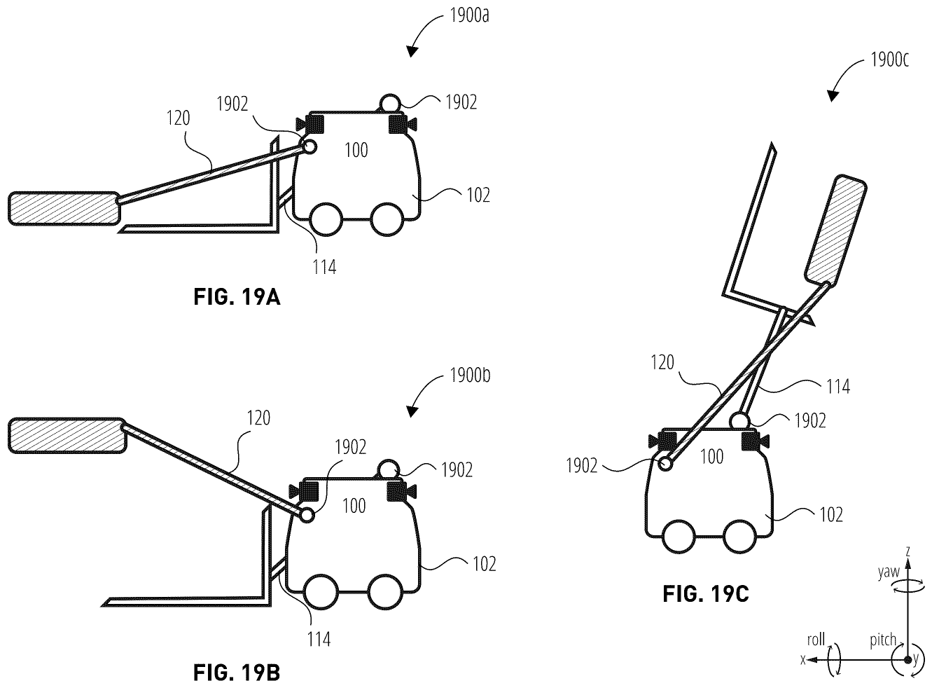

FIG. 19A-FIG. 19C illustrate a tidying robot 100 such as that introduced with respect to FIG. 1A. In such an embodiment, the pusher pad arms 120 may be controlled by a servo or servos (or other actuators) at different points of connection 1902 with the chassis 102 from those controlling the scoop arm 114. The tidying robot 100 may be seen disposed in a lowered scoop position and lowered pusher position 1900a, a lowered scoop position and raised pusher position 1900b, and a raised scoop position and raised pusher position 1900c. This tidying robot 100 may be configured to perform the algorithms disclosed herein.

The different points of connection 1902 between the scoop arm and chassis and the pusher pad arms and chassis shown are exemplary positions and not intended to limit the physical locations of these points of connection. Such connections may be made in various locations as appropriate to the construction of the chassis and arms, and the applications of intended use.

FIG. 20 illustrates a tidying robot 100 such as was previously introduced in a front drop position 2000. The arms of the tidying robot 100 may be positioned to form a containment area 1710 as previously described.

The tidying robot 100 may be configured with a scoop pivot point 112 where the scoop 110 connects to the scoop arm 114. The scoop pivot point 112 may allow the scoop 110 to be tilted forward and down while the scoop arm 114 is raised, allowing objects in the containment area 1710 to slide out and be deposited in an area to the front 1702 of the tidying robot 100.

FIG. 21 illustrates how the positions of the components of the tidying robot 100 may be configured such that the tidying robot 100 may approach an object collection bin 1602 and perform a front dump action 2100. The scoop 110 may be raised by scoop arm motor 178, extended by scoop arm linear actuator 170, and tilted by scoop motor 180 so that tidyable objects 2102 carried in the scoop 110 may be deposited into the storage compartment 1604 of the object collection bin 1602 positioned to the front 1702 of the tidying robot 100, as is also described with respect to the front drop position 2000 of FIG. 20.

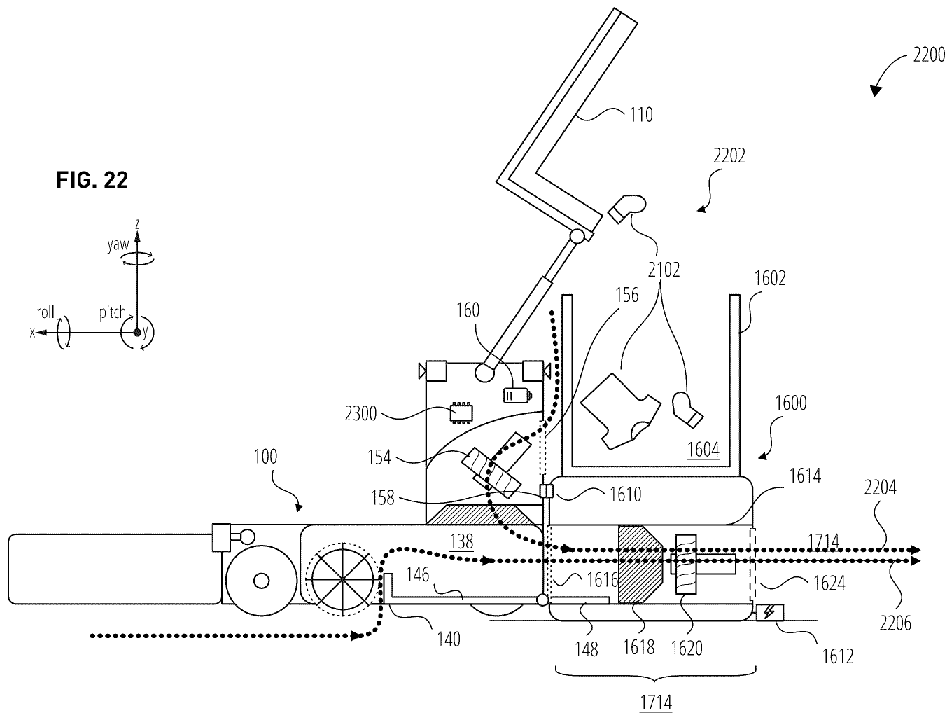

FIG. 22 illustrates a tidying robotic system interaction 2200 in accordance with one embodiment. The tidying robotic system may include the tidying robot 100, the base station 1600, a robotic control system 2300, and logic 2314 that when executed directs the robot to perform the disclosed method. When the tidying robot 100 is docked at a base station 1600 having an object collection bin 1602, the scoop 110 may be raised and rotated up and over the tidying robot 100 chassis 102, allowing tidyable objects 2102 in the scoop 110 to drop into the storage compartment 1604 of the object collection bin 1602 to the rear 1714 of the tidying robot 100 in a rear dump action 2202, as is also described with respect to the raised scoop position and raised pusher position 1700c and raised scoop position and raised pusher position 1800c described with respect to FIG. 17C and FIG. 18C, respectively.

In a docked state, the robot charge connector 158 may electrically couple with the base station charge connector 1610 such that electrical power from the power source connection 1612 may be carried to the battery 160, and the battery 160 may be recharged toward its maximum capacity for future use.

When the tidying robot 100 docks at its base station 1600, the dirt release latch 148 may lower, allowing the vacuum compartment 138 to interface with the vacuum emptying system 1614. Where the vacuum emptying system intake port 1616 is covered by a protective element, the dirt release latch 148 may interface with that element to open the vacuum emptying system intake port 1616 when the tidying robot 100 is docked. The vacuum compartment fan 154 may remain inactive or may reverse direction, permitting or compelling airflow 2204 through the vacuum compartment exhaust port 156, into the vacuum compartment 138, across the dirt collector 146, over the dirt release latch 148, into the vacuum emptying system intake port 1616, through the vacuum emptying system filter bag 1618, and out the vacuum emptying system exhaust port 1624, in conjunction with the operation of the vacuum emptying system fan 1620. The action of the vacuum emptying system fan 1620 may also pull airflow 2206 in from the vacuum compartment intake port 140, across the dirt collector 146, over the dirt release latch 148, into the vacuum emptying system intake port 1616, through the vacuum emptying system filter bag 1618, and out the vacuum emptying system exhaust port 1624. In combination, airflow 2204 and airflow 2206 may pull dirt and dust from the dirt collector 146 into the vacuum emptying system filter bag 1618, emptying the dirt collector 146 for future vacuuming tasks. The vacuum emptying system filter bag 1618 may be manually discarded and replaced on a regular basis.

FIG. 23 depicts an embodiment of a robotic control system 2300 to implement components and process steps of the systems described herein. Some or all portions of the robotic control system 2300 and its operational logic may be contained within the physical components of a robot and/or within a cloud server in communication with the robot and/or within the physical components of a user's mobile computing device, such as a smartphone, tablet, laptop, personal digital assistant, or other such mobile computing devices. In one embodiment, aspects of the robotic control system 2300 on a cloud server and/or user's mobile computing device may control more than one robot at a time, allowing multiple robots to work in concert within a working space.

Input devices 2304 (e.g., of a robot or companion device such as a mobile phone or personal computer) comprise transducers that convert physical phenomena into machine internal signals, typically electrical, optical, or magnetic signals. Signals may also be wireless in the form of electromagnetic radiation in the radio frequency (RF) range but also potentially in the infrared or optical range. Examples of input devices 2304 are contact sensors which respond to touch or physical pressure from an object or proximity of an object to a surface, mice which respond to motion through space or across a plane, microphones which convert vibrations in the medium (typically air) into device signals, scanners which convert optical patterns on two or three-dimensional objects into device signals. The signals from the input devices 2304 are provided via various machine signal conductors (e.g., busses or network interfaces) and circuits to memory 2306.

The memory 2306 is typically what is known as a first- or second-level memory device, providing for storage (via configuration of matter or states of matter) of signals received from the input devices 2304, instructions and information for controlling operation of the central processing unit or processor 2302, and signals from storage devices 2310. The memory 2306 and/or the storage devices 2310 may store computer-executable instructions and thus forming logic 2314 that when applied to and executed by the processor 2302 implement embodiments of the processes disclosed herein. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter). Logic 2314 may include portions of a computer program, along with configuration data, that are run by the processor 2302 or another processor. Logic 2314 may include one or more machine learning models 2316 used to perform the disclosed actions. In one embodiment, portions of the logic 2314 may also reside on a mobile or desktop computing device accessible by a user to facilitate direct user control of the robot.

Information stored in the memory 2306 is typically directly accessible to the processor 2302 of the device. Signals input to the device cause the reconfiguration of the internal material/energy state of the memory 2306, creating in essence a new machine configuration, influencing the behavior of the robotic control system 2300 by configuring the processor 2302 with control signals (instructions) and data provided in conjunction with the control signals.

Second- or third-level storage devices 2310 may provide a slower but higher capacity machine memory capability. Examples of storage devices 2310 are hard disks, optical disks, large-capacity flash memories or other non-volatile memory technologies, and magnetic memories.

In one embodiment, memory 2306 may include virtual storage accessible through a connection with a cloud server using the network interface 2312, as described below. In such embodiments, some or all of the logic 2314 may be stored and processed remotely.

The processor 2302 may cause the configuration of the memory 2306 to be altered by signals in storage devices 2310. In other words, the processor 2302 may cause data and instructions to be read from storage devices 2310 in the memory 2306 which may then influence the operations of processor 2302 as instructions and data signals, and which may also be provided to the output devices 2308. The processor 2302 may alter the content of the memory 2306 by signaling to a machine interface of memory 2306 to alter the internal configuration and then converted signals to the storage devices 2310 alter its material internal configuration. In other words, data and instructions may be backed up from memory 2306, which is often volatile, to storage devices 2310, which are often non-volatile.

Output devices 2308 are transducers that convert signals received from the memory 2306 into physical phenomena such as vibrations in the air, patterns of light on a machine display, vibrations (i.e., haptic devices), or patterns of ink or other materials (i.e., printers and 3-D printers).

The network interface 2312 receives signals from the memory 2306 and converts them into electrical, optical, or wireless signals to other machines, typically via a machine network. The network interface 2312 also receives signals from the machine network and converts them into electrical, optical, or wireless signals to the memory 2306. The network interface 2312 may allow a robot to communicate with a cloud server 2322 containing logic 2314, a mobile device, other robots, and other network-enabled devices.

In one embodiment, a global database 2318 may provide data storage available across the devices that comprise or are supported by the robotic control system 2300. The global database 2318 may include maps, robotic instruction algorithms, robot state information, static, movable, and tidyable object reidentification fingerprints, labels, and other data associated with known static, movable, and tidyable object reidentification fingerprints, or other data supporting the implementation of the disclosed solution. The global database 2318 may be a single data structure or may be distributed across more than one data structure and storage platform, as may best suit an implementation of the disclosed solution. In one embodiment, the global database 2318 is coupled to other components of the robotic control system 2300 through a wired or wireless network, and in communication with the network interface 2312.

In one embodiment, a robot instruction database 2320 may provide data storage available across the devices that comprise or are supported by the robotic control system 2300. The robot instruction database 2320 may include the programmatic routines that direct specific actuators of the tidying robot, such as are described previously, to actuate and cease actuation in sequences that allow the tidying robot to perform individual and aggregate motions to complete tasks.

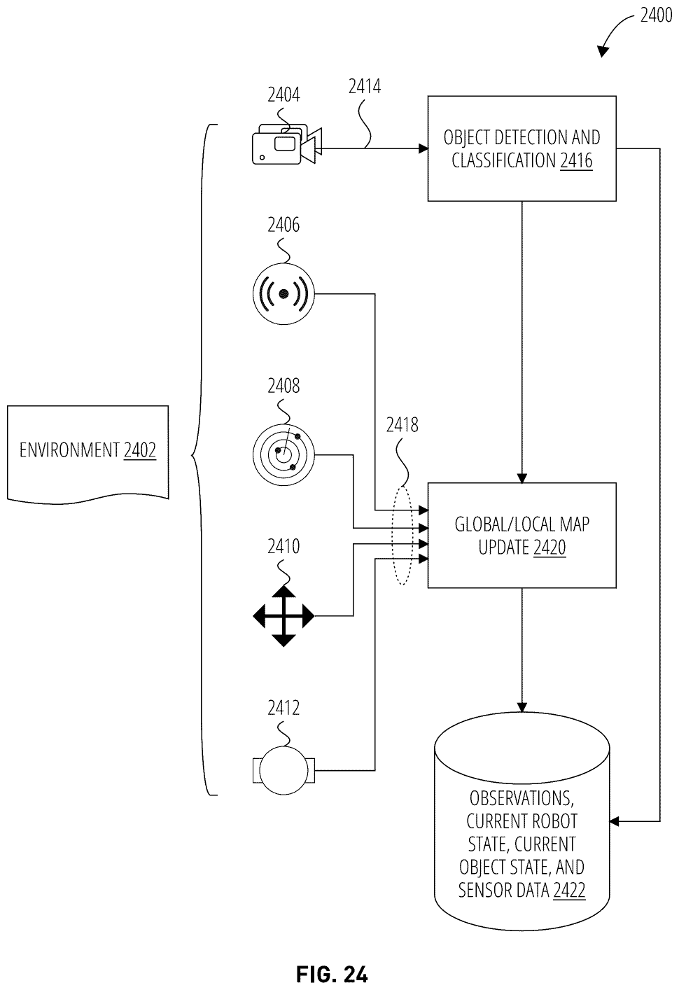

FIG. 24 illustrates sensor input analysis 2400 in accordance with one embodiment. Sensor input analysis 2400 may inform the tidying robot 100 of the dimensions of its immediate environment 2402 and the location of itself and other objects within that environment 2402.

The tidying robot 100 as previously described includes a sensing system 106. This sensing system 106 may include at least one of cameras 2404, IMU sensors 2406, lidar sensor 2408, odometry 2410, and actuator force feedback sensor 2412. These sensors may capture data describing the environment 2402 around the tidying robot 100.

Image data 2414 from the cameras 2404 may be used for object detection and classification 2416. Object detection and classification 2416 may be performed by algorithms and models configured within the robotic control system 2300 of the tidying robot 100. In this manner, the characteristics and types of objects in the environment 2402 may be determined.

Image data 2414, object detection and classification 2416 data, and other sensor data 2418 may be used for a global/local map update 2420. The global and/or local map may be stored by the tidying robot 100 and may represent its knowledge of the dimensions and objects within its decluttering environment 2402. This map may be used in navigation and strategy determination associated with decluttering tasks.

The tidying robot 100 may use a combination of camera 2404, lidar sensor 2408 and the other sensors to maintain a global or local area map of the environment and to localize itself within that. Additionally, the robot may perform object detection and object classification and may generate visual re-identification fingerprints for each object. The robot may utilize stereo cameras along with a machine learning/neural network software architecture (e.g., semi-supervised or supervised convolutional neural network) to efficiently classify the type, size and location of different objects on a map of the environment.

The robot may determine the relative distance and angle to each object. The distance and angle may then be used to localize objects on the global or local area map. The robot may utilize both forward and back ward facing cameras to scan both to the front and to the rear of the robot.

image data 2414, object detection and classification 2416 data, other sensor data 2418, and global/local map update 2420 data may be stored as observations, current robot state, current object state, and sensor data 2422. The observations, current robot state, current object state, and sensor data 2422 may be used by the robotic control system 2300 of the tidying robot 100 in determining navigation paths and task strategies.

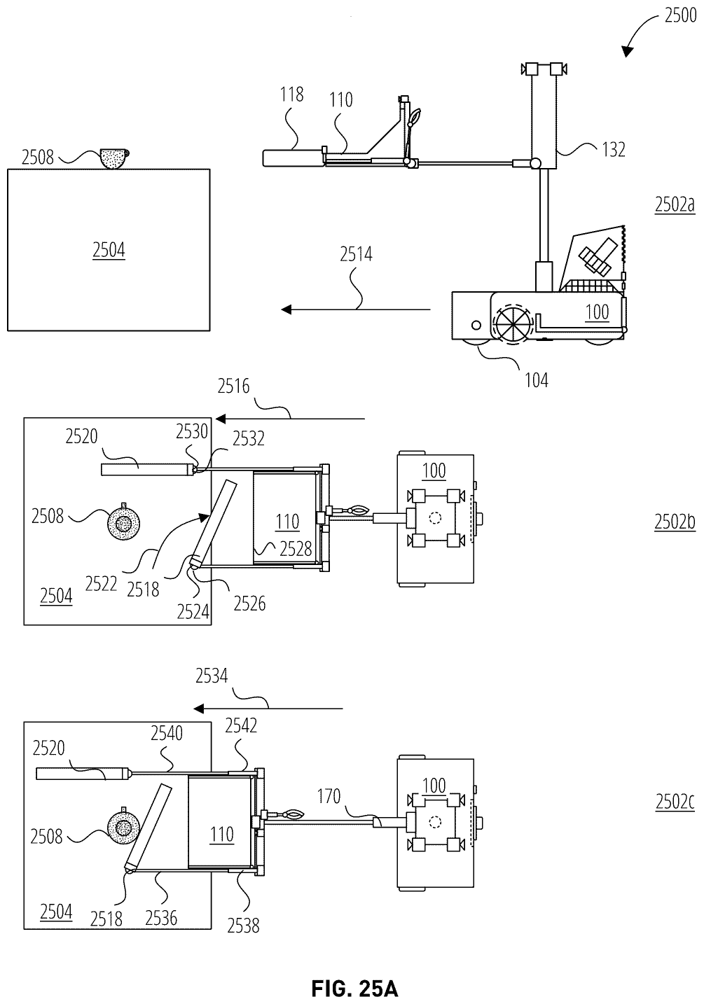

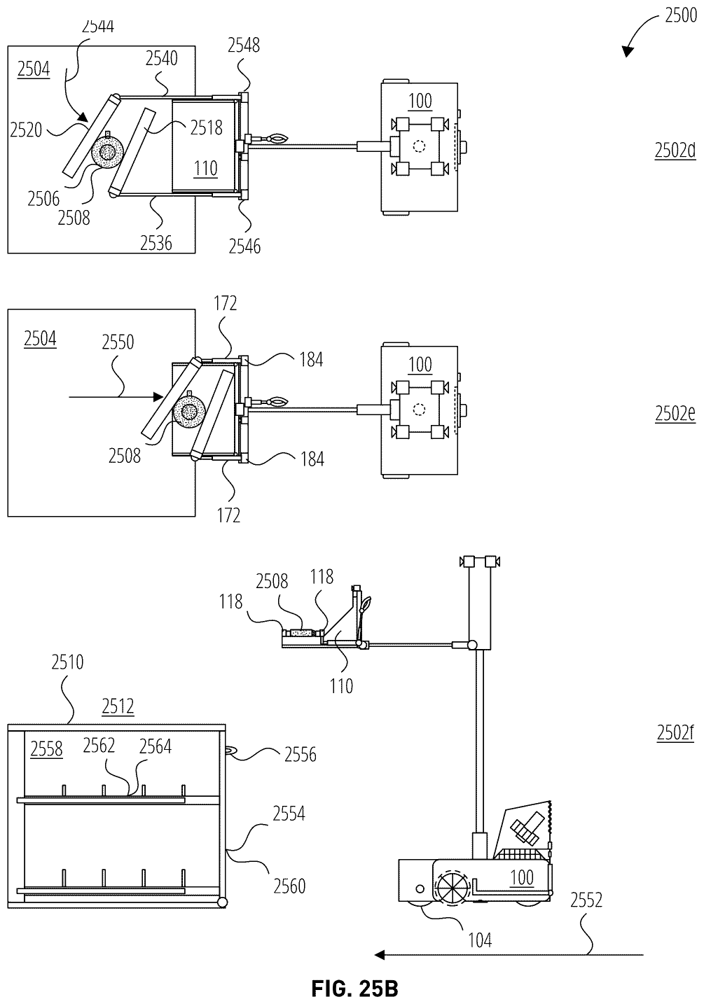

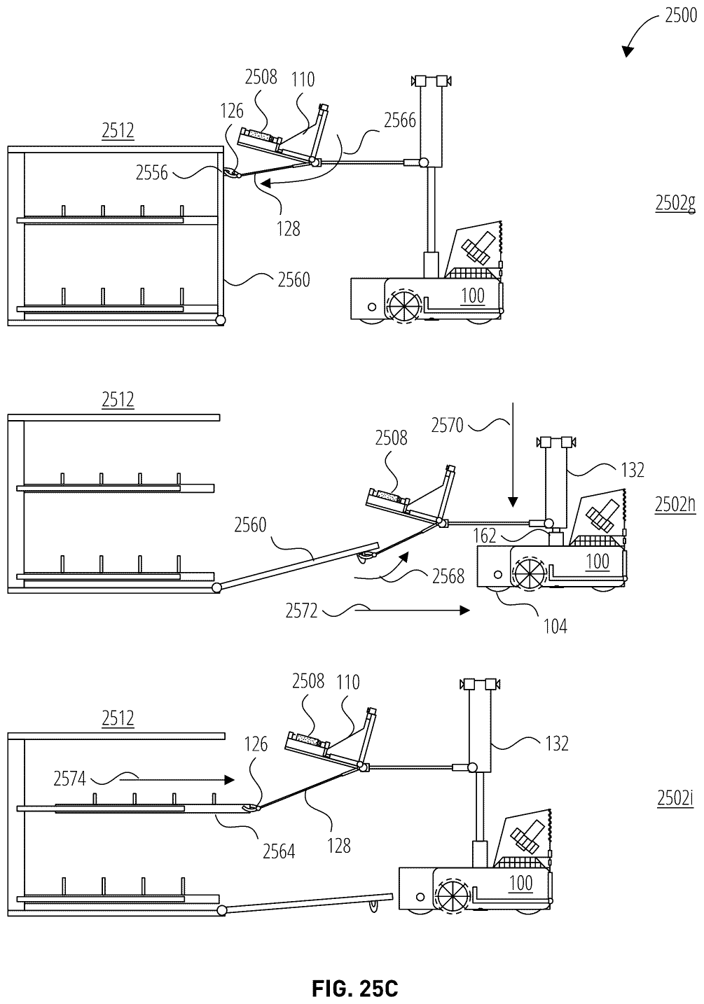

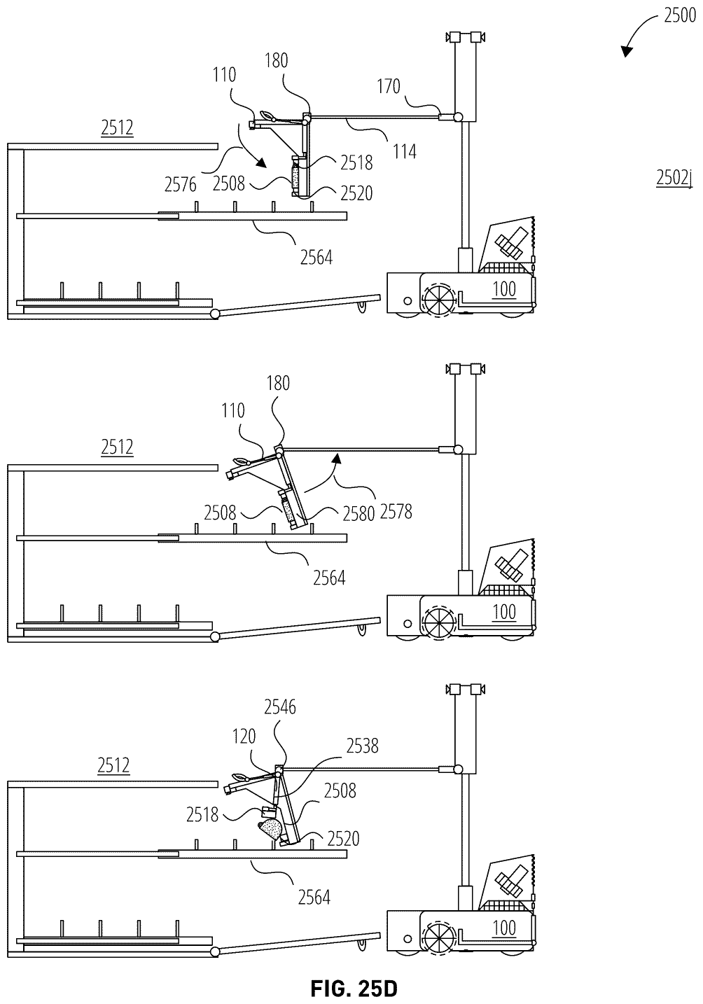

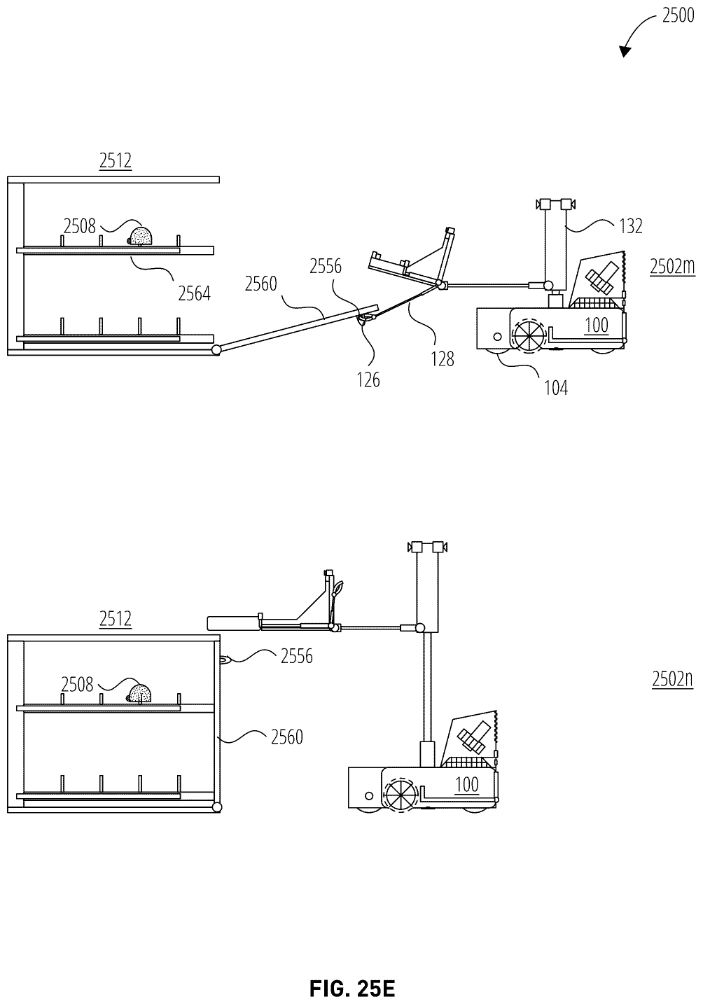

FIG. 25A-FIG. 25E illustrate an obstruction placement procedure 2500 in accordance with one embodiment. Steps 2502a-2502n illustrate the actions a tidying robot 100 may take to approach a tabletop or countertop 2504, remove an obstruction 2506 such as a dirty cup 2508, and place it at a destination 2510, such as a dishwasher 2512. In step 2502a, the tidying robot 100 may approach 2514 the countertop 2504 through the action of the mobility system 104. The tidying robot 100 may have its pusher pads 118 extended in front of the scoop 110. The lifting column 132 may be elevated such that the bottom of the scoop 110 is level with and slightly above the top of the countertop 2504.

In step 2502b, the tidying robot 100 may continue to approach 2516 the countertop 2504 and the cup 2508 with the first pusher pad 2518 rotated inward 2522 at a first pad pivot point 2524 by a first pusher pad motor 2526 toward the front edge 2528 of the scoop 110, and parallel to or angled toward that front edge 2528. The second pusher pad 2520 may be open and pointing forward as shown or may be rotated outward at a second pad pivot point 2530 by a second pusher pad motor 2532 to be further away from the scoop 110 front edge 2528. In step 2502c, the tidying robot 100 may drive forward or may extend 2534 the scoop arm linear actuator 170, and/or the first pusher pad arm 2536 using the first pusher pad arm linear actuator 2538 and the second pusher pad arm 2540 using the second pusher pad arm linear actuator 2542, horizontally forward until the cup 2508 is in contact with the first pusher pad 2518.

In step 2502d, the tidying robot 100 may close 2544 the second pusher pad 2520 so that the cup 2508 is held firmly between the first pusher pad 2518 and the second pusher pad 2520. The first pusher pad arm motor 2546 at the base of the first pusher pad arm 2536 and the second pusher pad arm motor 2548 at the base of the second pusher pad arm 2540 may be rotated to lift the cup 2508 slightly up and off of the countertop 2504. The cup 2508 may be positioned slightly above the level of the front edge 2528 of the scoop 110. In step 2502e, the pusher pad arm linear actuators 172 may retract 2550 so that the cup 2508 passes above the front edge 2528 into an area fully above the scoop 110. The first and second pusher pad arm motors 184 may rotate to lower the cup 2508 onto the scoop 110.

In step 2502f, the tidying robot 100 may plan and execute an approach path 2552, using the mobility system 104 to drive from the countertop 2504 to the destination 2510, such as the dishwasher 2512. The destination 2510 may have an access panel 2554 with a handle 2556 allowing access to an interior of the destination 2558, such as a dishwasher door 2560. The destination 2510 may include storage platforms 2562 such as dishwasher trays 2564. During path planning and navigation, the tidying robot 100 may hold the cup 2508 securely in the scoop 110 with the pusher pads 118. In step 2502g, the tidying robot 100 may rotate and extend 2566 the gripper arm 128 underneath the scoop 110 so that the gripper arm 128 or actuated gripper 126 may grab the handle 2556 of the dishwasher door 2560.

In step 2502h, the tidying robot 100 may retract and potentially rotate 2568 the gripper arm 128 to begin opening the dishwasher 2512. The tidying robot 100 may then retract the lifting column linear actuator 162 to lower 2570 the lifting column 132 while backing up 2572 using its mobility system 104 to fully open the dishwasher door 2560. In step 2502i, the tidying robot 100 may use the gripper arm 128 or actuated gripper 126 to pull out 2574 one of the dishwasher trays 2564 while still holding the cup 2508 securely in the scoop 110. This action may be performed through similar forward and backward motions of the tidying robot 100 along with extension, retraction, and rotation of the gripper arm 128, raising and lowering of the lifting column 132, etc.

In step 2502j, the tidying robot 100 may extend the scoop arm linear actuator 170 of the scoop arm 114 so that the scoop 110 is over the dishwasher tray 2564. The scoop motor 180 may rotate 2578 so that the scoop 110 begins to invert 2576. At this time, the first pusher pad 2518 and second pusher pad 2520 may still apply firm pressure to the cup 2508. In step 2502k, the scoop motor 180 may continue to rotate 2578 the scoop 110 so that the cup 2508 is held in a partially inverted position 2580 slightly above the dishwasher tray 2564 while the cup is still held securely in the scoop 110.

In step 2502l, the first pusher pad 2518 may rotate slightly through the action of its first pusher pad arm motor 2546, and the first pusher pad arm linear actuator 2538 may extend slightly as shown, moving the cup 2508 slowly out of the scoop 110 and onto the dishwasher tray 2564. The first pusher pad 2518 and second pusher pad 2520 may maintain firm pressure on the cup 2508 as it is being moved to keep its motion steady and controlled. In step 2502m, the cup 2508 may now rest safely on the dishwasher tray 2564. The tidying robot 100 may push the dishwasher tray 2564 back into the dishwasher 2512 and close the dishwasher door 2560 through coordinated operation of the mobility system 104, gripper arm 128, lifting column 132, etc., in a manner similar to the steps previously described.

In step 2502n, now that the cup 2508 is in the dishwasher 2512, the dishwasher door 2560 is closed, and the handle 2556 is released, the tidying robot 100 may plan a path to return to the countertop to pick up another dish to put in the dishwasher 2512, to navigate to a base station, or to perform other tidying tasks. One of ordinary skill in the art will appreciate that, while the first pusher pad is shown here to be the left pusher pad and the second pusher pad is illustrated as the right pusher pad, the actions described here and elsewhere in this disclosure may be performed as readily with the right pusher pad being the first and the left the second. The designations “first,” “second,” “right,” and “left” used herein are not intended to limit the performance of these actions to a specifically sided sequence of motion for the tidying robot 100.

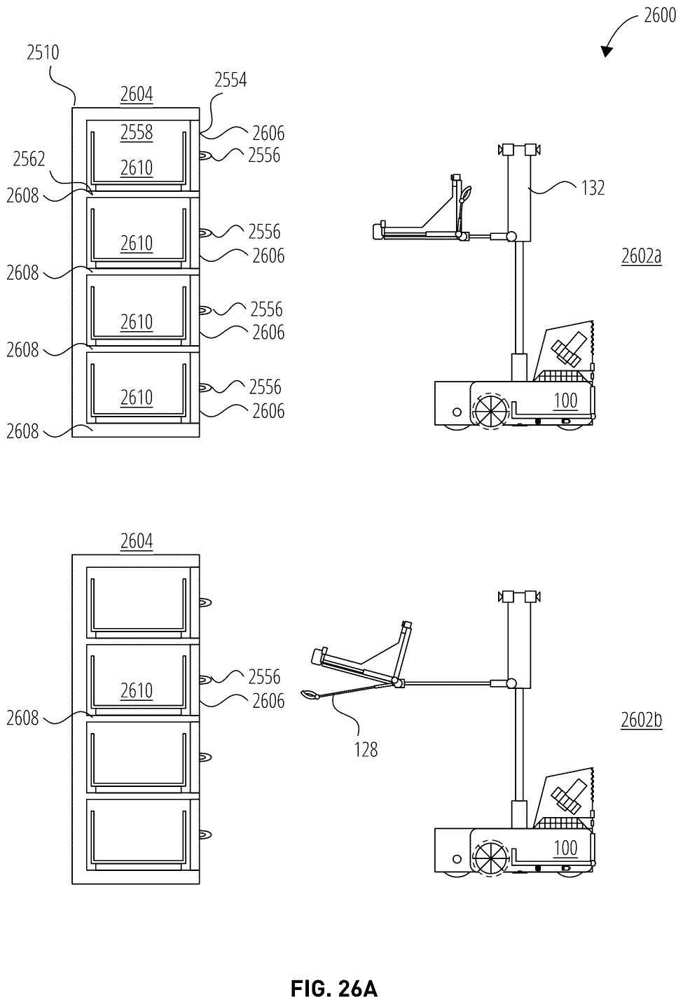

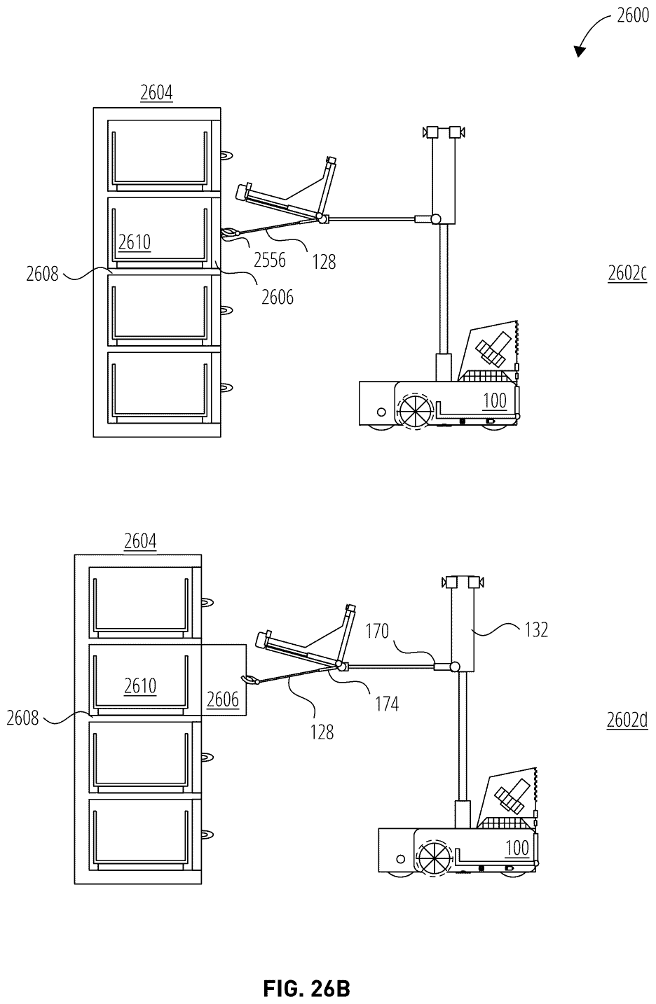

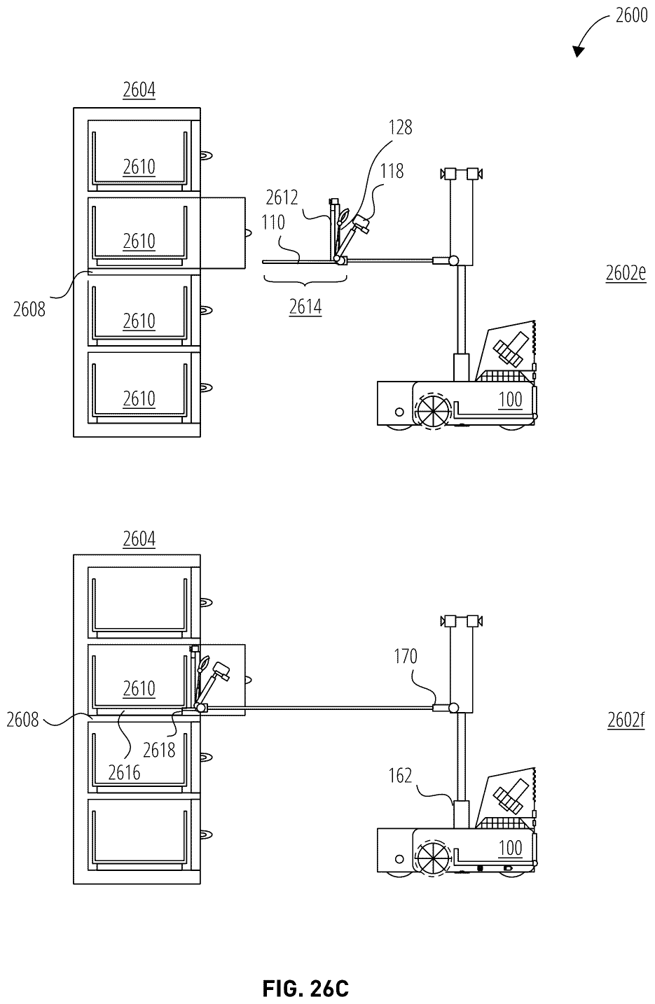

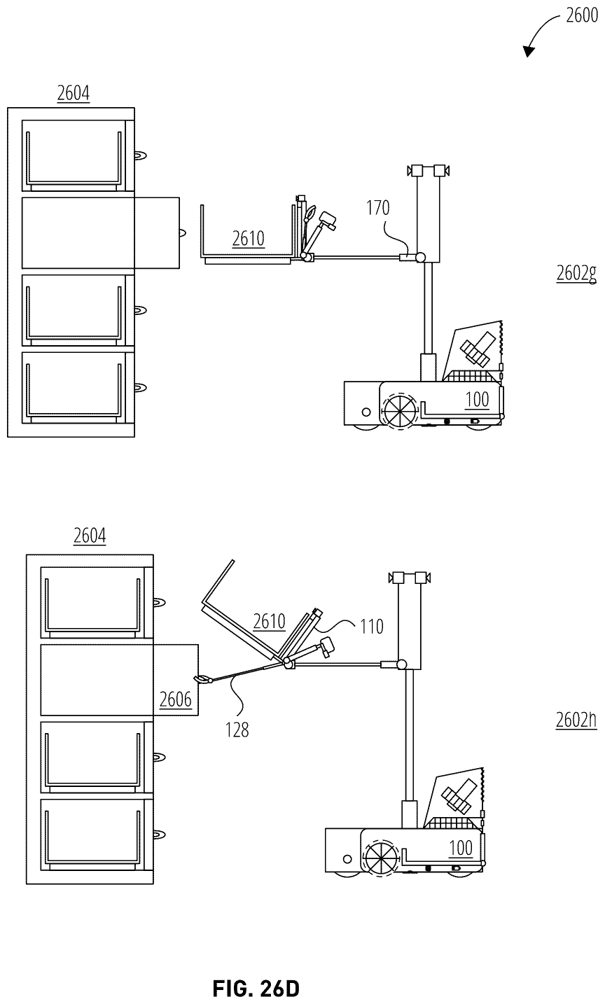

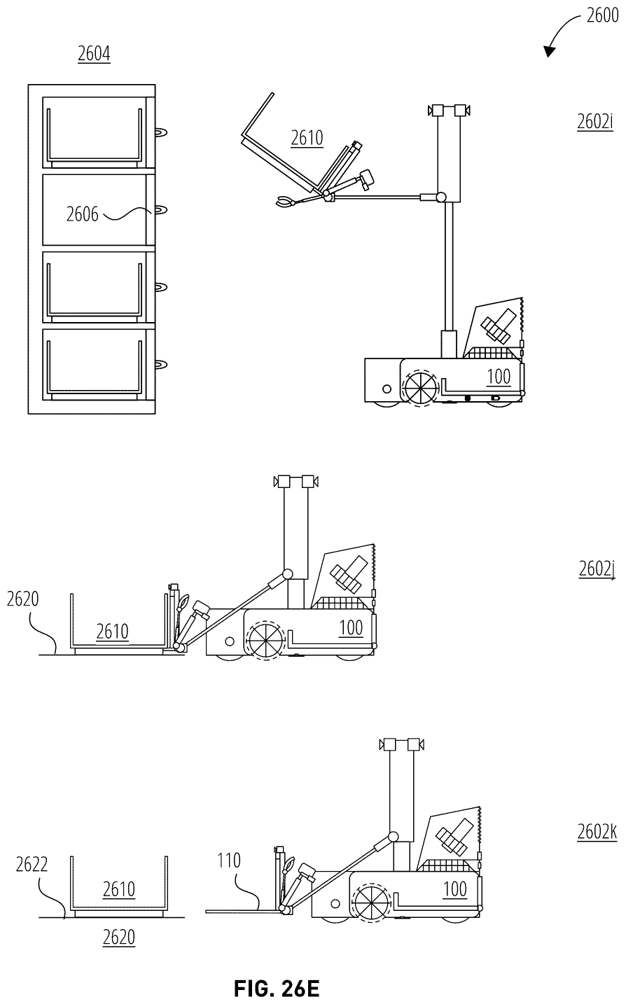

FIG. 26A-FIG. 26E illustrate an obstruction placement procedure 2600 in accordance with one embodiment. In steps 2602a-2602k of this process, a tidying robot 100 may operate to approach a destination 2510 with access panels 2554 having handles 2556 allowing access to an interior of the destination 2558, as well as storage platforms 2562, such as cabinet 2604 having handled cabinet doors 2606 and shelves 2608 for storing portable bins 2610. The portable bins 2610 may be configured to be lifted and carried by the tidying robot 100. The portable bins 2610 may be configured for carrying by the tidying robot 100 as shown for portable bins 3600-4700 illustrated in FIG. 36-FIG. 47. The tidying robot 100 may be configured with movable scoop walls, such as the tidying robots with movable scoop walls 3200-3500.

In step 2602a, the tidying robot 100 may approach a cabinet 2604 or closet having closed cabinet doors 2606, behind which are stored portable bins 2610 on shelves 2608. The lifting column 132 may be raised to a height appropriate to engage with a desired cabinet door 2606 handle 2556 of the cabinet 2604. In step 2602b, the tidying robot 100 may extend its gripper arm 128 toward the handle 2556 of the desired cabinet door 2606. The tidying robot 100 may follow an algorithm to explore the cabinet 2604 and identify different portable bins 2610 and their locations within it to detect the correct one, may store a lookup table of specific portable bin 2610 locations, etc.

In step 2602c, the gripper arm 128 (or actuated gripper 126) may engage with and close around the cabinet door 2606 handle 2556 in order to grasp it. In step 2602d, the gripper arm linear actuator 174 may retract, the scoop arm linear actuator 170 may retract, or the tidying robot 100 may drive backwards to open the cabinet door 2606. Note that the base of the gripper arm 128 may allow some deflection (e.g., by incorporating a spring) as the cabinet door 2606 likely rotates while opening. The tidying robot 100 may also turn in its entirety or the lifting column 132 may rotate slightly to account for the rotation of the opening cabinet door 2606.

In step 2602e, the movable scoop walls 2612 may rotate back into the scoop 110 or otherwise out of the way so that sides of the scoop 110 don't interfere with the scoop 110 passing beneath portable bins 2610. Similarly, the gripper arm 128 and pusher pads 118 may be moved so as to avoid obstructing engagement of the scoop 110 with the portable bin 2610. In this position, the scoop 110 may be considered to be in a “forklift” configuration (forklift configuration 2614) for engaging with the desired portable bin 2610. In step 2602f, the tidying robot 100 may extend the scoop arm linear actuator 170 or may drive forward so that the scoop 110 passes beneath the portable bin 2610 in the cabinet 2604. The lifting column linear actuator 162 may be extended to lift the portable bin 2610 slightly up off of the cabinet 2604 shelf 2608.

In one embodiment, the portable bin 2610 may have a scoop slot 2616 that includes a scoop slot opening 2618. The scoop slot opening 2618 may allow the scoop 110 to pass into the scoop slot 2616, and the scoop slot 2616 may allow the portable bin 2610 to remain engaged with the scoop 110 as the scoop 110 is manipulated into various positions and orientations. In step 2602f, the scoop arm linear actuator 170 may extend and insert the scoop 110 into the scoop slot opening 2618 until a known position is reached or a force detector detects resistance indicating that the scoop 110 is fully seated within the scoop slot 2616.

In step 2602g, the tidying robot 100 may back away from the cabinet 2604 and/or retract the scoop arm linear actuator 170, moving the portable bin 2610 out of the cabinet 2604. In step 2602h, the tidying robot 100 may tilt the scoop 110 up and back while extending the gripper arm 128 to grasp the cabinet door 2606. The tidying robot 100 may then close the cabinet door 2606 by pushing with the gripper arm 128.

In step 2602i, after closing the cabinet door 2606, the tidying robot 100 may drive away while carrying the portable bin 2610. In step 2602j, the tidying robot 100 may lower the portable bin 2610 onto the floor 2620. The portable bin 2610 may also be placed by the tidying robot 100 onto a table, a countertop, or other stable, flat surface 2622. In step 2602k, the tidying robot 100 may back up, leaving the portable bin 2610 on the floor 2620 or other surface. The portable bin 2610 may include legs or a slot under it so the tidying robot 100 may easily remove its scoop 110 from under the portable bin 2610.

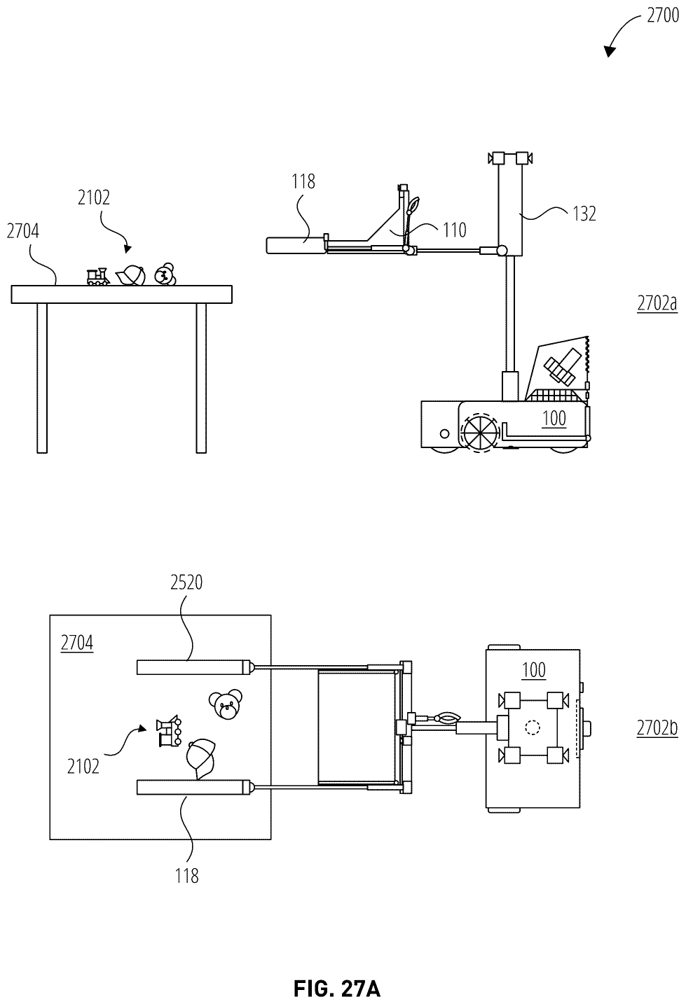

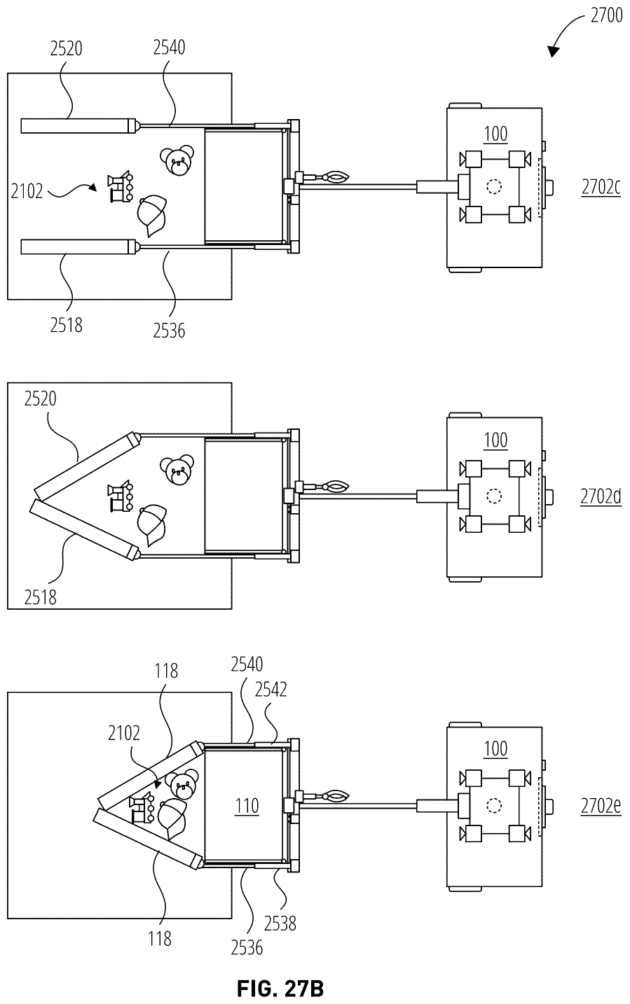

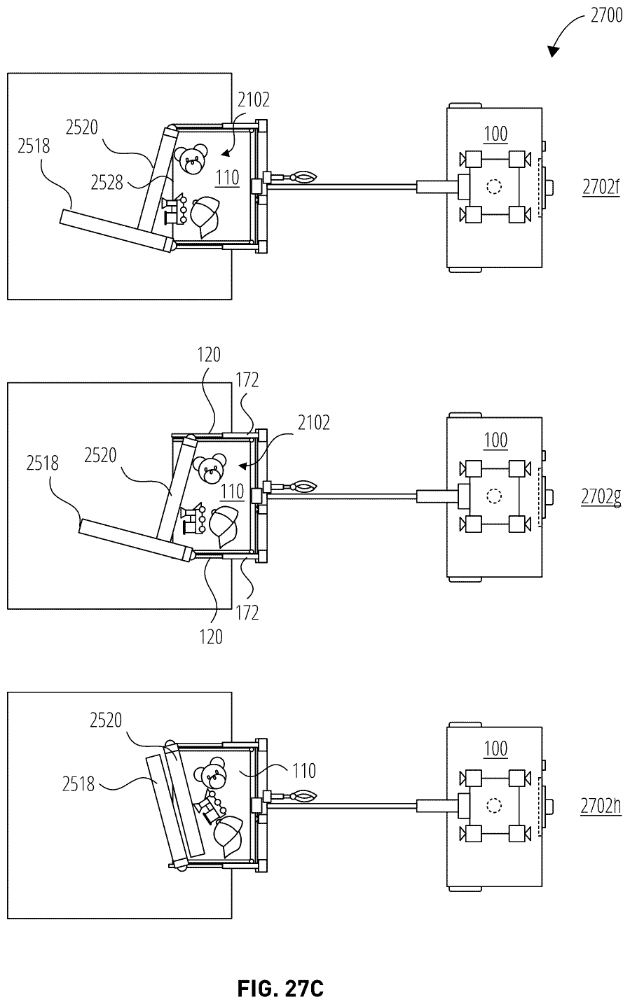

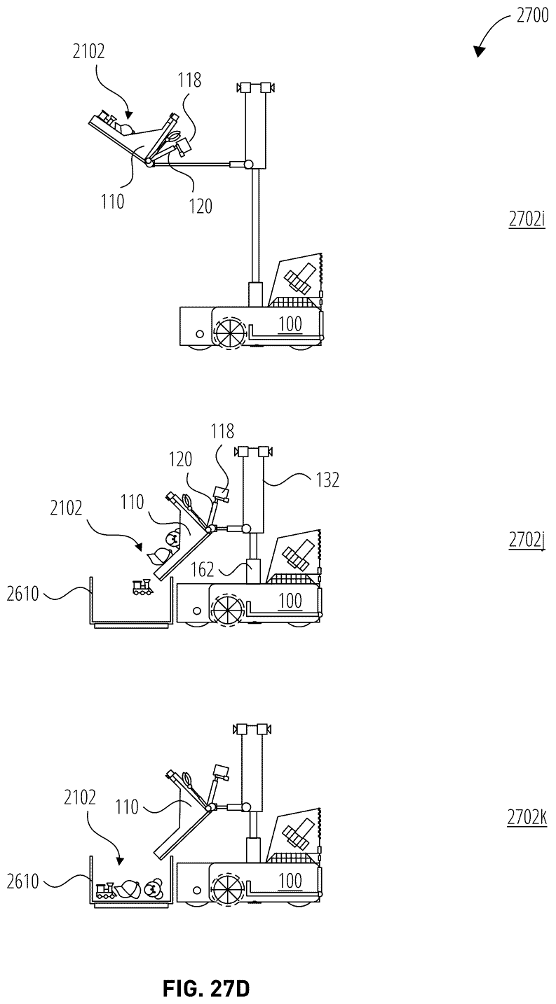

FIG. 27A-FIG. 27D illustrate a process for tidying tidyable objects from a table into a bin 2700 in accordance with one embodiment. Steps 2702a-2702k illustrate a tidying robot 100 completing the actions needed for this process. In step 2702a, the tidying robot 100 may drive to an elevated surface 2704 such as a table that has tidyable objects 2102 on it, with the lifting column 132 set at a height such that the scoop 110 and pusher pads 118 are higher than the top of the elevated surface 2704. The tidying robot 100 may continue to drive toward the elevated surface 2704 in step 2702b with the first pusher pad 2518 and second pusher pad 2520 extended forward so that the target tidyable objects 2102 may fit between them.

The tidying robot 100 may drive forward in step 2702c so that the tidyable objects 2102 are in front of the scoop 110 and in between the first pusher pad 2518 and second pusher pad 2520. The second pusher pad arm 2540 and first pusher pad arm 2536 may be extended so that the first pusher pad 2518 and second pusher pad 2520 are past the tidyable objects 2102. In step 2702d, the first pusher pad 2518 and the second pusher pad 2520 may be closed into a wedge configuration so that there is no gap between the tips of the pusher pads. In step 2702c, the tidying robot 100 may retract the first pusher pad arm linear actuator 2538 and second pusher pad arm linear actuator 2542 so that the tidyable objects 2102 are fully surrounded by the pusher pads 118 and the scoop 110.

In step 2702f, the tidying robot 100 may close the second pusher pad 2520 so that the tidyable objects 2102 are pushed across the front edge 2528 of the scoop 110. The first pusher pad 2518 may move slightly to make space and to prevent a gap from forming between the first pusher pad 2518 and the second pusher pad 2520. Alternatively, the first pusher pad 2518 may be closed instead. In step 2702g, the pusher pad arm 120 pusher pad arm linear actuators 172 may be retracted to further push the tidyable objects 2102 into the scoop 110. In step 2702h, the first pusher pad 2518 and second pusher pad 2520 may be fully closed across the front of the scoop 110.

In step 2702i, the tidying robot 100 may tilt the scoop 110 up and back, creating a “bowl” configuration in order to carry the tidyable objects 2102. In step 2702j, the tidying robot 100 may drive to and may dock with a portable bin 2610 (or an object collection bin 1602 such as was previously illustrated in and described with respect to FIG. 16A). The tidying robot 100 may lower the lifting column 132 using the lifting column linear actuator 162, thereby lowering the scoop 110 to be just above the portable bin 2610. In step 2702j or previously, the tidying robot 100 may rotate the pusher pad arms 120 to move the pusher pads 118 away from the front of the scoop 110. The tidying robot 100 may tilt the scoop 110 forward in a front dump action 2100 as previously described. In step 2702k, the tidyable objects 2102 may fall off of the scoop 110 and into the portable bin 2610.

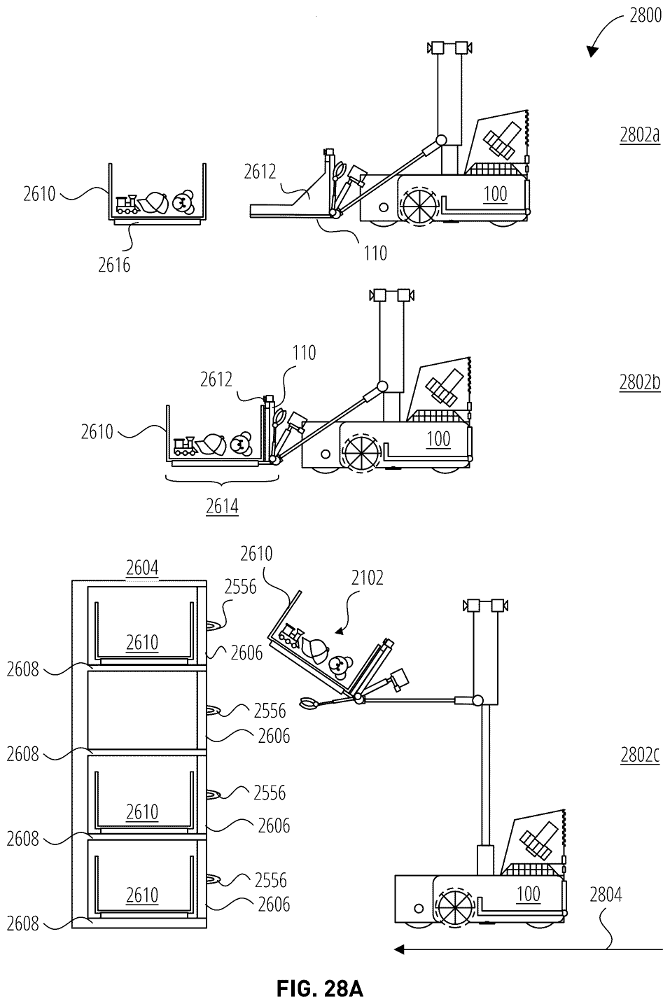

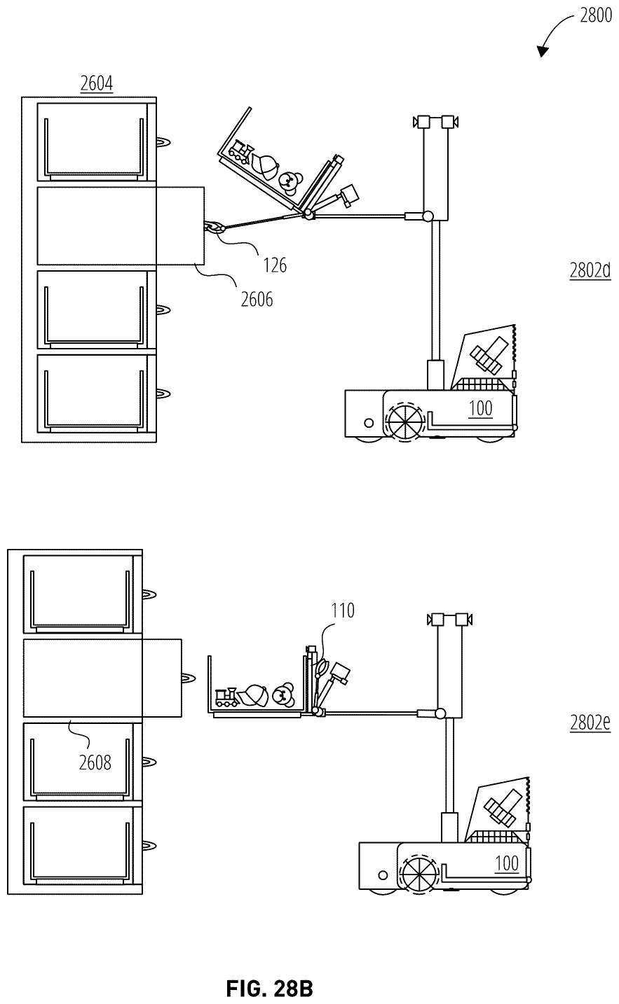

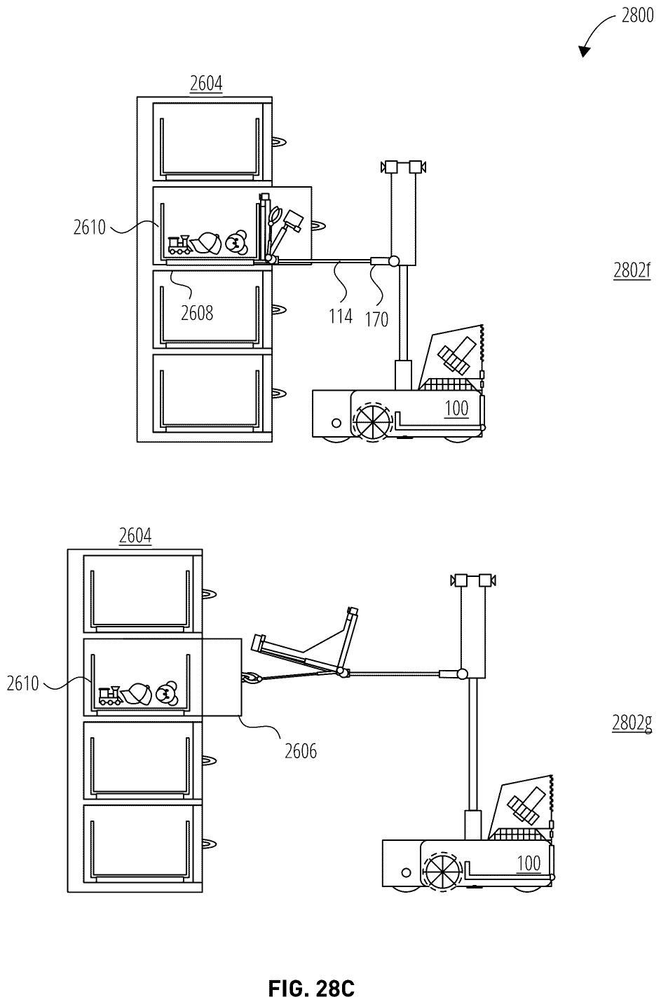

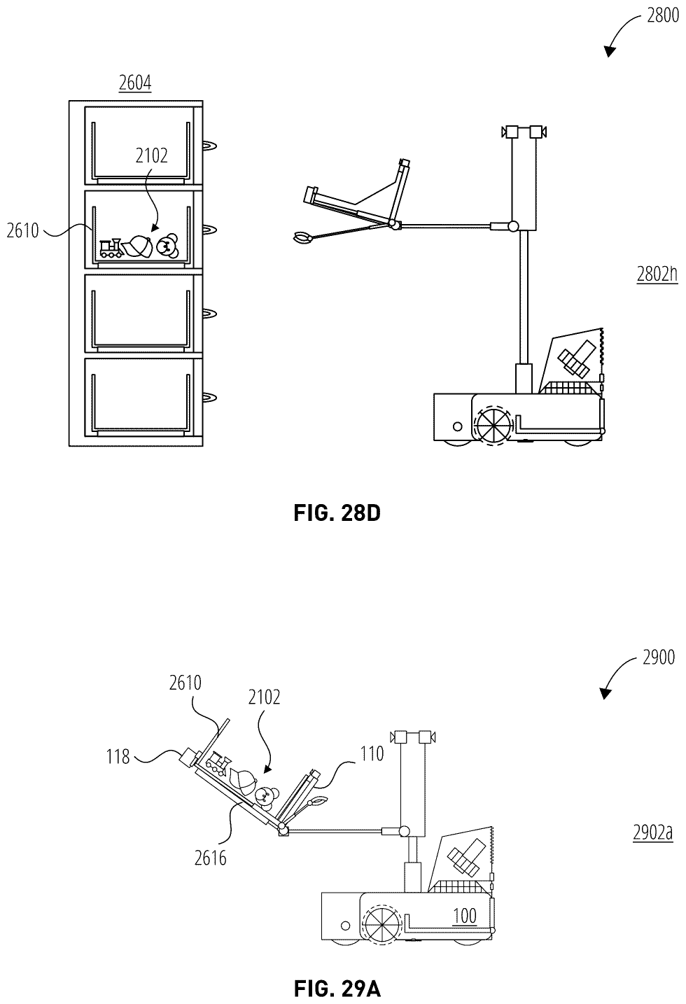

FIG. 28A-FIG. 28D illustrate a portable bin placement procedure 2800 in accordance with one embodiment. Steps 2802a-2802h illustrate a tidying robot 100 completing the actions needed for this process. In step 2802a, the tidying robot 100 may lower the scoop 110 to ground level (or countertop/table level) so that the bottom of the scoop 110 is flat, just above the found, table, or countertop surface. The movable scoop wall 2612 may be rotated, retracted, or otherwise repositioned so that the scoop 110 is configured in a forklift configuration 2614 where the side walls of the scoop 110 will not interfere with the scoop 110 going under bins or sliding into a scoop slot 2616 of a portable bin 2610. In step 2802b the tidying robot 100 may drive forward so that the scoop 110 goes under the bottom of the bin. This may be facilitated by configuring the bin with legs or a slot, making it easy for bottom of the scoop 110 to slide under the bin. Portable bins 2610 having such configurations are illustrated in FIG. 26-FIG. 47. In step 2802c, the tidying robot 100 may lift the portable bin 2610 full of tidyable objects 2102 and may navigate along a return approach path 2804 to a cabinet 2604 having cabinet doors 2606 with handles 2556 and shelves 2608 for storing portable bins 2610.

In step 2802d, the tidying robot 100 may extend its actuated gripper 126 and use the actuated gripper 126 to open the cabinet 2604 cabinet door 2606 behind which it wishes to place the portable bin 2610. In step 2802e, the tidying robot 100 may align the scoop 110 to be flat and level with the cabinet 2604 shelf 2608.

In step 2802f, the tidying robot 100 may drive forward or may extend the scoop arm 114 scoop arm linear actuator 170 so that the portable bin 2610 is held slightly above the cabinet 2604 shelf 2608. The tidying robot 100 may then lower the scoop 110 slightly so the portable bin 2610 is supported by the cabinet 2604 shelf 2608. In step 2802g, the tidying robot 100 may back up, leaving the portable bin 2610 in the cabinet 2604. The tidying robot 100 may use the actuated gripper 126 to close the cabinet 2604 cabinet door 2606. The portable bin 2610 full of tidyable object 2102 is now put away in the closed cabinet 2604, as shown in step 2802h.

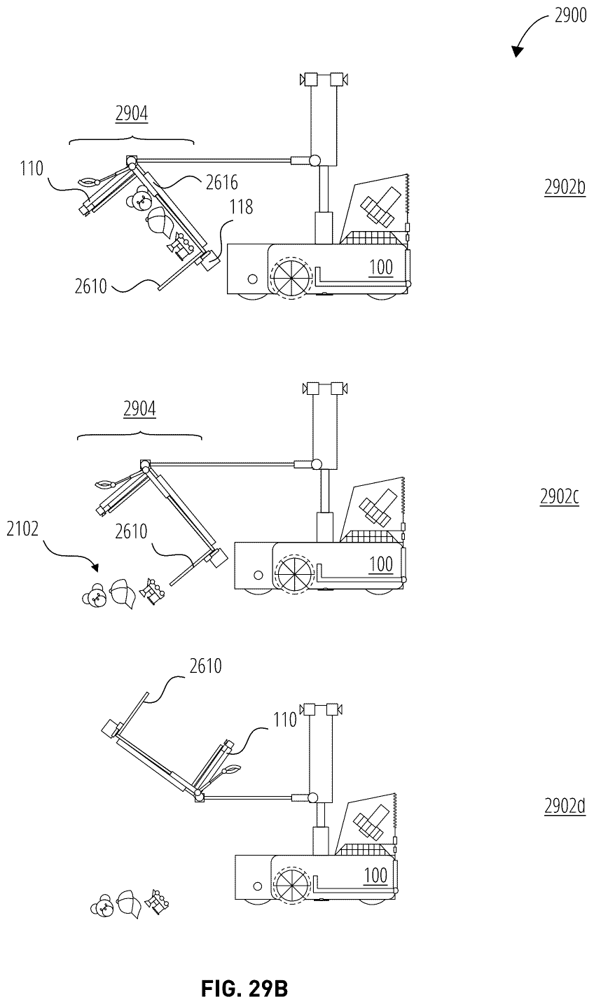

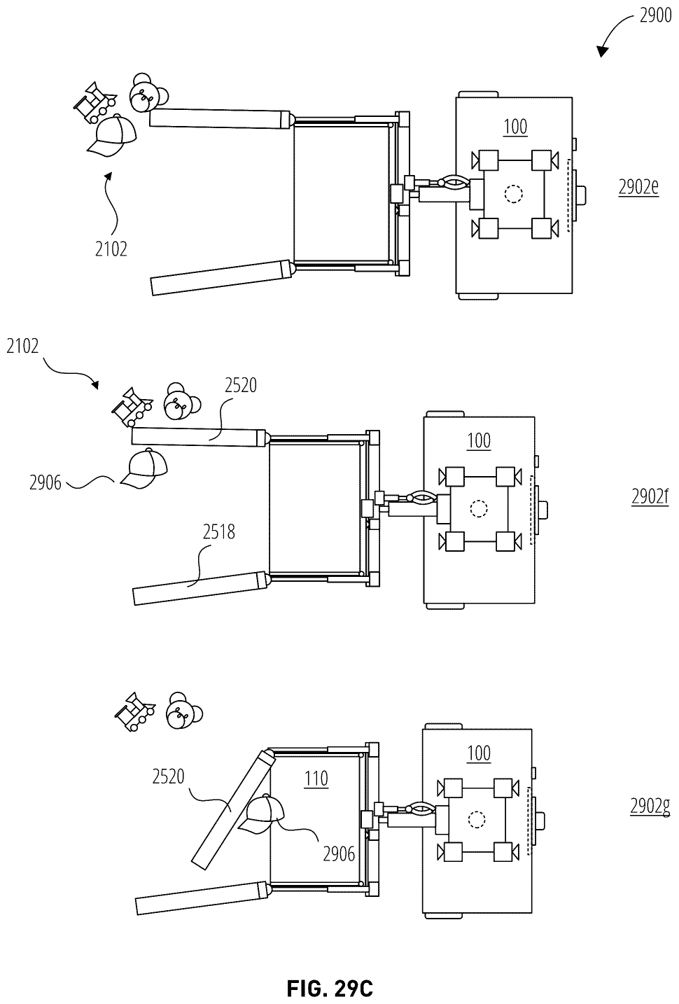

FIG. 29A-FIG. 29C illustrate a process for emptying tidyable objects from a bin and sorting them on the floor 2900 in accordance with one embodiment. Steps 2902a-2902g illustrate a tidying robot 100 completing the actions needed for this process. In step 2902a, the bottom of the scoop 110 of the tidying robot 100 may reside within the scoop slot 2616 under the portable bin 2610 full of tidyable objects 2102, which may be accomplished in a manner similar to that described previously. The left and right pusher pads 118 may be closed in front of the portable bin 2610.

In step 2902b, the scoop 110 may tilt forward into an inverted position 2904, but the portable bin 2610 may still be retained due to the bottom of the scoop 110 being through the scoop slot 2616 on the portable bin 2610 while the pusher pads 118 keep the portable bin 2610 from sliding forward.

In step 2902c, the tidyable objects 2102 may fall out of the portable bin 2610 onto the floor (or another destination location such as a play mat, table, countertop, bed, or toy chest). In step 2902d, the scoop 110 may be tilted back up and back. The tidying robot 100 may continue to carry the now empty portable bin 2610.

Tidyable objects 2102 may be sorted by the tidying robot 100 on the floor in step 2902c. In step 2902f, the second pusher pad 2520 may be driven forward between tidyable objects 2102 in order to separate the target object(s), such as the target object 2906 shown, from objects that are intended to be left on the floor. Alternatively, the first pusher pad 2518 may be used to separate the target object(s) from those intended to remain on the floor, though this is not illustrated.

In step 2902g, the second pusher pad 2520 may rotate closed, pushing the target object 2906 onto the scoop 110. The scoop 110 may be then lifted up and back in order to carry the target object 2906 or target objects 2906 and then dump them into a target bin or another target location.

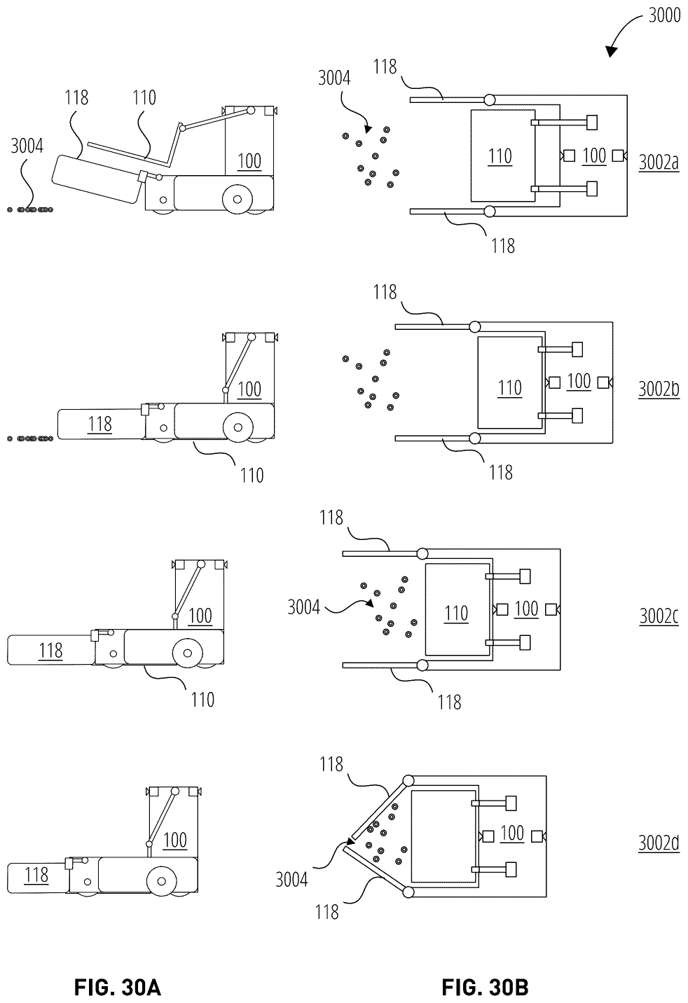

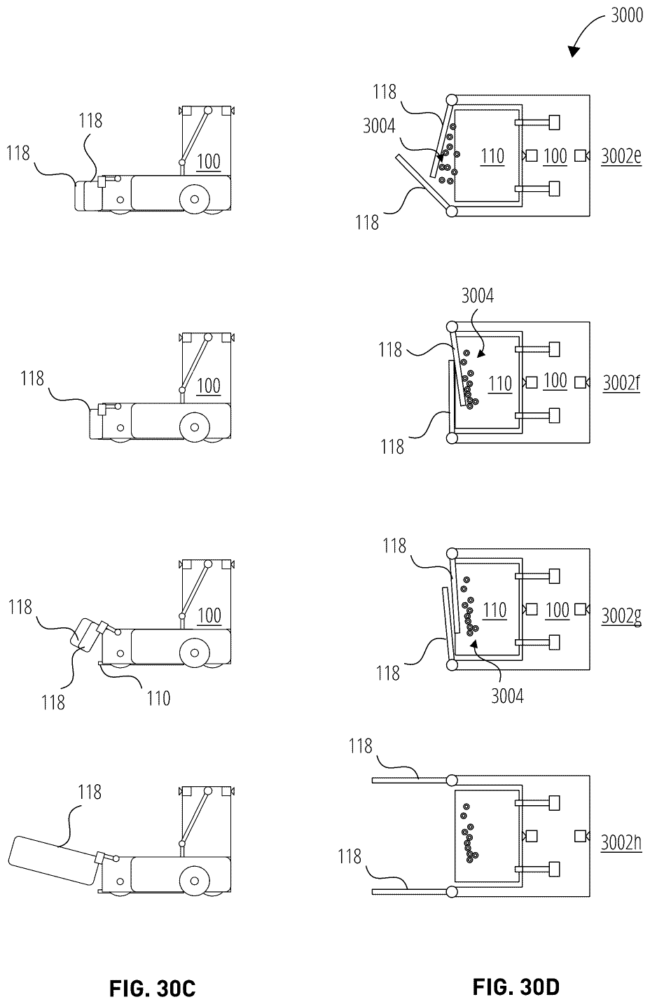

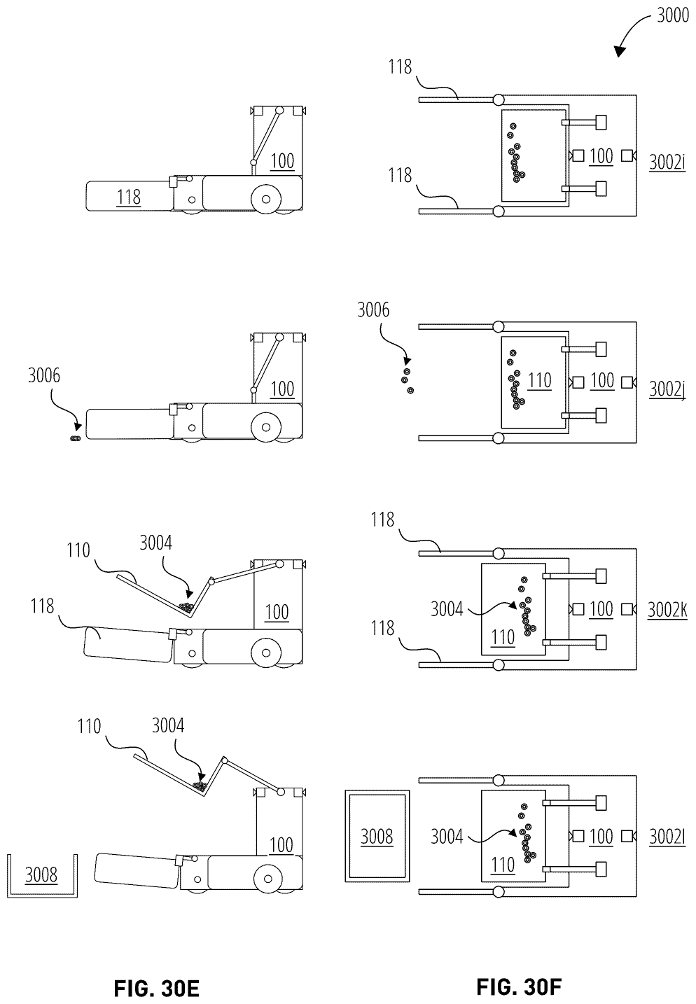

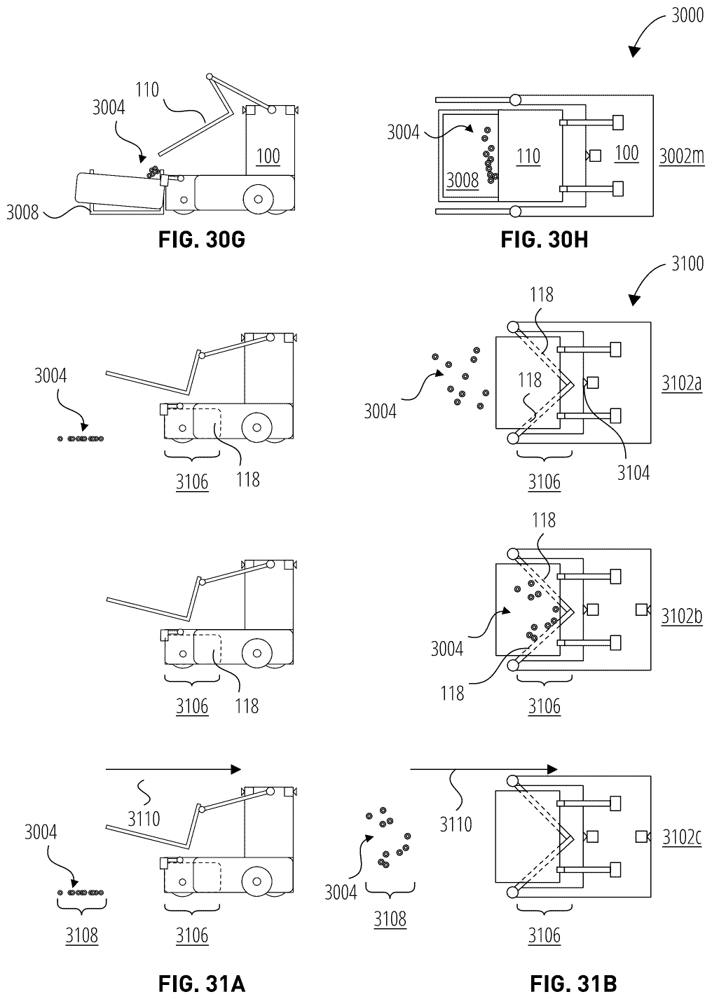

FIG. 30A-FIG. 30H illustrate a process for pre-sweeping a floor 3000 in accordance with one embodiment. FIG. 30A FIG. 30C, FIG. 30E, and FIG. 30G illustrate a side view of the steps performed and FIG. 30B, FIG. 30D, FIG. 30F, and FIG. 30H illustrate a top view of each step. Steps 3002a-3002m illustrate a tidying robot 100 completing the actions needed for this process.

While following a standard vacuuming pattern with the scoop 110 lifted and pusher pads 118 lifted in step 3002a, the tidying robot 100 may encounter heavy dirt and debris 3004 on the floor that cannot be easily vacuumed (e.g., dropped food, small rocks, broken glass, hair, etc.). In step 3002b, the tidying robot 100 may drop its pusher pads 118 and scoop 110 to be level against the floor. In step 3002c, the tidying robot 100 may drive forward so that the target heavy dirt and debris 3004 is between the pusher pads 118 and toward scoop 110 edge. In step 3002d, the tidying robot 100 may close its pusher pads 118 to fully encapsulate the target heavy dirt and debris 3004.

In step 3002e, the tidying robot 100 may use the pusher pads 118 to push the heavy dirt and debris 3004 toward the scoop 110 while minimizing the gap between the pusher pads 118. In step 3002f, the tidying robot 100 may fully push the heavy dirt and debris 3004 onto the scoop 110 with one pusher pad 118 following closely behind the other pusher pad 118 so that there is no gap. In step 3002g, the tidying robot 100 may lift the pusher pads 118 up to avoid pushing the heavy dirt and debris 3004 out of the scoop 110. In step 3002h, the tidying robot 100 may open the pusher pads 118 while they are lifted.

In step 3002i, the tidying robot 100 may drop its pusher pads 118 back to floor level. In step 3002j, the tidying robot 100 may drive forward to pick up additional heavy dirt and debris 3006 that is still on the floor, repeating the process from step 3002b on, adding more heavy dirt and debris 3004 to the scoop 110. In step 3002k, the tidying robot 100 may lift its scoop 110 and pusher pads 118 when done picking up the heavy dirt and debris 3004. The tidying robot 100 may continue to follow the standard vacuuming pattern, incrementally picking up additional heavy dirt and debris 3006 into the scoop 110 as needed.

In step 3002l, when done vacuuming, or when the scoop 110 is full, the tidying robot 100 may navigate to a disposal location 3008 in order to dump heavy dirt and debris 3004 out of the scoop 110. In step 3002m, the tidying robot 100 may dock with the disposal location 3008 and dump the heavy dirt and debris 3004 out of the scoop 110. The tidying robot 100 may then continue vacuuming, return to a base station if vacuuming is complete, perform or explore for additional tasks, etc.

FIG. 31A and FIG. 31B illustrate a process for sweeping in an inverted wedge configuration 3100 in accordance with one embodiment. FIG. 31A shows a side view and FIG. 31B a top view of the tidying robot 100 performing each step. Steps 3102a-3102c illustrate a tidying robot 100 completing the actions needed for this process.

In step 3102a, the pusher pads 118 may rotate back toward the center of the chassis 3104 and so be placed in an inverted wedge configuration 3106 in front of the vacuum intake port to passively collect heavy dirt and debris 3004 on the floor as the tidying robot 100 drives forward. In step 3102b, the inverted wedge configuration 3106 may encourage the heavy dirt and debris 3004 to accumulate toward the center where the pusher pads 118 meet as the tidying robot 100 drives forward.

Once sufficient heavy dirt and debris 3004 accumulates, or if the tidying robot 100 encounters obstructions it needs to handle, the tidying robot 100 may push the heavy dirt and debris 3004 to an intermediate location 3108, as shown in step 3102c. The tidying robot 100 may back up a full robot length 3110, open its pusher pads 118 and go through a pickup cycle to collect the pile of heavy dirt and debris 3004, as described above with respect to steps 3002j-3002m shown in FIG. 30E-FIG. 30H. The tidying robot 100 may also back away from the intermediate location 3108, return to the obstructions, and execute an obstruction handling strategy, returning to collect the heavy dirt and debris 3004 from the intermediate location 3108 once the obstructions are handled, and continuing its vacuum cleaning pattern for areas that have not yet been vacuumed.

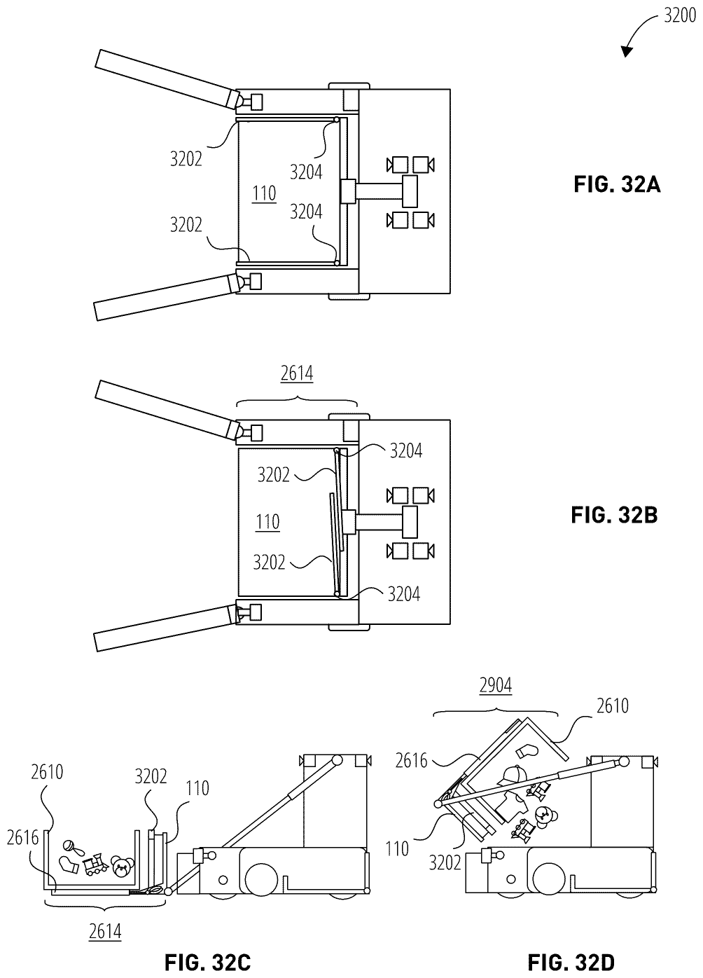

FIG. 32A-FIG. 32D illustrate a tidying robot with movable scoop walls 3200 in various configurations in accordance with one embodiment. FIG. 32A and FIG. 32B show top views. FIG. 32C and FIG. 32D show side views.

In FIG. 32A, a top view of the tidying robot with movable scoop walls 3200 is shown. The horizontally rotating movable scoop walls 3202 are shown extended to either side of the scoop 110. motors 3204 may be seen where each horizontally rotating movable scoop wall 3202 attaches near the rear of the scoop 110. These motors may rotate the horizontally rotating movable scoop walls 3202 inward, toward each other and toward the rear of the scoop 110, as shown in FIG. 32B. In another embodiment, the horizontally rotating movable scoop walls 3202 may rotate outward and extend backward behind and perpendicular to the rear of the scoop 110, or fold into a cavity or notch provided along the back edge of the scoop 110. This may place the tidying robot with movable scoop walls 3200 into a forklift configuration 2614, as described with respect to step 2602e of FIG. 26C, allowing the tidying robot with movable scoop walls 3200 to engage with the scoop slot 2616 of a portable bin 2610.

FIG. 32C shows a side view of the tidying robot with movable scoop walls 3200 with the scoop 110 in the forklift configuration 2614 shown in FIG. 32B. The tidying robot with movable scoop walls 3200 may be seen with the scoop 110 engaged within the scoop slot 2616 of a portable bin 2610. FIG. 32D shows a side view of the tidying robot with movable scoop walls 3200 placing the portable bin 2610 into an inverted position 2904, facilitated by the engagement of the scoop 110 within the scoop slot 2616 of the portable bin 2610.

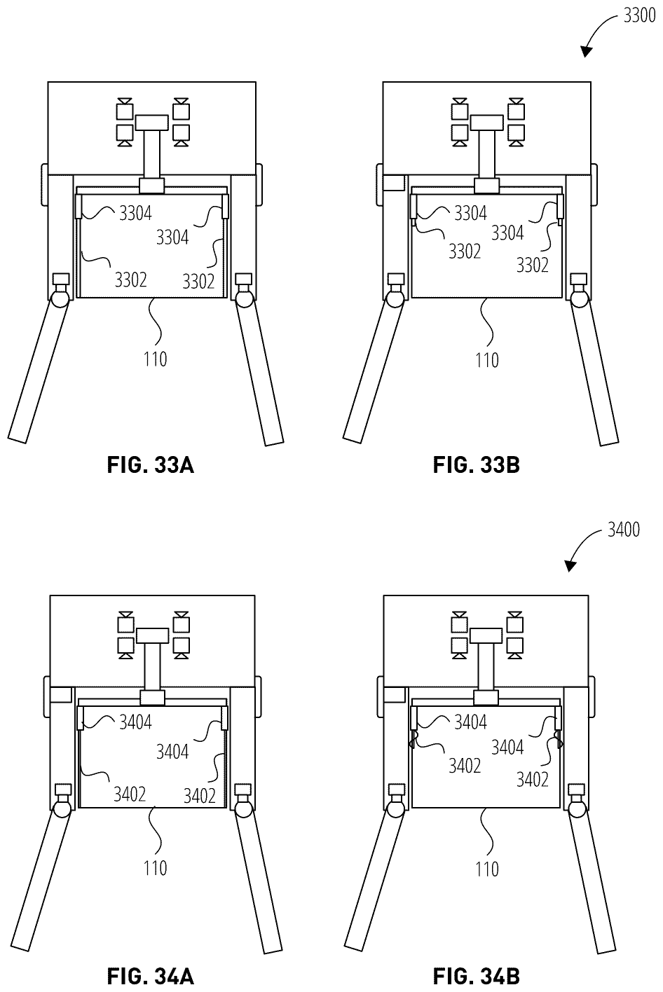

FIG. 33A and FIG. 33B illustrate a tidying robot with movable scoop walls 3300 in various configurations in accordance with one embodiment. The tidying robot with movable scoop walls 3300 may comprise retracting movable scoop walls 3302 and linear actuators 3304. The retracting movable scoop walls 3302 may extend to the front edge of the scoop 110 as shown in FIG. 33A, or may be retracted by the linear actuators 3304 as shown in FIG. 33B. The retracting movable scoop walls 3302 may retract simultaneously, independently, or in a coordinated manner, as needed for specific applications.

In one embodiment, each retracting movable scoop wall 3302 may use a combination of a cable and a spring rather than a linear actuator 3304. The spring may maintain the retracting movable scoop wall 3302 in the extended position shown in FIG. 33A. The cable may be wound by a small motor to pull the retracting movable scoop wall 3302 into a retracted position as shown in FIG. 33B. The narrower portion of the retracting movable scoop wall 3302 toward the front of the scoop 110 may retract into the wider portion of the retracting movable scoop wall 3302 toward the rear of the scoop 110.

FIG. 34A and FIG. 34B illustrate a tidying robot with movable scoop walls 3400 in various configurations in accordance with one embodiment. The tidying robot with movable scoop walls 3400 may comprise collapsing movable scoop walls 3402 and linear actuators 3404. The collapsing movable scoop wall 3402 may be made of a flexible material such as a durable fabric, mesh, or other membrane, that is kept under tension in the extended position, as shown in FIG. 34A, but may be pulled towards the back of the scoop 110 into a retracted position, as shown in FIG. 34B, by the linear actuator 3404.

A rod controlled by the linear actuator 3404 of each collapsing movable scoop wall 3402 may be threaded through small holes in the fabric, mesh, or membrane, such that the material of the collapsing movable scoop wall 3402 may fold neatly into a compact repeating “S” shape without extending too far out from or into the scoop 110. In one embodiment, a cable and spring as described above may be used to extend and retract the collapsing movable scoop walls 3402.

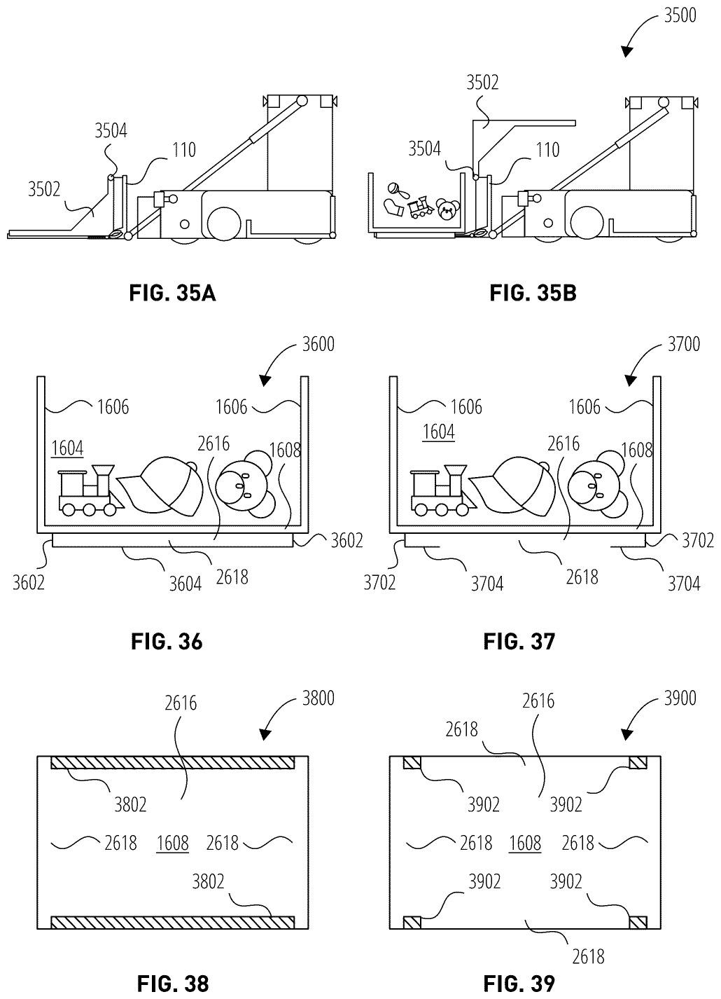

FIG. 35A and FIG. 35B illustrate a tidying robot with movable scoop walls 3500 in accordance with one embodiment. The tidying robot with movable scoop walls 3500 may comprise vertically rotating movable scoop walls 3502 and motors 3504. The vertically rotating movable scoop walls 3502 may rotate up over the top of the scoop 110 through the action of the motors 3504. In this manner, the vertically rotating movable scoop wall 3502 may be moved out of the way of the scoop 110 engaging with portable bins 2610 with either scoop slots or legs. The illustrated embodiment may also work for scoops 110 having curved bases, rather than the flat base illustrated here, which may obstruct the horizontal rotation of the movable scoop walls.

FIG. 36 illustrates a front elevation view of a portable bin 3600 in accordance with one embodiment. The portable bin 3600 may comprise a storage compartment 1604, bin sides 1606, a bin base 1608, a scoop slot 2616, a scoop slot opening 2618, scoop slot sides 3602, and a scoop slot bottom 3604. The scoop slot 2616 may be fully or primarily enclosed, having a solid scoop slot bottom 3604 and scoop slot sides 3602.

The scoop slot 2616 may be provided under the portable bin 3600 storage compartment 1604 and bin base 1608. The scoop slot 2616 may be bounded by scoop slot sides 3602 and a scoop slot bottom 3604, which may define a scoop slot opening 2618 configured to allow the scoop 110 of a tidying robot 100 to slide into the scoop slot 2616, as introduced with respect to steps 2602e and 2602f of FIG. 26C. This may allow the tidying robot 100 to move a portable bin into an inverted position 2904 as illustrated in FIG. 29B.

FIG. 37 illustrates a front elevation view of a portable bin 3700 in accordance with one embodiment. The portable bin 3700 may comprise a storage compartment 1604, bin sides 1606, a bin base 1608, a scoop slot 2616, a scoop slot opening 2618, scoop slot sides 3702, and a scoop slot bottom 3704. The scoop slot 2616 may be partially or primarily open along its sides, or along the scoop slot bottom 3704, as shown here, while still providing enclosure adequate to secure the portable bin 3700 to the scoop 110 of the tidying robot 100.

The scoop slot 2616 may be provided under the portable bin 3700 storage compartment 1604 and bin base 1608. The scoop slot 2616 may be bounded by scoop slot sides 3702 and portions of a scoop slot bottom 3604, which may define a scoop slot opening 2618 configured to allow the scoop 110 of a tidying robot 100 to slide into the scoop slot 2616, as introduced with respect to steps 2602e and 2602f of FIG. 26C. This may allow the tidying robot 100 to move a portable bin into an inverted position 2904 as illustrated in FIG. 29B.

FIG. 38 illustrates a bottom plan view of a portable bin 3800 in accordance with one embodiment. The portable bin 3800 may comprise a storage compartment 1604 and bin sides 1606 not pictured here, a bin base 1608, and legs 3802 positioned along two opposite sides of the bin base 1608.

The legs 3802 may raise the bin base 1608 off of the ground, forming a scoop slot 2616 area beneath the portable bin 3800 that may allow the scoop 110 of a tidying robot 100 to slide into the two scoop slot opening 2618 areas at either end of the portable bin 3800 between the legs 3802, the ground, and the bin base 1608. In this manner, the scoop 110 of the tidying robot 100 may get beneath the portable bin 3800 and lift it securely, similar to a forklift. The legs 3802 may prevent the portable bin 3800 from sliding sideways off of the scoop 110 while a tilted position of the scoop 110 may prevent the portable bin 3800 from sliding forward off of the scoop 110.

FIG. 39 illustrates a bottom plan view of a portable bin 3900 in accordance with one embodiment. The portable bin 3900 may comprise a storage compartment 1604 and bin sides 1606 not pictured here, a bin base 1608, and legs 3902 positioned at or near each corner of the bin base 1608.

The legs 3902 may raise the bin base 1608 off of the ground, forming a scoop slot 2616 area beneath the portable bin 3900 that may allow the scoop 110 of a tidying robot 100 to slide into scoop slot opening 2618 areas at each side of the portable bin 3900 between the legs 3802, the ground, and the bin base 1608. In this manner, the scoop 110 of the tidying robot 100 may get beneath the portable bin 3800 and lift it securely, similar to a forklift. The legs 3902 may prevent the portable bin 3900 from sliding sideways off of the scoop 110 while a tilted position of the scoop 110 may prevent the portable bin 3900 from sliding forward off of the scoop 110.

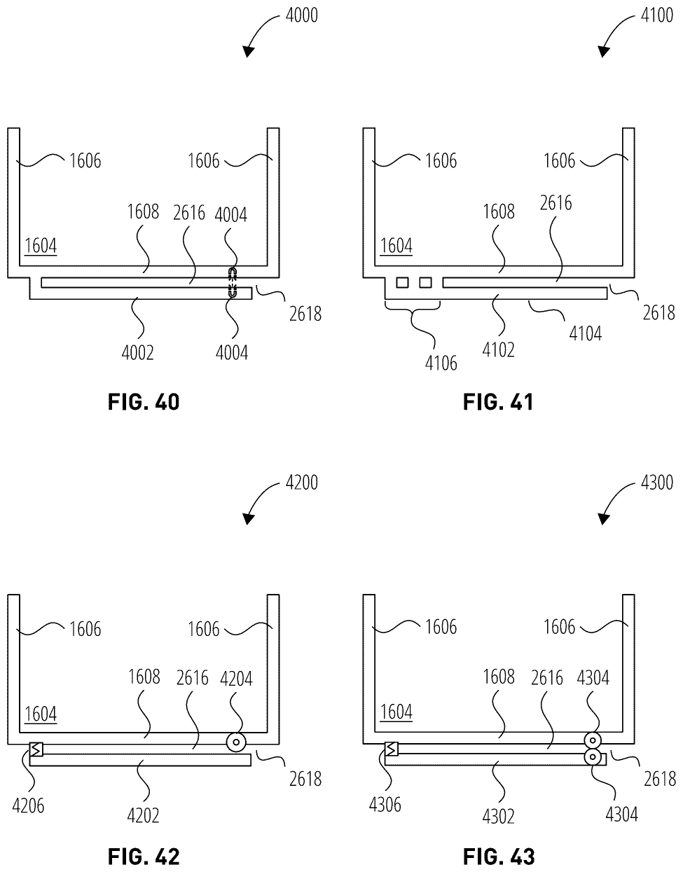

FIG. 40 illustrates a side elevation view of a portable bin 4000 in accordance with one embodiment. The portable bin 4000 may comprise a storage compartment 1604, bin sides 1606, a bin base 1608, a scoop slot 2616, a scoop slot opening 2618, a scoop slot bottom 4002, and magnets 4004.

The magnets 4004 may be aligned with each other, one in the bin base 1608 and one in the scoop slot bottom 4002, near or at the scoop slot opening 2618. They may be configured to repel each other, and thus may prevent the scoop slot opening 2618 and scoop slot 2616 from being compressed by weight of the bin or objects in the storage compartment 1604 to a degree that prevents or inhibits the passage of the scoop 110 into the scoop slot opening 2618. The repulsion of the magnets 4004 may also induce the scoop slot opening 2618 to open more widely when not engaged with a scoop 110, reducing friction upon entry of the scoop 110 into the scoop slot opening 2618.

In one embodiment, the scoop 110 of the tidying robot 100 may include metallic or magnetic components that passively or dynamically engage the magnets 4004, and provide an additional mechanism for securing the portable bin 4000 to the scoop 110. Such components may be capable of switching their magnetic fields on and off, such that they may attract the magnets 4004 while the portable bin 4000 is being carried, but repel or cease to attract them when the tidying robot 100 needs to deposit the portable bin 4000 at a desired location.

FIG. 41 illustrates a side elevation view of a portable bin 4100 in accordance with one embodiment. The portable bin 4100 may comprise a storage compartment 1604, bin sides 1606, a bin base 1608, a scoop slot 2616, a scoop slot opening 2618, and a scoop slot bottom 4102.

The scoop slot bottom 4102 may be formed from material with high yield strength 4104, and may include a reinforced area 4106 at the end of the scoop slot 2616 opposite the scoop slot opening 2618. These features may prevent the scoop slot opening 2618 from being compressed by the weight of the bin or objects in the storage compartment 1604 to a degree that prevents the passage of the scoop 110 into the scoop slot opening 2618.

FIG. 42 illustrates a side elevation view of a portable bin 4200 in accordance with one embodiment. The portable bin 4200 may comprise a storage compartment 1604, bin sides 1606, a bin base 1608, a scoop slot 2616, a scoop slot opening 2618, a scoop slot bottom 4202, a wheel and bearing 4204, and a linear spring 4206.

The wheel and bearing 4204 may be attached to the bin base 1608 and positioned near the scoop slot opening 2618. A single wheel and bearing 4204 may be positioned toward the center of the edge of the bin base 1608 near the scoop slot opening 2618, or one wheel and bearing 4204 may be attached at either side of that bin base 1608 edge. Other configurations may also be possible.

The wheel and bearing 4204 may reduce friction and facilitate entry of the scoop 110 into the scoop slot opening 2618. The linear spring 4206 may be positioned opposite the scoop slot 2616 from the scoop slot opening 2618, and may allow the scoop slot 2616 to widen as the edge of the scoop 110 passes between the wheel and bearing 4204 and the scoop slot bottom 4202, further facilitating entry of the scoop 110 into the scoop slot 2616.

FIG. 43 illustrates a side elevation view of a portable bin 4300 in accordance with one embodiment. The portable bin 4300 may comprise a storage compartment 1604, bin sides 1606, a bin base 1608, a scoop slot 2616, a scoop slot opening 2618, a scoop slot bottom 4302, wheels and bearings 4304, and a linear spring 4306.

The wheels and bearings 4304 may be positioned near the scoop slot opening 2618 with one attached to the bin base 1608 and the other to the scoop slot bottom 4302. A single set of wheels and bearings 4304 may be positioned toward the center of the edge of the bin base 1608 near the scoop slot opening 2618, or one set of wheels and bearings 4304 may be attached at either side of that bin base 1608 edge. Other configurations may also be possible.

The wheels and bearings 4304 may reduce friction and facilitate entry of the scoop 110 into the scoop slot opening 2618. The linear spring 4306 may be positioned opposite the scoop slot 2616 from the scoop slot opening 2618, and may allow the scoop slot 2616 to widen as the edge of the scoop 110 passes between the wheels and bearings 4304, further facilitating entry of the scoop 110 into the scoop slot 2616.

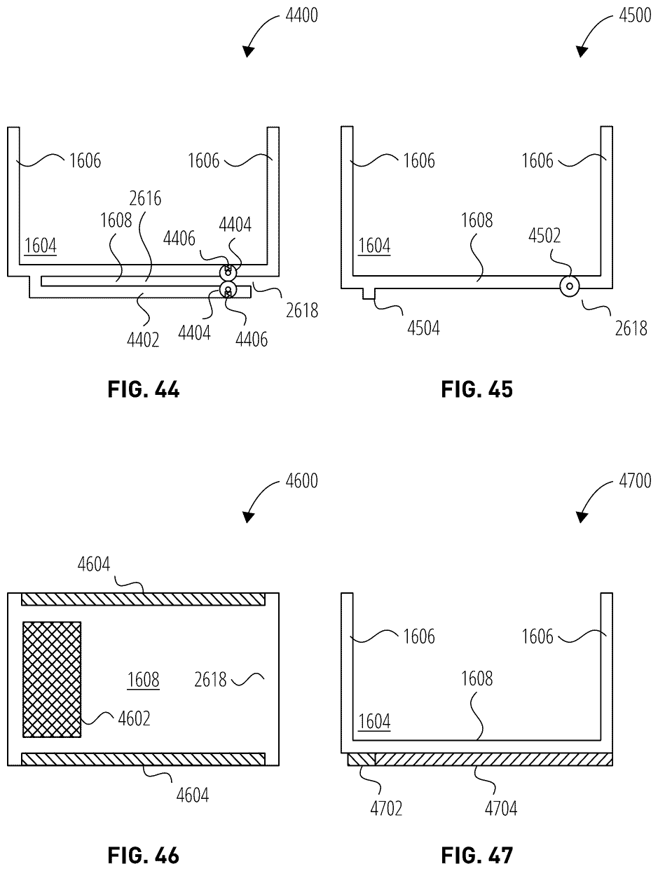

FIG. 44 illustrates a side elevation view of a bin 4400 in accordance with one embodiment. The bin 4400 may comprise a storage compartment 1604, bin sides 1606, a bin base 1608, a scoop slot 2616, a scoop slot opening 2618, a scoop slot bottom 4402, wheels and bearings 4404, and linear springs 4406.

The wheels and bearings 4404 may be positioned near the scoop slot opening 2618 with one attached to the bin base 1608 and the other to the scoop slot bottom 4402. A single set of wheels and bearings 4404 may be positioned toward the center of the edge of the bin base 1608 near the scoop slot opening 2618, or one set of wheels and bearings 4404 may be attached at either side of that bin base 1608 edge. Other configurations may also be possible.

The wheels and bearings 4404 may reduce friction and facilitate entry of the scoop 110 into the scoop slot opening 2618. The wheels and bearings 4404 may be attached to the bin base 1608 and scoop slot bottom 4402 through the linear springs 4406. The linear springs 4406 may allow the wheels and bearings 4404 to move away from each other elastically as the scoop 110 passes between them, further facilitating entry of the scoop 110 into the scoop slot 2616.

FIG. 45 illustrates a side elevation view of a portable bin 4500 in accordance with one embodiment. The portable bin 4500 may comprise a storage compartment 1604, bin sides 1606, a bin base 1608, a scoop slot opening 2618, one or more wheels and bearings 4502, and one or more legs 4504.

The leg or legs 4504 and the one or more wheels and bearings 4502 may raise the bin base 1608 off of the ground, forming a scoop slot 2616 area beneath the portable bin 4500 that may allow the scoop 110 of a tidying robot 100 to slide into scoop slot opening 2618 areas. The leg 4504 may be a linear ridge such as the legs 3802 illustrated in FIG. 38, running along the edge of the bin base 1608 opposite the scoop slot opening 2618 area. Legs 4504 such as the legs 3902 showing in FIG. 39 may, alternatively, be positioned at either corner of the bin base 1608 opposite the scoop slot opening 2618. A single wheel and bearing 4502 may be positioned toward the center of the edge of the bin base 1608 near the scoop slot opening 2618, or one wheel and bearing 4502 may be attached at either side of that bin base 1608 edge. Other configurations may also be possible.

The wheel and bearing 4502 may reduce friction as the front edge of the scoop 110 passes through the scoop slot opening 2618 into the scoop slot 2616 area beneath the bin base 1608. The leg 4504 may provide an amount of friction that maintains the portable bin 4500 as the scoop 110 passes beneath it. These components may also prevent the portable bin 4500 from sliding sideways off of the scoop 110.

FIG. 46 illustrates a bottom plan view of a portable bin 4600 in accordance with one embodiment. The portable bin 4600 may comprise a storage compartment 1604 and bin sides 1606 not pictured here, a bin base 1608, a scoop slot opening 2618, a ledge 4602, and legs 4604. The leg 4604 shown are similar to the two legs 3802 illustrated in FIG. 38, but in one embodiment, the portable bin 4600 may have four legs such as the legs 3902 shown in FIG. 39.

The ledge 4602 may be affixed to but have a gap between it and the bin base 1608, such that it may hook under the front of the scoop 110 when the scoop 110 is fully inserted into the scoop slot 2616 formed between the legs 4604, the bin base 1608, and the ground. This may allow the scoop 110 to turn the portable bin 4600 upside down into an inverted position 2904 as shown in FIG. 29B in order to dump toys out. The ledge may keep the portable bin 4600 in place even when it is upside down on the scoop 110.

FIG. 47 illustrates a side elevation view of a portable bin 4700 in accordance with one embodiment. The portable bin 4700 may comprise a storage compartment 1604, bin sides 1606, and a bin base 1608 configured with a high friction material 4702 and a low friction material 4704.

The low friction material 4704 may allow the front edge of the scoop 110 to pass beneath the bin base 1608 easily, allowing the scoop 110 to slide beneath the portable bin 4700. The high friction material 4702 may prevent the portable bin 4700 from sliding on the floor as the scoop 110 passes beneath it, and may prevent the portable bin 4700 from sliding off of the scoop 110 as the bin is lifted and carried by the tidying robot 100.

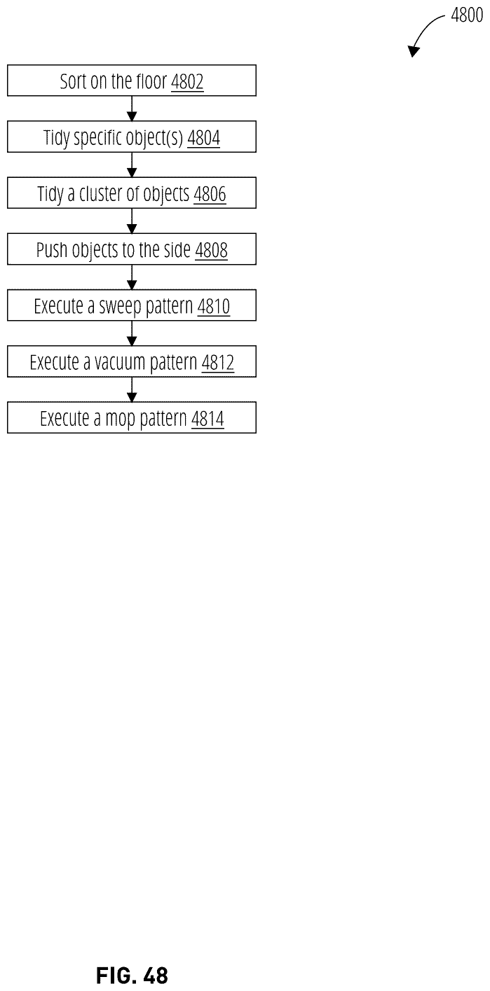

FIG. 48 illustrates an exemplary multi-stage tidying routine 4800 in accordance with one embodiment. Although the example exemplary multi-stage tidying routine 4800 depicts a particular sequence of operations, the sequence may be altered without departing from the scope of the present disclosure. For example, some of the operations depicted may be performed in parallel or in a different sequence that does not materially affect the function of the exemplary multi-stage tidying routine 4800. In other examples, different components of an example device or system that implements the exemplary multi-stage tidying routine 4800 may perform functions at substantially the same time or in a specific sequence.

According to some examples, the method includes sorting on the floor at block 4802. For example, the tidying robot 100 illustrated in FIG. 1A may sort on the floor. The tidying robot may initially sort objects located on the floor. This sorting may group the objects based on an object type for easier pickup.

According to some examples, the method includes tidying specific object(s) at block 4804. The tidying robot may put away a specific object or specific objects, dropping them at their home locations.

According to some examples, the method includes tidying a cluster of objects at block 4806. The tidying robot may tidy clusters of objects, dropping them at their home locations. In one embodiment, the robot may collect multiple objects having the same home location as one cluster to be tidied.

According to some examples, the method includes pushing objects to the side at block 4808. The tidying robot may push remaining objects without home locations to the side of the room they currently reside in, along the wall, into an open closet, or otherwise to an area out of the way of future operations.

According to some examples, the method includes executing a sweep pattern at block 4810. The tidying robot may use pusher pads having brushes to sweep dirt and debris from the floor into the scoop. The robot may then transport the dirt and debris to a garbage bin and dump it therein.

According to some examples, the method includes executing a vacuum pattern at block 4812. The tidying robot may vacuum up any remaining fine dust and dirt, leaving the floor clear. In one embodiment, the vacuumed dust and dirt may be stored in the robot's dust bin and emptied later at the charging dock. In one embodiment, the sweep pattern and vacuum pattern may be executed concurrently while the tidying robot 100 is in an inverted wedge configuration, as shown in FIG. 31A and FIG. 31B.

According to some examples, the method includes executing a mop pattern at block 4814. For example, the tidying robot 100 introduced in FIG. 1A may execute a mop pattern. The tidying robot may wet-mop the floor using a mop pad to further deep-clean a hard floor such as tile, vinyl, or wood.

This staged approach may allow the robot to progressively tidy a messy room by breaking the cleaning effort into manageable tasks, such as organizing objects on the floor before trying to put them away, putting objects away before sweeping, sweeping up dirt and debris such as food pieces before vacuuming up finer particles, etc.

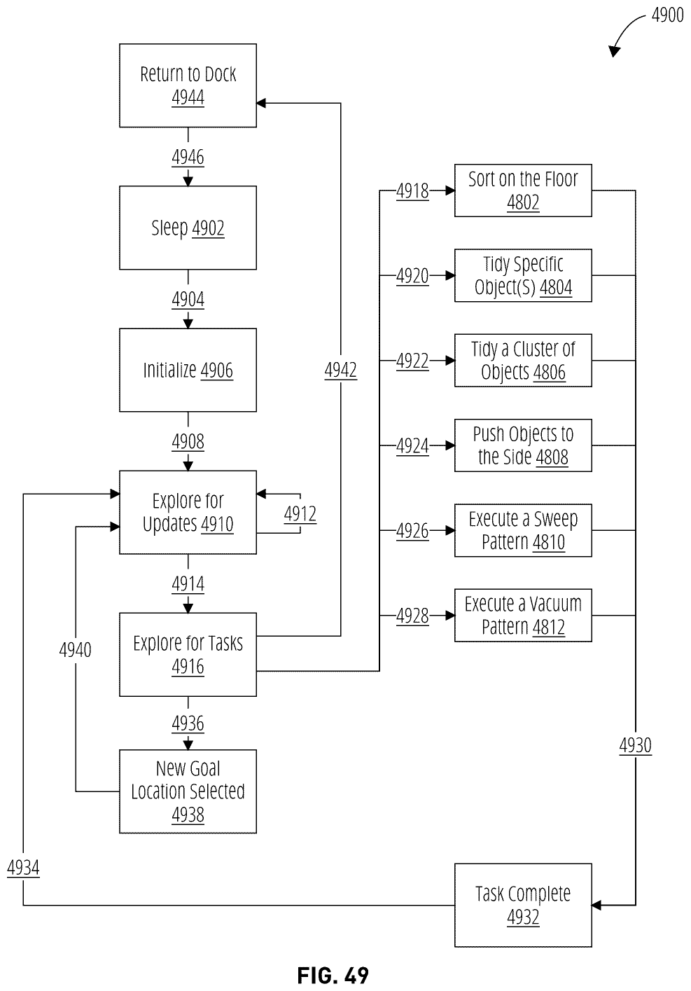

FIG. 49 illustrates a robot operation state diagram 4900 in accordance with one embodiment. A tidying robot may begin in a sleep 4902 state. In this sleep 4902 state, the robot may be sleeping and charging at the base station 1600.

When the robot wakes up 4904, it may transition to an initialize 4906 state. During the initialize 4906 state, the robot may perform a number of system checks and functions preparatory to its operation, including loading existing maps.

Once the robot is ready 4908, it may transition to an explore for updates 4910 state. During the explore for updates 4910 state, the robot may update its global map and the robot may be localized within that map by processing video frames captured by the robot's cameras and other sensor data. The robot keeps exploring 4912 until the map is updated and the robot is localized 4914.

Once the map is updated and the robot is localized 4914, the robot may transition to an explore for tasks 4916 state. In its explore for tasks 4916 state, the robot may compare a prioritized task list against map information to find its next task for execution. In another embodiment, the robot may be instructed to navigate a pattern throughout the environment looking for tasks to perform. In one embodiment, the prioritized task list may indicate the robot is to perform a process such as the exemplary multi-stage tidying routine 4800. Where the robot finds objects to sort 4918, it may perform block 4802 of the exemplary multi-stage tidying routine 4800. Where the robot finds specific objects to tidy 4920, it may perform block 4804 of the exemplary multi-stage tidying routine 4800 after performing block 4802 as needed. Where the robot finds a cluster of objects to tidy 4922, it may perform block 4806 of the exemplary multi-stage tidying routine 4800 after performing block 4802 and block 4804 as needed. Where the robot finds objects to be pushed to the side 4924, it may perform block 4808 of the exemplary multi-stage tidying routine 4800 after performing blocks 4802-4806 as needed. Where the robot finds an area that needs sweeping 4926, it may perform block 4810 of the exemplary multi-stage tidying routine 4800 after performing blocks 4802-4808 as needed. Where the robot finds an area that needs vacuuming 4928, it may perform block 4812 of the exemplary multi-stage tidying routine 4800 after performing blocks 4802-4810 as needed. In one embodiment, the robot may determine that an area needs to be mopped after it has been swept and/or vacuumed and may perform a mopping task after block 4810 or block 4812. Once the robot determines a task is finished 4930, it may mark the task complete 4932, then it continues exploring 4934. The robot may then transition back through the explore for updates 4910 state and the explore for tasks 4916 state.

If the robot selects a new goal location 4936, it may transition from the explore for tasks 4916 state to the new goal location selected 4938 state, allowing it to view and map previously unobserved scenes in the environment. The robot navigates to the new location 4940 and returns to the explore for updates 4910 state.

While the robot is in the explore for tasks 4916 state, if it determines its battery is low or there is nothing to tidy 4942, it may transition to the return to dock 4944 state. In this state, the robot may select a point near its base station 1600 as its goal location, may navigate to that point, and may then dock with the base station 1600 to charge. When the robot is docked and charging 4946, it may return to the sleep 4902 state.

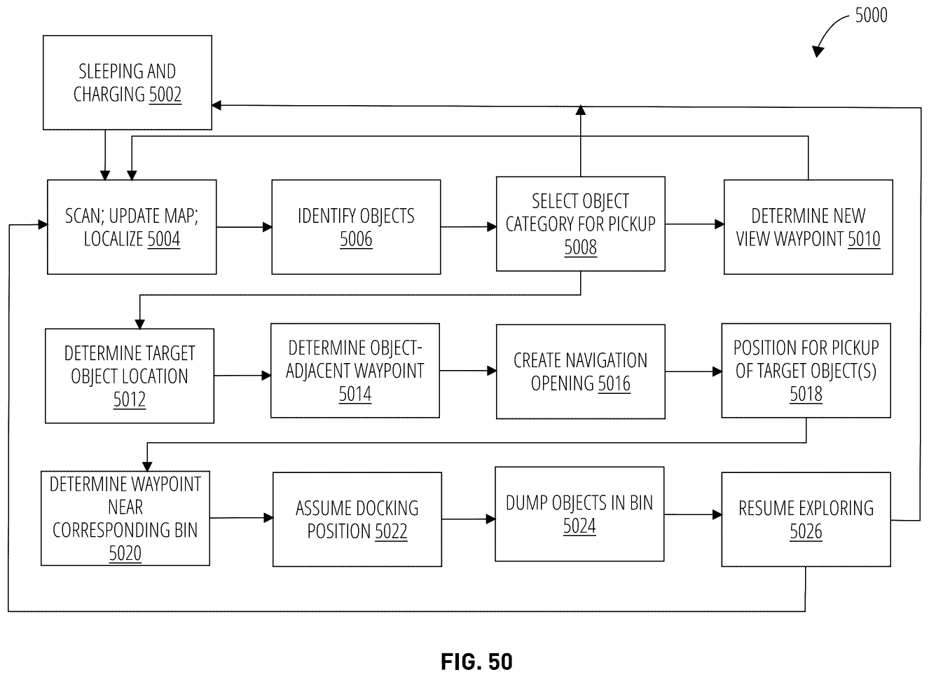

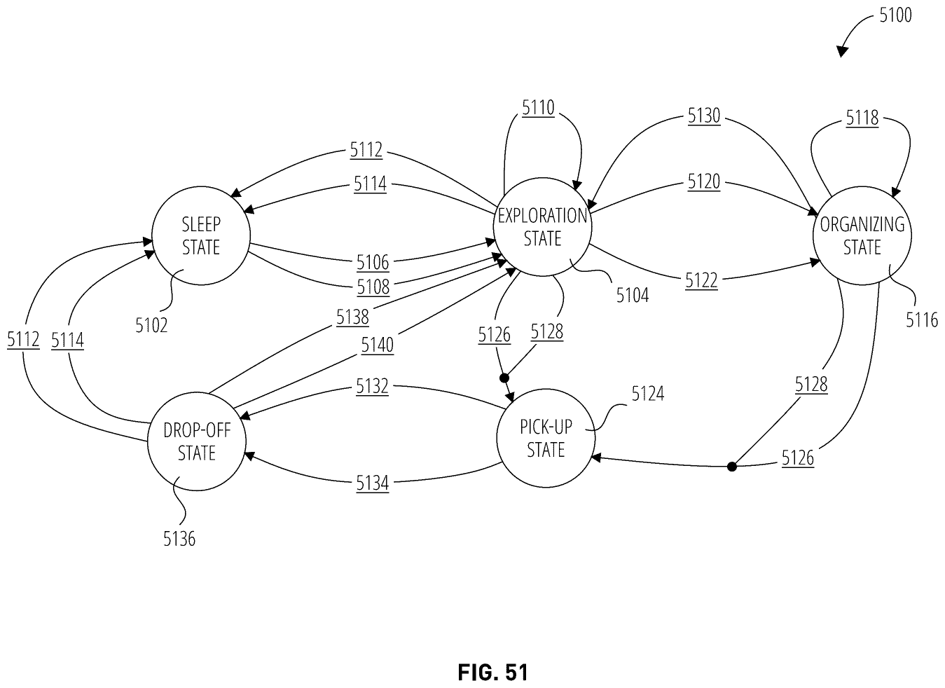

FIG. 50 also depicts a robotic process 5000 in one embodiment, in which the robotic system sequences through an embodiment of a state space map 5100 as depicted in FIG. 51.

The sequence begins with the robot sleeping (sleep state 5102) and charging at the base station (block 5002). The robot is activated, e.g., on a schedule, and enters an exploration mode (environment exploration state 5104, activation action 5106, and schedule start time 5108). In the environment exploration state 5104, the robot scans the environment using cameras (and other sensors) to update its environmental map and localize its own position on the map (block 5004, explore for configured interval 5110). The robot may transition from the environment exploration state 5104 back to the sleep state 5102 on condition that there are no more objects to pick up 5112, or the battery is low 5114.

From the environment exploration state 5104, the robot may transition to the object organization state 5116, in which it operates to move the items on the floor to organize them by category 5118. This transition may be triggered by the robot determining that objects are too close together on the floor 5120, or determining that the path to one or more objects is obstructed 5122. If none of these triggering conditions is satisfied, the robot may transition from the environment exploration state 5104 directly to the object pick-up state 5124 on condition that the environment map comprises at least one drop-off container for a category of objects 5126, and there are unobstructed items for pickup in the category of the container 5128. Likewise, the robot may transition from the object organization state 5116 to the object pick-up state 5124 under these latter conditions. The robot may transition back to the environment exploration state 5104 from the object organization state 5116 on condition that no objects are ready for pick-up 5130.

In the environment exploration state 5104 and/or the object organization state 5116, image data from cameras is processed to identify different objects (block 5006). The robot selects a specific object type/category to pick up, determines a next waypoint to navigate to, and determines a target object and location of type to pick up based on the map of environment (block 5008, block 5010, and block 5012).

In the object pick-up state 5124, the robot selects a goal location that is adjacent to the target object(s) (block 5014). It uses a path-planning algorithm to navigate itself to that new location while avoiding obstacles. “Obstacles” refers to objects that may impede the passage of a robot as it navigates its environment to complete desired tasks. The robot actuates left and right pusher arms to create an opening large enough that the target object may fit through, but not so large that other unwanted objects are collected when the robot drives forward (block 5016). The robot drives forward so that the target object is between the left and right pusher arms, and the left and right pusher arms work together to push the target object onto the collection scoop (block 5018).

The robot may continue in the object pick-up state 5124 to identify other target objects of the selected type to pick up based on the map of the environment. If other such objects are detected, the robot selects a new goal location that is adjacent to the target object. It uses a path-planning algorithm to navigate itself to that new location while avoiding obstacles while carrying the target object(s) that were previously collected. The robot actuates left and right pusher arms to create an opening large enough that the target object may fit through, but not so large that other unwanted objects are collected when the robot drives forward. The robot drives forward so that the next target object(s) are between the left and right pusher arms. Again, the left and right pusher arms work together to push the target object onto the collection scoop.

On condition that all identified objects in category are picked up 5132, or if the scoop is at capacity 5134, the robot transitions to the object drop-off state 5136 and uses the map of the environment to select a goal location that is adjacent to the bin for the type of objects collected and uses a path planning algorithm to navigate itself to that new location while avoiding obstacles (block 5020). The robot backs up toward the bin into a docking position where the back of the robot is aligned with the back of the bin (block 5022). The robot lifts the scoop up and backward, rotating over a rigid arm at the back of the robot (block 5024). This lifts the target objects up above the top of the bin and dumps them into the bin.

From the object drop-off state 5136, the robot may transition back to the environment exploration state 5104 on condition that there are more items to pick up 5138, or it has an incomplete map of the environment 5140. the robot resumes exploring and the process may be repeated (block 5026) for each other type of object in the environment having an associated collection bin.

The robot may alternatively transition from the object drop-off state 5136 to the sleep state 5102 on condition that there are no more objects to pick up 5112 or the battery is low 5114. Once the battery recharges sufficiently, or at the next activation or scheduled pick-up interval, the robot resumes exploring and the process may be repeated (block 5026) for each other type of object in the environment having an associated collection bin.

FIG. 51 illustrates a state space map 5100 in accordance with one embodiment through which a tidying robot 100 may sequence as described above.

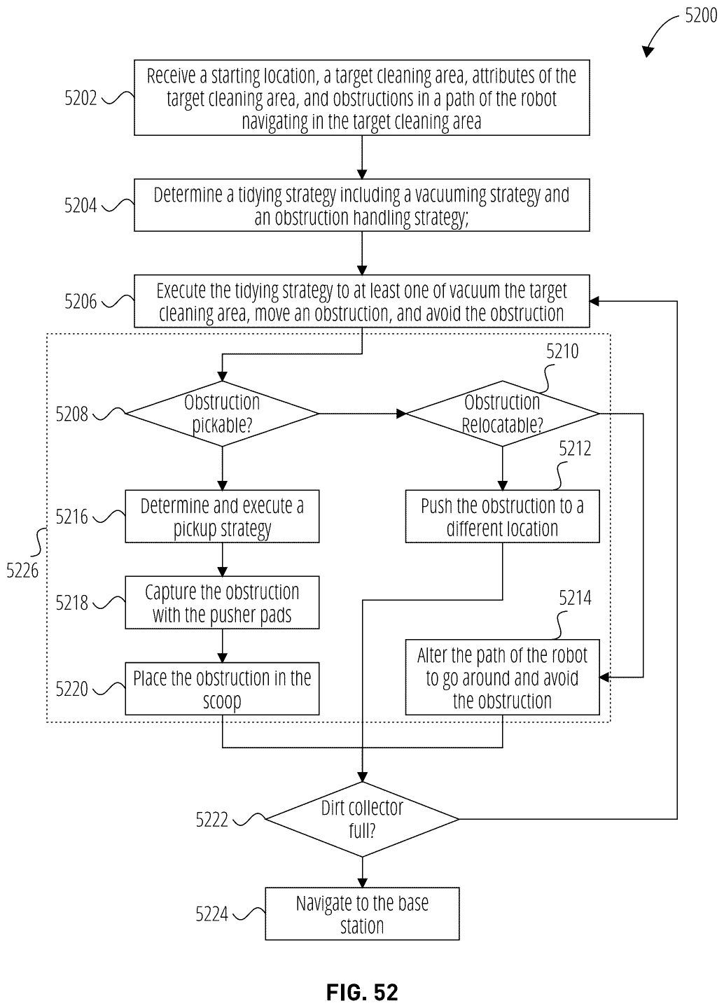

FIG. 52 illustrates an example routine 5200 for a tidying robot such as that introduced with respect to FIG. 1A. Although the example routine 5200 depicts a particular sequence of operations, the sequence may be altered without departing from the scope of the present disclosure. For example, some of the operations depicted may be performed in parallel or in a different sequence that does not materially affect the function of the routine 5200. In other examples, different components of an example device or system that implements the routine 5200 may perform functions at substantially the same time or in a specific sequence.

According to some examples, the method includes receiving a starting location, a target cleaning area, attributes of the target cleaning area, and obstructions in a path of the robot navigating in the target cleaning area at block 5202. For example, the tidying robot 100 illustrated in FIG. 1A may receive a starting location, a target cleaning area, attributes of the target cleaning area, and obstructions in a path of the robot navigating in the target cleaning area.

According to some examples, the method includes determining a tidying strategy including a vacuuming strategy and an obstruction handling strategy at block 5204. The vacuuming strategy may include choosing a vacuum cleaning pattern for the target cleaning area, identifying the obstructions in the target cleaning area, determining how to handle the obstructions, and vacuuming the target cleaning area. Handling the obstructions may include moving the obstructions and avoiding the obstructions. Moving the obstructions may include pushing them aside, executing a pickup strategy to pick them up in the scoop, carrying them to another location out of the way, etc. The obstruction may, for example, be moved to a portion of the target cleaning area that has been vacuumed, in close proximity to the path, to allow the robot to quickly return and continue, unobstructed, along the path. In one embodiment, the robot may execute an immediate removal strategy, in which it may pick an obstruction up in its scoop, then immediately navigate to a garget storage bine and place the obstruction into the bin. The robot may then navigate back to the position where it picked up the obstruction, and may resume vacuuming from there. In one embodiment, the robot may execute an in-situ removal strategy, where it picks the object up, then continues to vacuum. When the robot is near the target storage bin, it may place the obstruction in the bin, then continue vacuuming from there. It may adjust its pattern to vacuum any portions of the floor it missed due to handling the obstruction. Once vacuuming is complete, or if the robot determines it does not have adequate battery power, the robot may return to the base station to complete the vacuuming strategy.

According to some examples, the method includes executing the tidying strategy to at least one of vacuum the target cleaning area, move an obstruction, and avoid the obstruction at block 5206. The obstruction may include at least one of a tidyable object and a movable object.

If the robot determines that the obstruction is pickable at decision block 5208, that is, the obstruction is an object the robot is capable of picking up, the method may progress to block 5216. If the robot decides the obstruction is not pickable, it may then determine whether the obstruction is relocatable at decision block 5210, that is, the obstruction is an object the robot is capable of moving and relocating, even though it cannot pick it up. If the robot determines the obstruction is relocatable, the method may include pushing the obstruction to a different location at block 5212. The obstruction may be pushed with the pusher pads, the scoop, and/or the chassis. If the robot determines the object is not relocatable, according to some examples, the method includes altering the path of the robot to go around and avoid the obstruction at block 5214.

According to some examples, the method includes determining and executing a pickup strategy at block 5216. The pickup strategy may include an approach path for the robot to take to reach the obstruction, a grabbing height for initial contact with the obstruction, a grabbing pattern for moving the pusher pads while capturing the obstruction, and a carrying position of the pusher pads and the scoop that secures the obstruction in a containment area on the robot for transport. The containment area may include at least two of the pusher pad arms, the pusher pads, and the scoop. Executing the pickup strategy may include extending the pusher pads out and forward with respect to the pusher pad arms and raising the pusher pads to the grabbing height. The robot may then approach the obstruction via the approach path, coming to a stop when the obstruction is positioned between the pusher pads. The robot may execute the grabbing pattern to allow capture of the obstruction within the containment area. The robot may confirm the obstruction is within the containment area. If the obstruction is within the containment area, the robot may exert pressure on the obstruction with the pusher pads to hold the obstruction stationary in the containment area and raise at least one of the scoop and the pusher pads, holding the obstruction, to the carrying position.

If the obstruction is not within the containment area, the robot may alter the pickup strategy with at least one of a different reinforcement learning based strategy, a different rules based strategy, and relying upon different observations, current robot state, current object state, and sensor data, and may then execute the altered pickup strategy. According to some examples, the method includes capturing the obstruction with the pusher pads at block 5218. According to some examples, the method then includes placing the obstruction in the scoop at block 5220. In one embodiment, the robot may navigate to a target storage bin or an object collection bin, then execute a drop strategy to place the obstruction in the bin. In one embodiment, the robot may turn aside from its vacuuming path to an already vacuumed area, then execute a drop strategy to place the obstruction on the floor. In one embodiment, the object collection bin may be on top of the base station.

According to some examples, the robot may determine whether or not the dirt collector is full at decision block 5222. If the dirt collector is full, the robot may navigate to the base station at block 5224. Otherwise, the robot may return to block 5206 and continue executing the tidying strategy. In one embodiment, decision block 5208-block 5220 may constitute an obstruction handling strategy 5226.

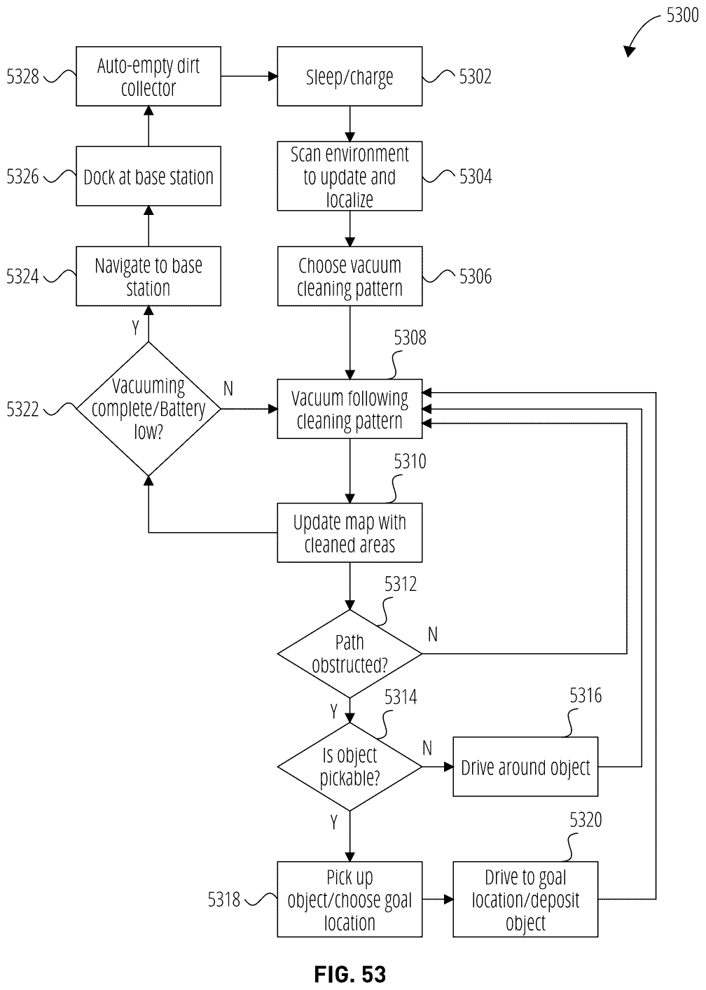

FIG. 53 illustrates an example basic routine 5300 for a system such as the tidying robot 100 and base station 1600 disclosed herein and illustrated interacting in FIG. 16A. Although the example basic routine 5300 depicts a particular sequence of operations, the sequence may be altered without departing from the scope of the present disclosure. For example, some of the operations depicted may be performed in parallel or in a different sequence that does not materially affect the function of the basic routine 5300. In other examples, different components of an example device or system that implements the basic routine 5300 may perform functions at substantially the same time or in a specific sequence.

The basic routine 5300 may begin with the tidying robot 100 previously illustrated in a sleeping and charging state at the base station 1600 previously illustrated. The robot may wake up from the sleeping and charging state at block 5302. The robot may scan the environment at block 5304 to update its local or global map and localize itself with respect to its surroundings and its map. In one embodiment, the tidying robot 100 may utilize its sensing system, including cameras and/or LIDAR sensors to localize itself in its environment. If this localization fails, the tidying robot 100 may execute an exploration cleaning pattern, such as a random walk in order to update its map and localize itself as it cleans.

At block 5306, the robot may determine a tidying strategy including at least one of a vacuuming strategy and an object isolation strategy. The tidying strategy may include choosing a vacuum cleaning pattern. For example, the robot may choose to execute a simple pattern of back and forth lines to clear a room where there are no obstacles detected. In one embodiment, the robot may choose among multiple planned cleaning patterns.

“Vacuum cleaning pattern” refers to a pre-determined path to be traveled by the tidying robot with its robot vacuum system engaged for the purposes of vacuuming all or a portion of a floor. The vacuum cleaning pattern may be configured to optimize efficiency by, e.g., minimizing the number of passes performed or the number of turns made. The vacuum cleaning pattern may account for the locations of known static objects and known movable objects which the tidying robot may plan to navigate around, and known tidyable objects which the tidying robot may plan to move out of its path. The vacuum cleaning pattern may be interrupted by tidyable objects or movable objects not anticipated at the time the pattern was selected, such that the tidying robot may be configured to engage additional strategies flexibly to complete a vacuum cleaning pattern under unanticipated circumstances it may encounter. “Tidyable objects” in this disclosure are elements detected in the environment that may be moved by the robot and put away in a home location. These objects may be of a type and size such that the robot may autonomously put them away, such as toys, clothing, books, stuffed animals, soccer balls, garbage, remote controls, keys, cellphones, etc. The term “movable object” in this disclosure refers to elements of the scene that are not desired to be moved by the robot (e.g., because they are decorative, too large, or attached to something), but that may be moved or deformed in the scene due to human influence. The term “Static object” in this disclosure refers to elements of a scene that are not expected to change over time, typically because they are rigid and immovable.

The robot may start vacuuming, and may at block 5308 vacuum the floor following the planned cleaning pattern. As cleaning progresses, maps may be updated at block 5310 to mark cleaned areas, keeping track of which areas have been cleaned. As long as the robot's path according to its planned cleaning pattern is unobstructed, the cleaning pattern is incomplete, and the robot has adequate battery power, the robot may return to block 5308 and continue cleaning according to its pattern.

Where the robot determines its path is obstructed at decision block 5312, the robot may next determine at decision block 5314 if the object obstructing its path may be picked up. If the object cannot be picked up, the robot may drive around the object at block 5316 and return to block 5308 to continue vacuuming/cleaning. If the object may be picked up, the robot may pick up the object and determine a goal location for that object at block 5318. Once the goal location is chosen, the robot may at block 5320 drive to the goal location with the object and may deposit the object at the goal location. The robot may then return to block 5308 and continue vacuuming.

In one embodiment, if the robot encounters an obstruction in its path at decision block 5312, it may determine the type of obstruction, and based on the obstruction type, the robot may determine an action plan for handling the obstruction. The action plan may be an action plan to move object(s) aside 5400 or an action plan to pick up objects in path 5500, as will be described in additional detail below. The action plan to pick up objects in path 5500 may may lead to the determination of additional action plans, such as the action plan to drop object(s) at a drop location 5600. The robot may execute the action plan(s). If the action plan fails, the robot may execute an action plan to drive around object(s) 5700 and may return to block 5308 and continue vacuuming. If the action plan to handle the obstruction succeeds, the robot may return to its vacuuming task at block 5308 following its chosen cleaning pattern.

The robot may in one embodiment return to the point at which vacuuming was interrupted to address the obstructing object to continue vacuuming. In another embodiment, the robot may restart vacuuming at the goal location, following a new path that allows it to complete its vacuuming task from that point. In one embodiment, the robot may continue to carry the object while vacuuming, waiting to deposit the object until after vacuuming is complete, or until the robot has reached a location near the goal location.

Once vacuuming is complete, or if a low battery condition is detected before vacuuming is complete at decision block 5322, the robot may at block 5324 navigate back to its base station. Upon arriving at the base station, the robot may dock with the base station at block 5326. In one embodiment, the base station may be equipped to auto-empty dirt from the robot's dirt collector at block 5328, if any dust, dirt, or debris is detected in the dirt collector. In one embodiment, the base station may comprise a bin, such as the base station 1600 and object collection bin 1602 illustrated in FIG. 16A. The robot may deposit any objects it is carrying in this bin. The robot may return to block 5302, entering a sleeping and/or charging mode while docked at the base station.

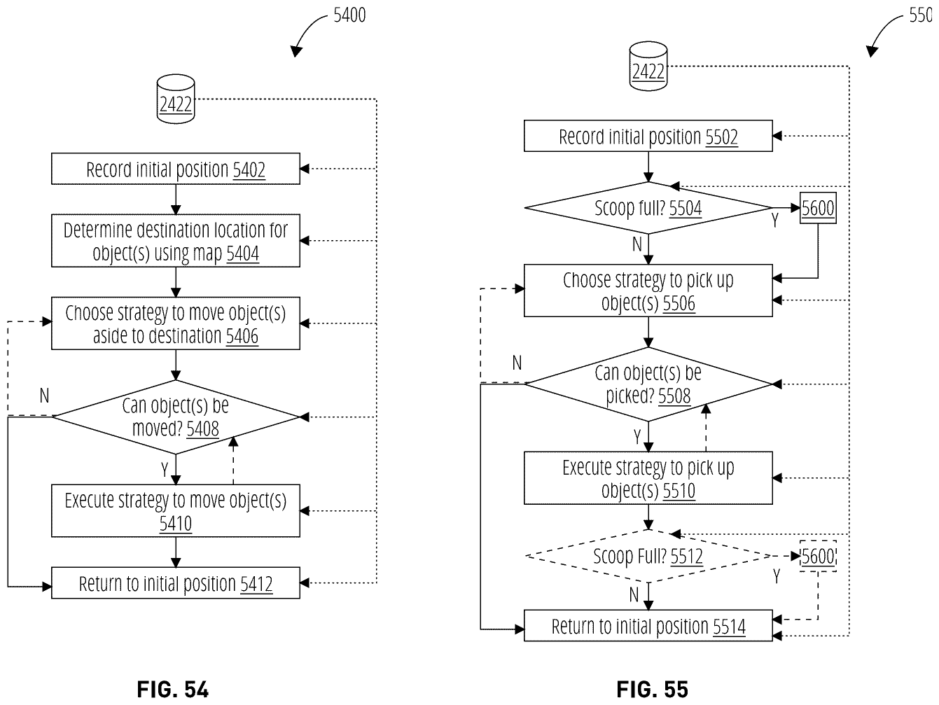

FIG. 54 illustrates an action plan to move object(s) aside 5400 in accordance with one embodiment. The tidying robot 100 may execute the action plan to move object(s) aside 5400 supported by the observations, current robot state, current object state, and sensor data 2422 introduced earlier with respect to FIG. 24.

The action plan to move object(s) aside 5400 may begin with recording an initial position for the tidying robot 100 at block 5402. The tidying robot 100 may then determine a destination for the object(s) to be moved using its map at block 5404. The tidying robot 100 may use its map, which may include noting which areas have already been vacuumed and determining a target location for the object(s) that has already been vacuumed, is in close proximity, and/or will not obstruct the continued vacuuming pattern.

The robot may at block 5406 choose a strategy to move the object(s). The robot may determine if it is able to move the object(s) via the strategy at decision block 5408. If it appears the object(s) are not movable via the strategy selected, the tidying robot 100 may return to its initial portion at block 5412. Alternatively, the tidying robot 100 may return to block 5406 and select a different strategy.

If the object(s) appear to be able to be moved, the robot may execute the strategy for moving the object(s) at block 5410. Executing the strategy may include picking up object(s) and dropping them at a determined destination location. Alternatively, the obstructing object(s) may be aligned with the outside of a robot's arm, and the robot may then use a sweeping motion to push the object(s) to the side, out of its vacuuming path. For example, the robot may pivot away from cleaned areas to navigate to a point where the robot may be pushed into the cleaned area by the robot pivoting back toward those cleaned areas.

If it is determined during execution of the strategy at block 5410 the object(s) cannot be moved, or if the strategy fails, the robot may navigate back to a starting position at block 5412. Alternatively, the robot may navigate to a different position that allows for continuation of the vacuuming pattern, skipping the area of obstruction. The action plan to move object(s) aside 5400 may then be exited.

In one embodiment, the robot may store the obstruction location on its map. The robot may issue an alert to notify a user of the instruction. The user may be able to clear the obstruction physically from the path, and then clear it from the robot's map through a user interface, either on the robot or through a mobile application in communication with the robot. The robot may in one embodiment be configured to revisit areas of obstruction once the rest of its cleaning pattern has been completed.

FIG. 55 illustrates an action plan to pick up objects in path 5500 in accordance with one embodiment. The tidying robot 100 may execute the action plan to pick up objects in path 5500 supported by the observations, current robot state, current object state, and sensor data 2422 introduced earlier with respect to FIG. 24.

The action plan to pick up objects in path 5500 may begin with recording an initial position for the tidying robot 100 at block 5502. The tidying robot 100 may make a determination at decision block 5504 whether its scoop is full or has capacity to pick up additional objects. If the scoop is full, the tidying robot 100 may, before proceeding, empty its scoop by depositing the objects therein at a desired drop location by following action plan to drop object(s) at a drop location 5600. The drop location may be a bin, a designated place on the floor that will be vacuumed before objects are deposited, or a designated place on the floor that has already been vacuumed.

Once it is determined that the scoop has capacity to pick up the objects, the tidying robot 100 may at block 5506 choose a strategy to pick up the obstructing objects it has detected. The tidying robot 100 may determine if it is able to pick the objects up via the selected strategy at decision block 5508. If it appears the object(s) are not pickable via the strategy selected, the tidying robot 100 may return to its initial portion at block 5514. Alternatively, the tidying robot 100 may return to block 5506 and select a different strategy.

If it is determined during execution of the strategy at block 5510 the object(s) cannot be picked up, or if the strategy fails, the robot may navigate back to a starting position at block 5514. Alternatively, the robot may navigate to a different position that allows for continuation of the vacuuming pattern, skipping the area of obstruction. The action plan to pick up objects in path 5500 may then be exited.

Once the objects are picked up through execution of the pickup strategy at block 5510, the tidying robot 100 may in one embodiment re-check scoop capacity at decision block 5512. If the scoop is full, the tidying robot 100 may perform the action plan to drop object(s) at a drop location 5600 to empty the scoop.

In one embodiment, the tidying robot 100 may immediately perform the action plan to drop object(s) at a drop location 5600 regardless of remaining scoop capacity in order to immediately drop the objects in a bin. In one embodiment, the tidying robot 100 may include features that allow it to haul a bin behind it, or carry a bin with it. In such an embodiment, the robot may perform an immediate rear dump into the bin behind it, or may set down the bin it is carrying before executing the pickup strategy, then immediately deposit the objects in the bin and retrieve the bin.

In one embodiment, if the scoop is not full and still has capacity, the tidying robot 100 may return to the initial position at block 5514 and continue cleaning while carrying the objects in its scoop, exiting the action plan to pick up objects in path 5500. Alternately, the robot may navigate to a different position that allows for continuation of the vacuuming pattern and may exit the action plan to pick up objects in path 5500.

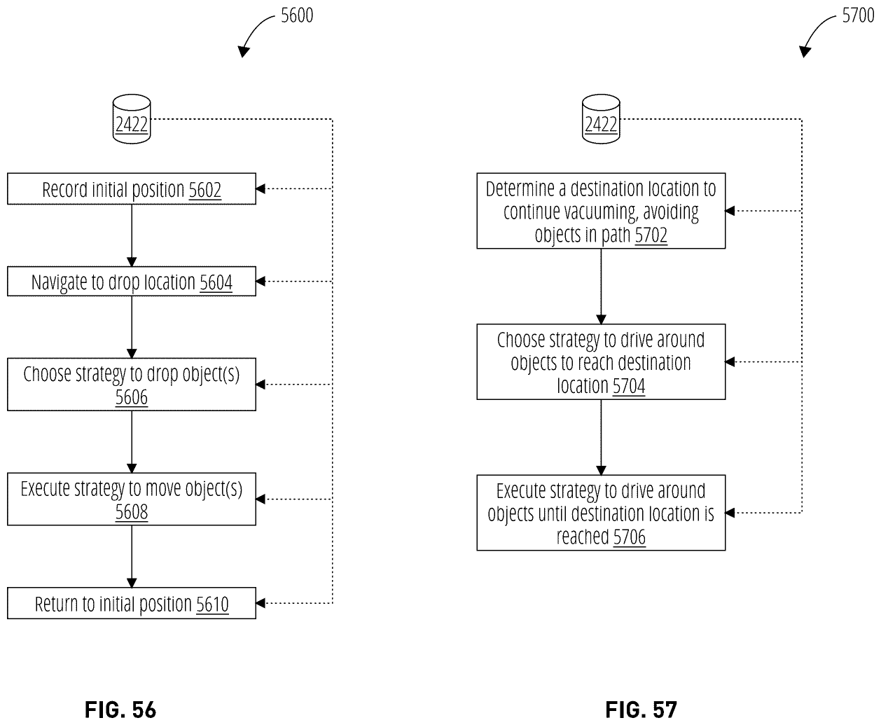

FIG. 56 illustrates an action plan to drop object(s) at a drop location 5600 in accordance with one embodiment. The tidying robot 100 may execute the action plan to drop object(s) at a drop location 5600 supported by the observations, current robot state, current object state, and sensor data 2422 introduced earlier with respect to FIG. 24.

The action plan to drop object(s) at a drop location 5600 may begin at block 5602 with the tidying robot 100 recording an initial position. The tidying robot 100 may then navigate to the drop location at block 5604. The drop location may be a bin or a designated place on the floor that will be vacuumed before dropping, or may have already been vacuumed.

At block 5606, the tidying robot 100 may choose a strategy for dropping the objects. The drop strategy may include performing a rear dump or a front dump, and may involve coordinated patterns of movement by the pusher pad arms to successfully empty the scoop, based on the types of objects to be deposited.

The tidying robot 100 may then execute the strategy to drop the objects at block 5608. In one embodiment, similar to other action plans disclosed herein, a failure in the drop strategy may be detected, wherein the tidying robot 100 may select a different strategy, return to other actions, or alert a user that an object is stuck in the scoop. Finally, at block 5610, the tidying robot 100 may return to the initial position, exiting the action plan to drop object(s) at a drop location 5600 and continuing to vacuum or perform other tasks.

FIG. 57 illustrates an action plan to drive around object(s) 5700 in accordance with one embodiment. The tidying robot 100 may execute the action plan to drive around object(s) 5700 supported by the observations, current robot state, current object state, and sensor data 2422 introduced earlier with respect to FIG. 24.

The action plan to drive around object(s) 5700 may begin at block 5702 with the tidying robot 100 determining a destination location to continue vacuuming after navigating around and avoiding the objects currently obstructing the vacuuming path. In one embodiment, the tidying robot 100 may use a map including the location of the objects and which areas have already been vacuumed to determine the desired target location beyond obstructing objects where it may best continue its vacuuming pattern.

At block 5704, the tidying robot 100 may choose a strategy to drive around the objects to reach the selected destination location. The tidying robot 100 may then execute the strategy at block 5706. In one embodiment, the robot may plot waypoint(s) to a destination location on a local map using an algorithm to navigate around objects. The robot may then navigate to the destination location following those waypoints.

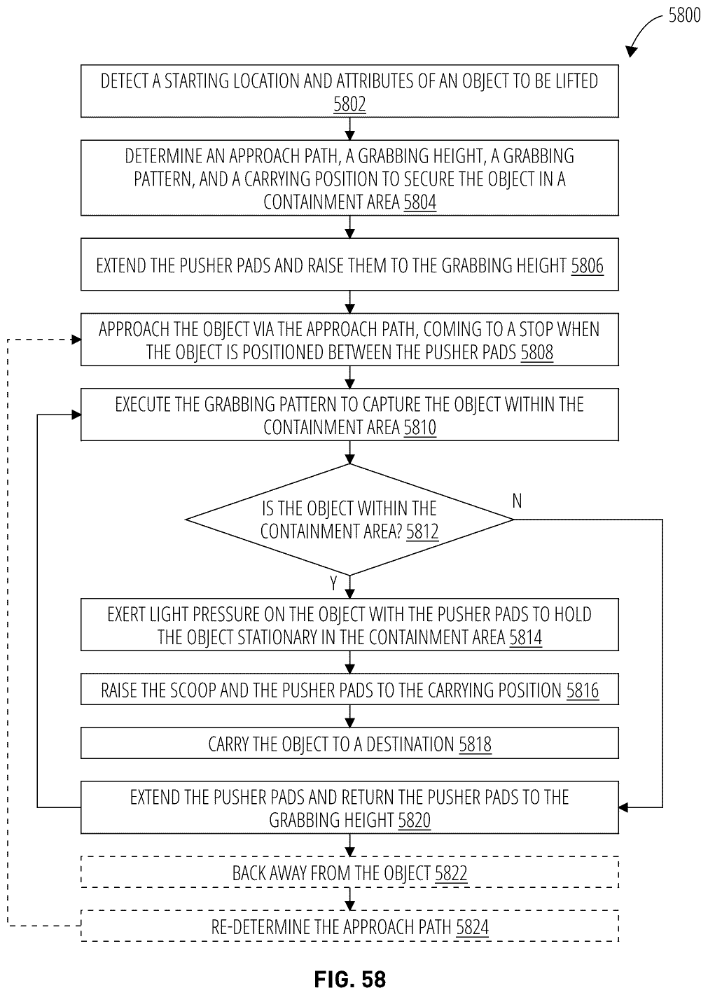

The disclosed algorithm may comprise a capture process 5800 as illustrated in FIG. 58. The capture process 5800 may be performed by a tidying robot 100 such as that introduced with respect to FIG. 1A. This robot may have the sensing system, control system, mobility system, pusher pads, pusher pad arms, and scoop illustrated in FIG. 1A through FIG. 1A, or similar systems and features performing equivalent functions as is well understood in the art.

The capture process 5800 may begin in block 5802 where the robot detects a starting location and attributes of an object to be lifted. Starting location may be determined relative to a learned map of landmarks within a room the robot is programmed to declutter. Such a map may be stored in memory within the electrical systems of the robot. These systems are described in greater detail with regard to FIG. 23. Object attributes may be detected based on input from a sensing system, which may comprise cameras, LIDAR, or other sensors. In some embodiments, data detected by such sensors may be compared to a database of common objects to determine attributes such as deformability and dimensions. In some embodiments, the robot may use known landmark attributes to calculate object attributes such as dimensions. In some embodiments, machine learning may be used to improve attributes detection and analysis.

In block 5804, the robot may determine an approach path to the starting location. The approach path may take into account the geometry of the surrounding space, obstacles detected around the object, and how components the robot may be configured as the robot approaches the object. The robot may further determine a grabbing height for initial contact with the object. This grabbing height may take into account an estimated center of gravity for the object in order for the pusher pads to move the object with the lowest chance of slipping off of, under, or around the object, or deflecting the object in some direction other than into the scoop. The robot may determine a grabbing pattern for movement of the pusher pads during object capture, such that objects may be contacted from a direction and with a force applied in intervals optimized to direct and impel the object into the scoop. Finally, the robot may determine a carrying position of the pusher pads and a scoop that secures the object in a containment area for transport after the object is captured. This position may take into account attributes such as the dimensions of the object, its weight, and its center of gravity.

In block 5806, the robot may extend its pusher pads out and forward with respect to the pusher pad arms and raise the pusher pads to the grabbing height. This may allow the robot to approach the object as nearly as possible without having to leave room for this extension after the approach. Alternately, the robot may perform some portion of the approach with arms folded in close to the chassis and scoop to prevent impacting obstacles along the approach path. In some embodiments, the robot may first navigate the approach path and deploy arms and scoop to clear objects out of and away from the approach path. In block 5808, the robot may finally approach the object via the approach path, coming to a stop when the object is positioned between the pusher pads.

In block 5810, the robot may execute the grabbing pattern determined in block 5802 to capture the object within the containment area. The containment area may be an area roughly described by the dimensions of the scoop and the disposition of the pusher pad arms with respect to the scoop. It may be understood to be an area in which the objects to be transported may reside during transit with minimal chances of shifting or being dislodged or dropped from the scoop and pusher pad arms. In decision block 5812, the robot may confirm that the object is within the containment area. If the object is within the containment area, the robot may proceed to block 5814.

In block 5814, the robot may exert a light pressure on the object with the pusher pads to hold the object stationary in the containment area. This pressure may be downward in some embodiments to hold an object extending above the top of the scoop down against the sides and surface of the scoop. In other embodiments this pressure may be horizontally exerted to hold an object within the scoop against the back of the scoop. In some embodiments, pressure may be against the bottom of the scoop in order to prevent a gap from forming that may allow objects to slide out of the front of the scoop.

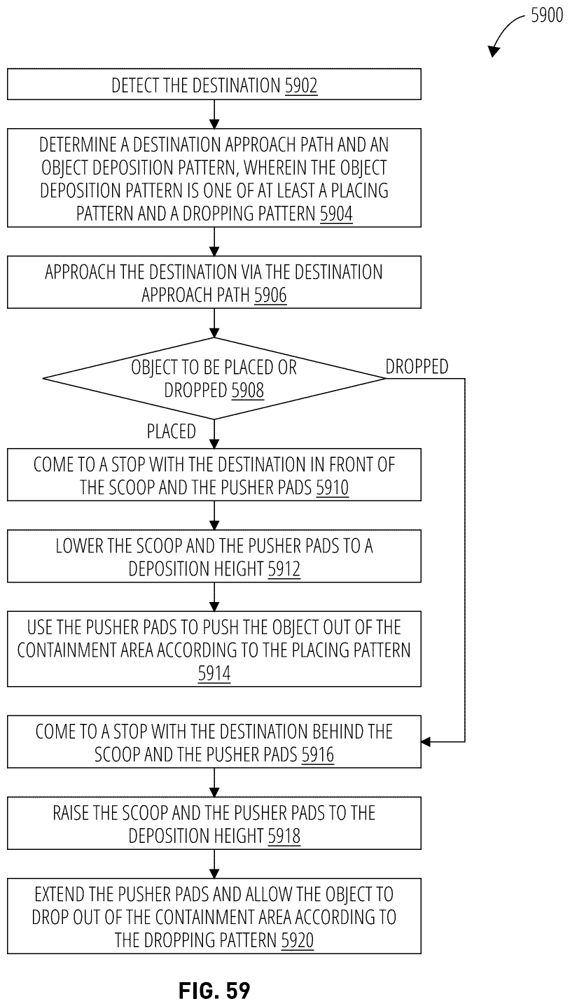

In block 5816, the robot may raise the scoop and the pusher pads to the carrying position determined in block 5802. The robot may then at block 5818 carry the object to a destination. The robot may follow a transitional path between the starting location and a destination where the object will be deposited. To deposit the object at the destination, the robot may follow the deposition process 5900 illustrated in FIG. 59.

If at decision block 5812 the object is not detected within the containment area, or is determined to be partially or precariously situated within the containment area, the robot may at block 5820 extend the pusher pads fall out of the scoop and forward with respect to the pusher pad arms and returns the pusher pads to the grabbing height. The robot may then return to block 5810. In some embodiments, the robot may at block 5822 back away from the object if simply releasing and reattempting to capture the object is not feasible. This may occur if the object has been repositioned or moved by the initial attempt to capture it. In block 5824, the robot may re-determine the approach path to the object. The robot may then return to block 5808.

FIG. 59 illustrates a deposition process 5900 in accordance with one embodiment. The deposition process 5900 may be performed by a tidying robot 100 such as that introduced with respect to FIG. 1A as part of the algorithm disclosed herein. This robot may have the sensing system, control system, mobility system, pusher pads, pusher pad arms, and scoop illustrated in FIG. 1A through FIG. 2B or similar systems and features performing equivalent functions as is well understood in the art.

In block 5902, the robot may detect the destination where an object carried by the robot is intended to be deposited. In block 5904, the robot may determine a destination approach path to the destination. This path may be determined so as to avoid obstacles in the vicinity of the destination. In some embodiments, the robot may perform additional navigation steps to push objects out of and away from the destination approach path. The robot may also determine an object deposition pattern, wherein the object deposition pattern is one of at least a placing pattern and a dropping pattern. Some neatly stackable objects such as books, other media, narrow boxes, etc., may be most neatly decluttered by stacking them carefully. Other objects may not be neatly stackable, but may be easy to deposit by dropping into a bin. Based on object attributes, the robot may determine which object deposition pattern is most appropriate to the object.

In block 5906, the robot may approach the destination via the destination approach path. How the robot navigates the destination approach path may be determined based on the object deposition pattern. If the object being carried is to be dropped over the back of the robot's chassis, the robot may traverse the destination approach path in reverse, coming to a stop with the back of the chassis nearest the destination. Alternatively, for objects to be stacked or placed in front of the scoop, i.e., at the area of the scoop that is opposite the chassis, the robot may travel forward along the destination approach path so as to bring the scoop nearest the destination.

At decision block 5908, the robot may proceed in one of at least two ways, depending on whether the object is to be placed or dropped. If the object deposition pattern is intended to be a placing pattern, the robot may proceed to block 5910. If the object deposition pattern is intended to be a dropping pattern, the robot may proceed to block 5916.

For objects to be placed via the placing pattern, the robot may come to a stop with the destination in front of the scoop and the pusher pads at block 5910. In block 5912, the robot may lower the scoop and the pusher pads to a deposition height. For example, if depositing a book on an existing stack of books, the deposition height may be slightly above the top of the highest book in the stack, such that the book may be placed without disrupting the stack or dropping the book from a height such that it might have enough momentum to slide off the stack or destabilize the stack. Finally, at block 5914, the robot may use its pusher pads to push the object out of the containment area and onto the destination. In one embodiment, the scoop may be tilted forward to drop objects, with or without the assistance of the pusher pads pushing the objects out from the scoop.

If in decision block 5908 the robot determines that it will proceed with an object deposition pattern that is a dropping pattern, the robot may continue to block 5916. At block 5916, the robot may come to a stop with the destination behind the scoop and the pusher pads, and by virtue of this, behind the chassis for a robot such as the one introduced in FIG. 1A. In block 5918, the robot may raise the scoop and the pusher pads to the deposition height. In one embodiment the object may be so positioned that raising the scoop and pusher pad arms from the carrying position to the deposition height results in the object dropping out of the containment area into the destination area. Otherwise, in block 5920, the robot may extend the pusher pads and allow the object to drop out of the containment area, such that the object comes to rest at or in the destination area. In one embodiment, the scoop may be tilted forward to drop objects, with or without the assistance of the pusher pads pushing the objects out from the scoop.

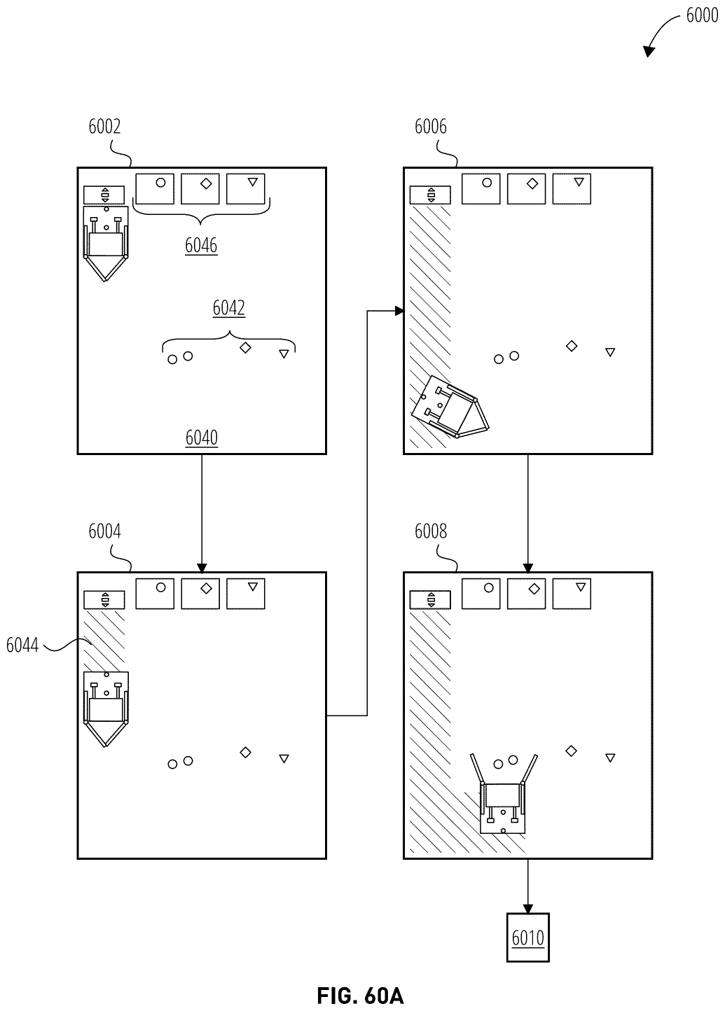

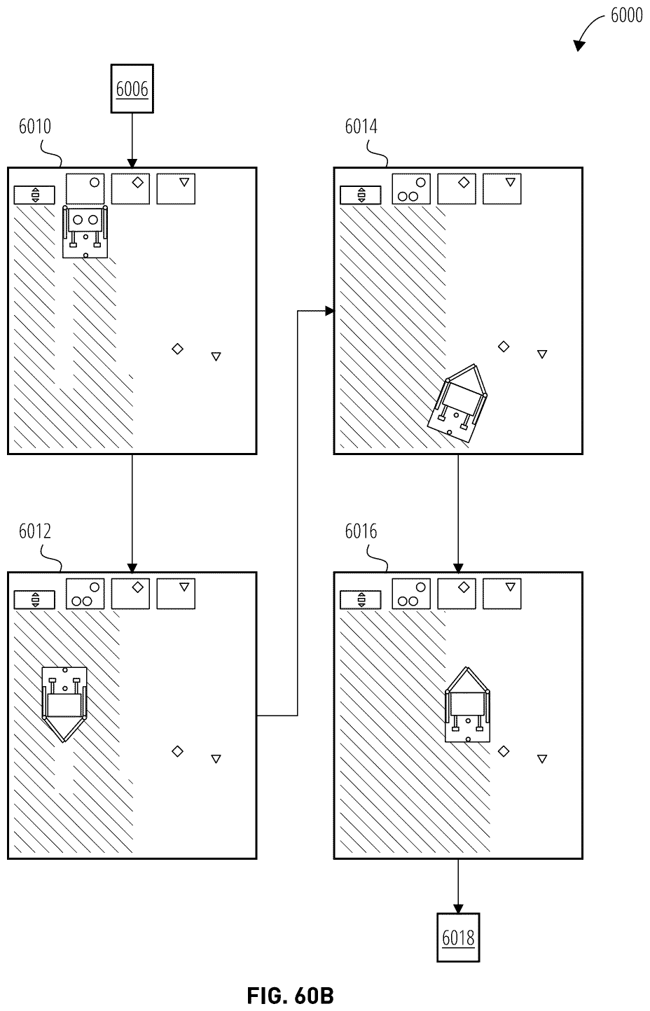

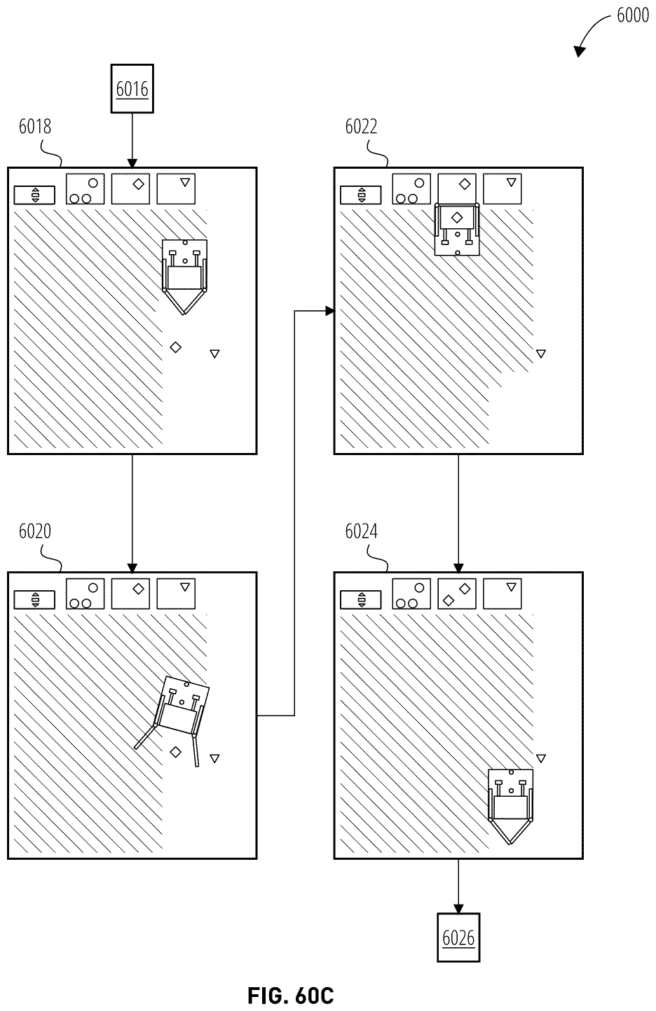

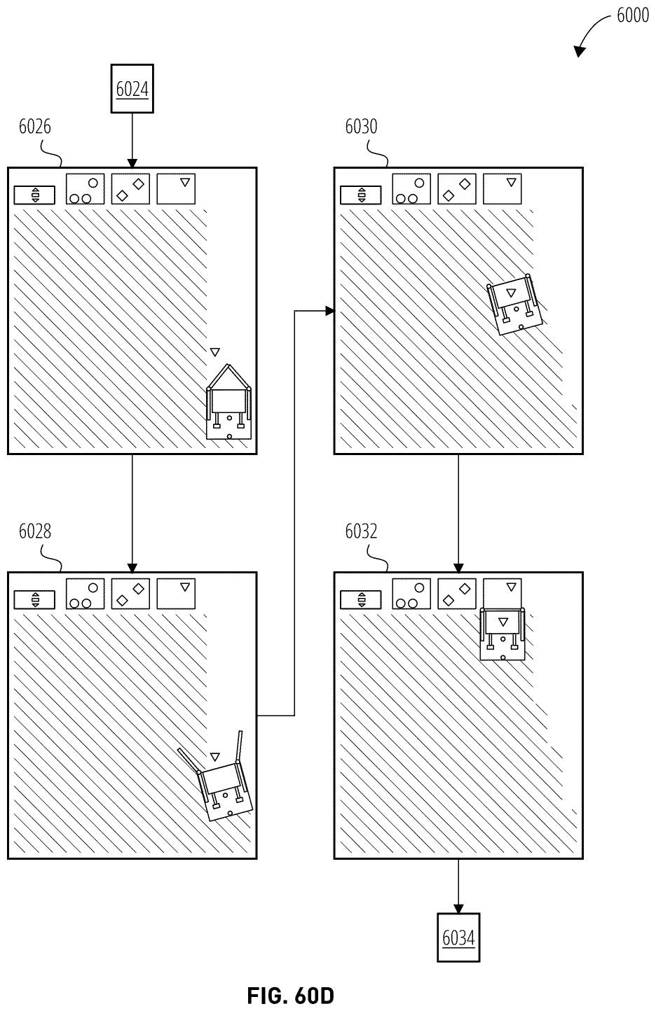

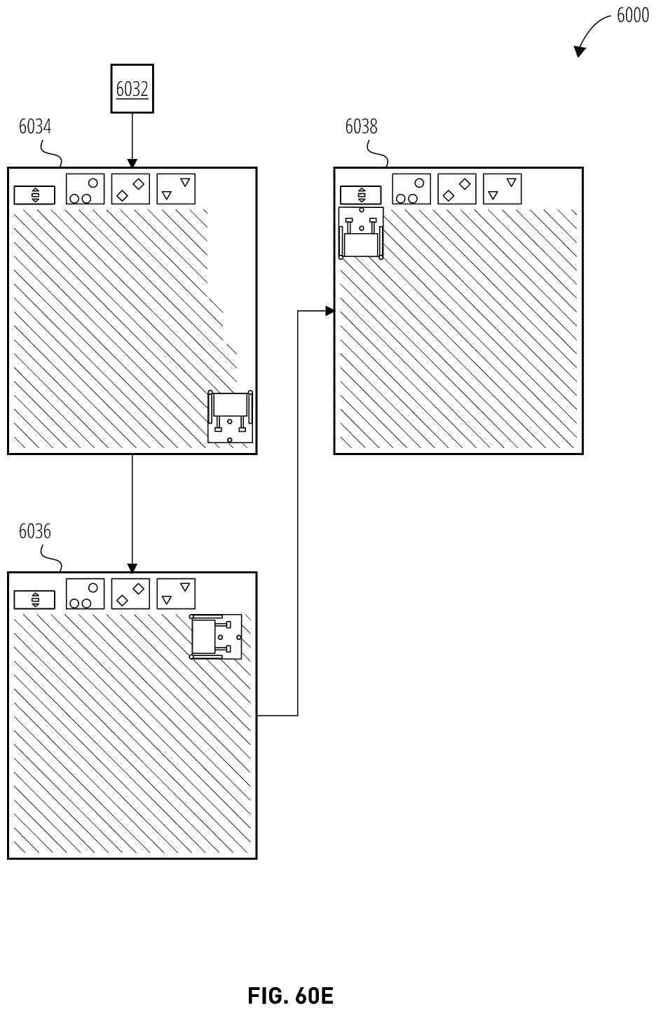

FIG. 60A-FIG. 60E illustrate an execution of a vacuuming strategy and tidying strategy 6000 in accordance with one embodiment. A tidying robot 100 may be seen, beginning at its base station 1600 in step 6002. It may be configured to clean a target cleaning area 6040 in which there are obstructions 6042. There are also target storage bins 6046 in which different categories of obstructions may be placed. In step 6004, the robot may be seen departing from its base station, having begun a vacuum cleaning pattern 6044, where cleaned areas are marked on its map, as indicated by the diagonal line pattern. The robot may encounter a wall or some other immovable object at step 6006, and may make a turn to continue its vacuuming strategy. The robot may encounter objects at step 6008. The robot may pick the objects up in its scoop and carry them to a bin, leaving a portion of the floor unvacuumed as shown in step 6010. After depositing the objects into the bin, the robot may turn and vacuum the portion left unvacuumed in step 6012, and may proceed to a point along the path it was previously following, continuing its vacuuming pattern, as shown in step 6014, step 6016, and step 6018. More objects may be encountered and retrieved at step 6020 and moved to appropriate bins at step 6022, with the robot returning to its vacuuming pattern at step 6024, this process being again repeated in step 6026, step 6028, step 6030, step 6032, and step 6034. When all areas of the vacuuming pattern have been completed and the entire floor has thus been vacuumed, as shown at step 6036, the robot may return to its base station at step 6038.

In one embodiment, debris and trash may be among the objects detected, and the robot may use its pusher pads to sweep these into its scoop and carry them to a designated trash bin. In another embodiment, the robot may traverse the floor in a pre-sweep position such as the inverted wedge configuration shown in FIG. 31A and FIG. 31B. In such an embodiment, the robot may relocate any debris it may have picked up in this position to an unvacuumed spot on the floor before retrieving and putting away objects. It may then re-encounter the debris later in its vacuuming pattern, and continue in this manner until all tidyable objects are put away, at which time it may collect the debris in its scoop and deposit it in an appropriate trash bin. For example, the bin on the base station 1600 illustrated in FIG. 16A and FIG. 16B may be used for depositing this debris once the vacuuming pattern is complete.

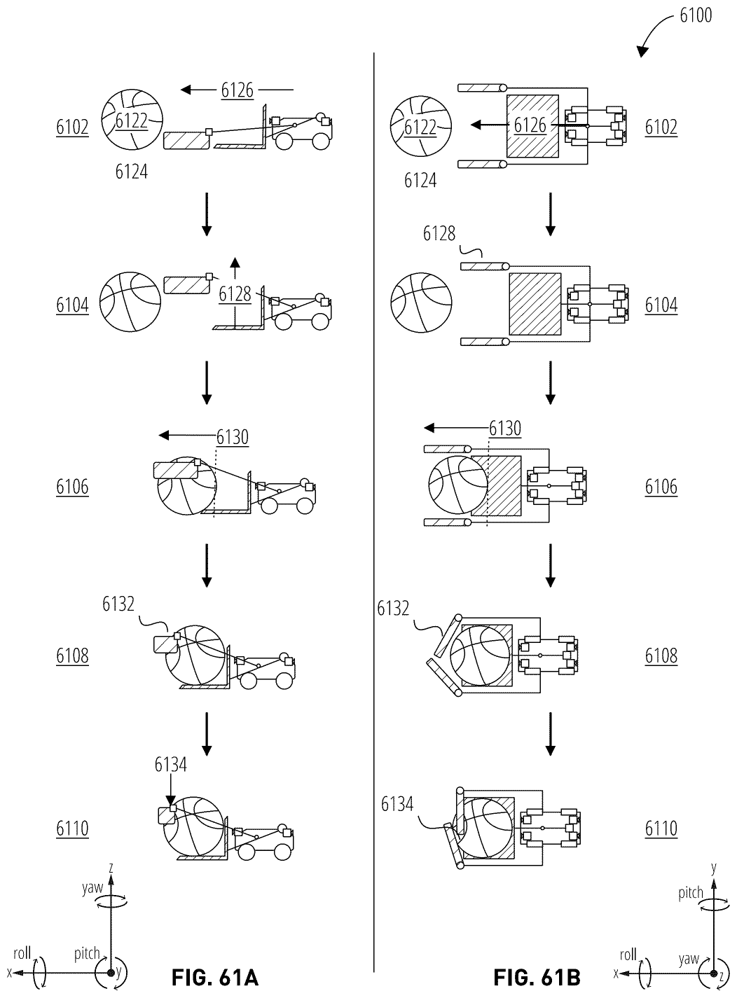

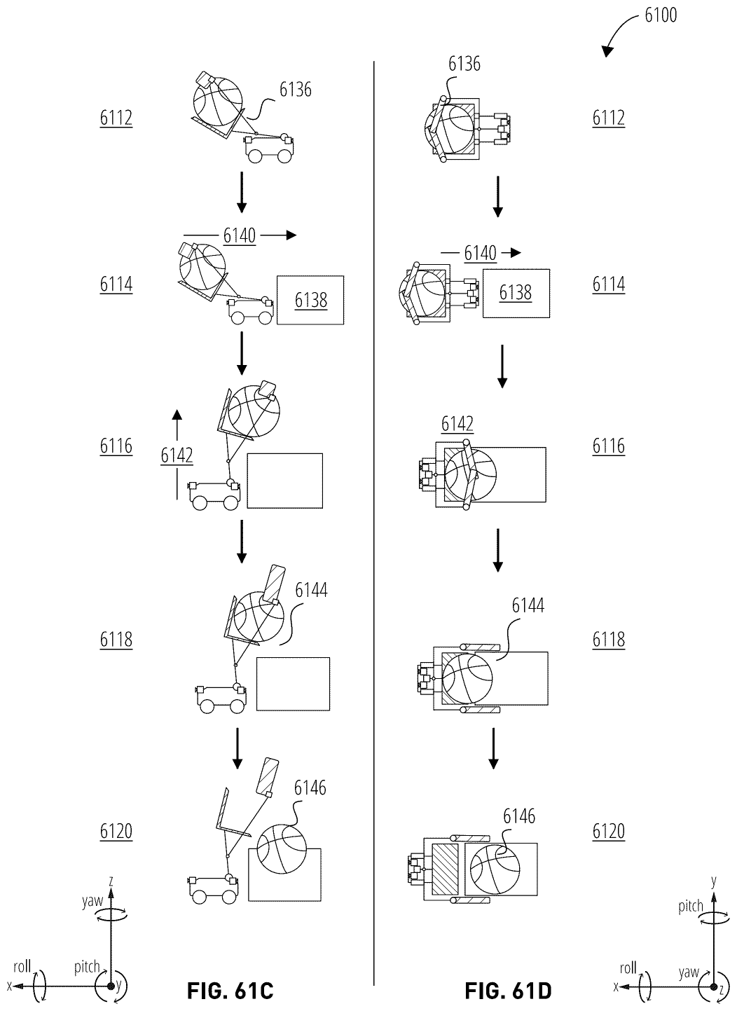

FIG. 61A-FIG. 61D illustrate a pickup strategy for a large, slightly deformable object 6100 in accordance with one embodiment. FIG. 61A shows a side view of the robot performing steps 6102-6110, while FIG. 61B shows a top view of the performance of these same steps. FIG. 61C illustrates a side view of steps 6112-6120, and FIG. 61D shows a top view of these steps. A large, slightly deformable object may be an object such as a basketball, which extends outside of the dimensions of the scoop, and may respond to pressure with very little deformation or change of shape.

As illustrated in FIG. 61A and FIG. 61B, the robot may first drive to the basketball 6122, such as a basketball, located at a starting location 6124, following an approach path 6126 at step 6102. The robot may adjust its pusher pad arms to a grabbing height 6128 based on the type of object at step 6104. For a basketball 6122 such as a basketball, this may be near or above the top of the basketball. The robot, at step 6106, may drive so that its arms align past the object 6130. The robot may employ a grabbing pattern 6132 at step 6108 to use its arms to push or roll the basketball onto the scoop or scoop. Using the pusher pad arms at step 6110, the robot may apply a light pressure 6134 to the top of the basketball to hold it securely within or atop the scoop.

As shown in FIG. 61C and FIG. 61D, the robot may lift the basketball at step 6112 while continuing to hold it with its pusher pad arms, maintaining the ball within the scoop in a carrying position 6136. Next, at step 6114, the robot may drive to the post pickup location 6138 where the basketball is intended to be placed, following a post pickup location approach path 6140. At step 6116, the robot may adjust the scoop and pusher pad arms to position the basketball at a deposition height 6142. For an object such as a basketball, this may position the scoop and ball in an area above the robot, tilted or aimed toward a container. Alternatively, the container may be to the front of the robot and the objects deposited as illustrated in FIG. 21. The robot may at step 6118 open its arms to release the object into the post pickup location container using a dropping pattern 6144. The basketball may then fall out of the scoop 6146 and come to rest in its post pickup location container at step 6120.

While the robot shown in FIG. 61A-FIG. 61D may be seen to have pusher pad arms attaching to pivot points on the scoop arm, this is a simplified schematic view provided for exemplary purposes. Performance of the pickup strategy for a large, slightly deformable object 6100 is not limited to robot embodiments exhibiting this feature. The pickup strategy for a large, slightly deformable object 6100 may be performed by any of the robot embodiments disclosed herein.

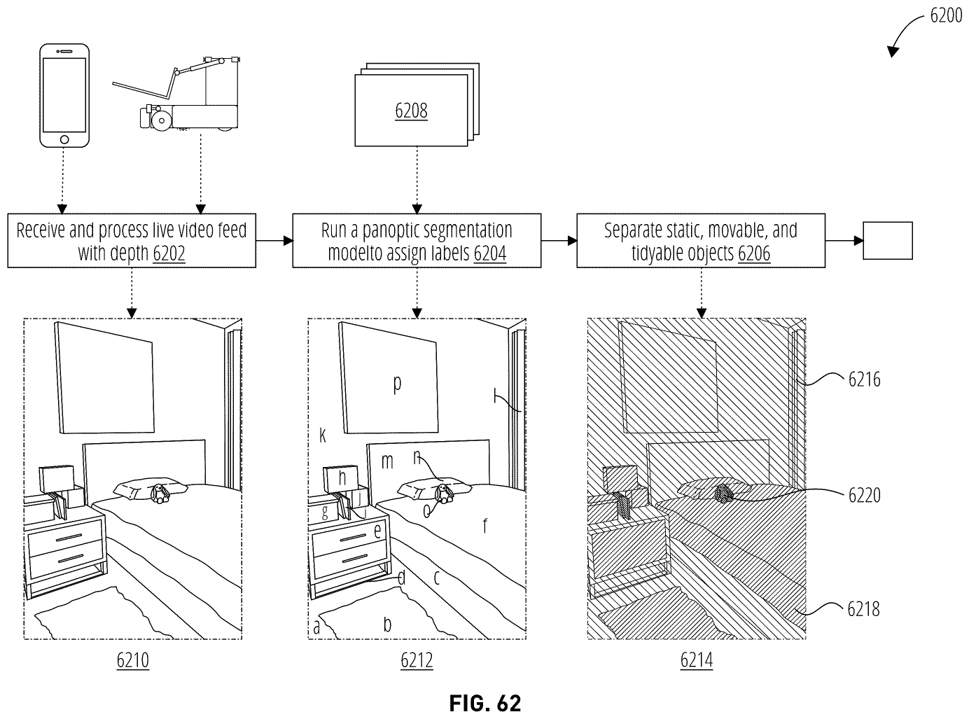

FIG. 62 illustrates a video-feed segmentation routine 6200 in accordance with one embodiment. Although the example video-feed segmentation routine 6200 depicts a particular sequence of operations, the sequence may be altered without departing from the scope of the present disclosure. For example, some of the operations depicted may be performed in parallel or in a different sequence that does not materially affect the function of the video-feed segmentation routine 6200. In other examples, different components of an example device or system that implements the video-feed segmentation routine 6200 may perform functions at substantially the same time or in a specific sequence.

According to some examples, the method includes receiving and processing live video with depth at block 6202. The live video feed may capture an environment to be tidied. For example, a mobile computing device such as a smartphone or tablet or the tidying robot 100 may be configured to receive and process live video with depth using a camera configured as part of the device in conjunction with the robotic control system 2300. This live video may be used to begin mapping the environment to be tidied, and to support the configuration and display of an augmented reality (AR) user interface. Alternatively, the tidying robot previously disclosed may be configured to receive and process live video with depth using its cameras 2404 in conjunction with the robotic control system 2300. This may support the robot's initialization, configuration, and operation as disclosed herein. The live video feed may include images of a scene 6210 across the environment to be tidied. These may be processed to display an augmented reality view to a user on a global map of the environment to be tidied.

According to some examples, the method includes running a panoptic segmentation model 6208 to assign labels at block 6204. For example, the panoptic segmentation model 6208 illustrated in FIG. 62 may run a model to assign labels. The model may assign a semantic label (such as an object type), an instance identifier, and a movability attribute (such as static, movable, and tidyable) for each pixel in an image of a scene 6210 (such as is displayed in a frame of captured video). The panoptic segmentation model 6208 may be configured as part of the logic 2314 of the robotic control system 2300 in one embodiment. The panoptic segmentation model 6208 may in this manner produce a segmented image 6212 for each image of a scene 6210. Elements detected in the segmented image 6212 may in one embodiment be labeled as shown:
a. floor
b. rug
c. bedframe
d. nightstand
e. drawer
f. bedspread
g. box
h. lamp
i. books
j. picture
k. wall
l. curtains
m. headboard
n. pillow
o. stuffed animal
p. painting

According to some examples, the method includes separating the segmented image into static objects 6216, movable objects 6218, and tidyable objects 6220 at block 6206. For example, the robotic control system 2300 illustrated in FIG. 23 may separate static, movable, and tidyable objects. Using the segmented image 6212 and assigned labels, static structures in the represented scene, such as floors, walls, and large furniture, may be separated out as static objects 6216 from movable objects 6218 like chairs, doors, and rugs, and tidyable objects 6220 such as toys, books, and clothing. Upon completion of the video-feed segmentation routine 6200, the mobile device, tidying robot, and robotic control system may act to perform a static object identification process based on the objects separated into static objects, movable objects, and tidyable objects 6214.

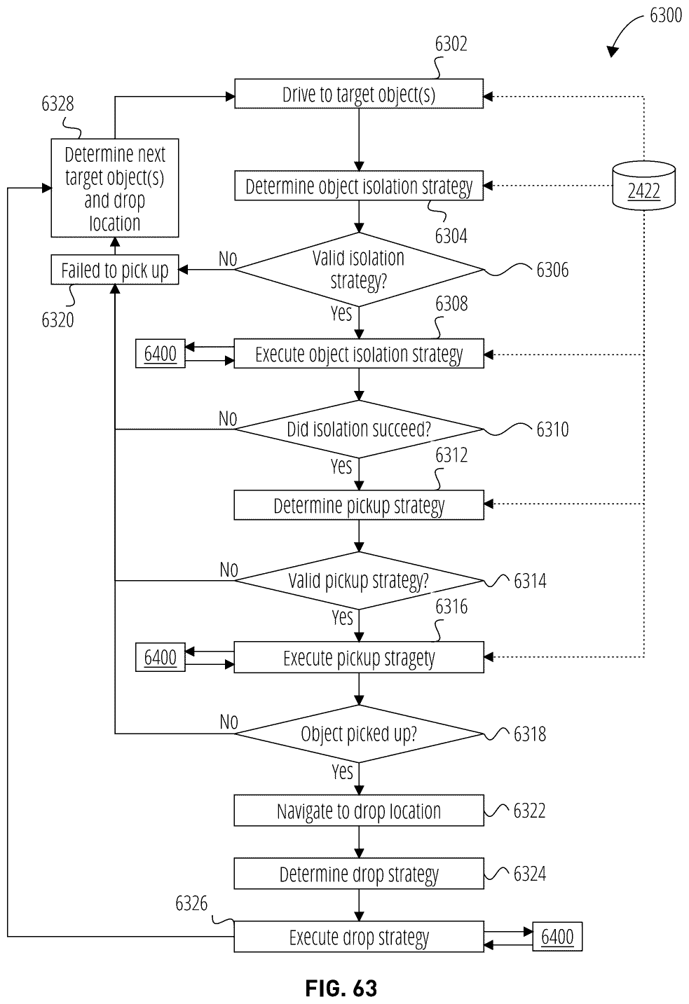

FIG. 63 illustrates a main navigation, collection, and deposition process 6300 in accordance with one embodiment. According to some examples, the method includes driving to target object(s) at block 6302. For example, the tidying robot 100 such as that introduced with respect to FIG. 1A may drive to target object(s) using a local map or global map to navigate to a position near the target object(s), relying upon observations, current robot state, current object state, and sensor data 2422 determined as illustrated in FIG. 24.

According to some examples, the method includes determining an object isolation strategy at block 6304. For example, the robotic control system 2300 illustrated in FIG. 23 may determine an object isolation strategy in order to separate the target object(s) from other objects in the environment based on the position of the object(s) in the environment. The object isolation strategy may be determined using a machine learning model or a rules based approach, relying upon observations, current robot state, current object state, and sensor data 2422 determined as illustrated in FIG. 24. In some cases, object isolation may not be needed, and related blocks may be skipped. For example, in an area containing few items to be picked up and moved, or where such items are not in a proximity to each other, furniture, walls, or other obstacles, that would lead to interference in picking up target objects, object isolation may not be needed.

In some cases, a valid isolation strategy may not exist. For example, the robotic control system 2300 illustrated in FIG. 23 may be unable to determine a valid isolation strategy. If it is determined at decision block 6306 that there is no valid isolation strategy, the target object(s) may be marked as failed to pick up at block 6320. The main navigation, collection, and deposition process 6300 may then advance to block 6328, where the next target object(s) are determined.

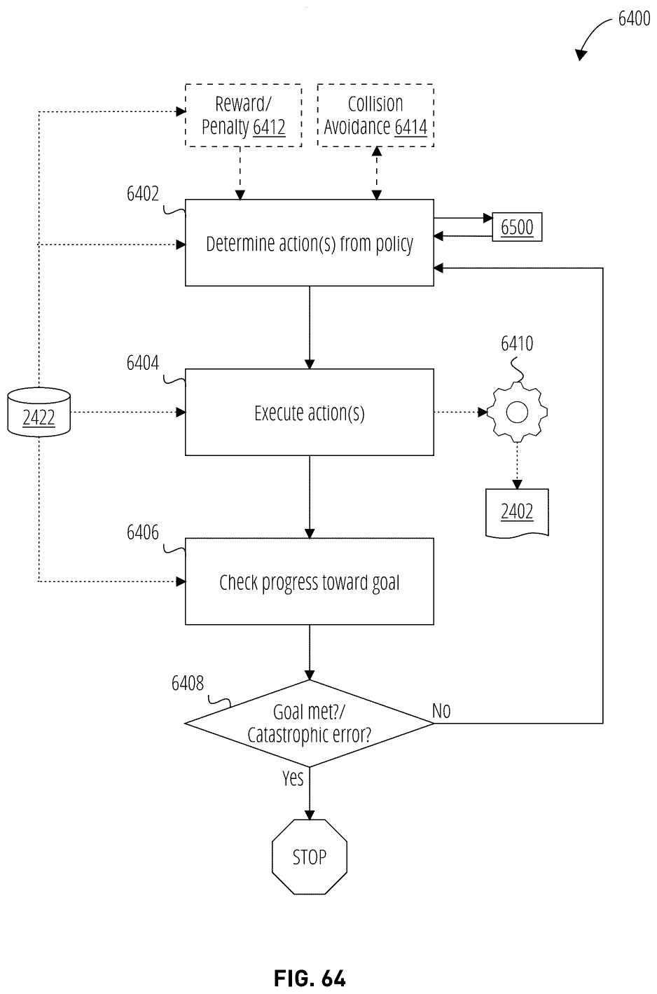

If there is a valid isolation strategy determined at decision block 6306, the tidying robot 100 may execute the object isolation strategy to separate the target object(s) from other objects at block 6308. The isolation strategy may follow strategy steps for isolation strategy, pickup strategy, and drop strategy 6400 illustrated in FIG. 64. The isolation strategy may be a reinforcement learning based strategy using rewards and penalties in addition to observations, current robot state, current object state, and sensor data 2422, or a rules based strategy relying upon observations, current robot state, current object state, and sensor data 2422 determined as illustrated in FIG. 24. Reinforcement learning based strategies relying on rewards and penalties are described in greater detail with reference to FIG. 64.

Rules based strategies may use conditional logic to determine the next logic based on observations, current robot state, current object state, and sensor data 2422 such as are developed in FIG. 24. Each rules based strategy may have a list of available actions it may consider. In one embodiment, a movement collision avoidance system may be used to determine the range of motion involved with each action. Rules based strategies for object isolation may include:
Navigating robot to a position facing the target object(s) to be isolated, but far enough away to open pusher pad arms and pusher pads and lower the scoop
Opening the pusher pad arms and pusher pads, lowering the pusher pad arms and pusher pads, and lowering the scoop
Turning robot slightly in-place so that target object(s) are centered in a front view
Opening pusher pad arms and pusher pads to be slightly wider than target object(s).
Driving forward slowly until the end of the pusher pad arms and pusher pads is positioned past the target object(s).
Slightly closing the pusher pad arms and pusher pads into a V-shape so that the pusher pad arms and pusher pads surround the target object(s)
Driving backwards 100 centimeters, moving the target object(s) into an open space

According to some examples, the method includes determining whether or not the isolation succeeded at decision block 6310. For example, the robotic control system 2300 illustrated in FIG. 23 may determine whether or not the target object(s) were successfully isolated. If the isolation strategy does not succeed, the target object(s) may be marked as failed to pickup at block 6320. The main navigation, collection, and deposition process 6300 advances to block 6328, where a next target object is determined. In some embodiments, rather than determining a next target object, a different strategy may be selected for the same target object. For example, if target object(s) are not able to be isolated by the current isolation strategy, a different isolation strategy may be selected and isolation retried.

If the target object(s) were successfully isolated, the method then includes determining a pickup strategy at block 6312. For example, the robotic control system 2300 illustrated in FIG. 23 may determine the pickup strategy. The pickup strategy for the particular target object(s) and location may be determined using a machine learning model or a rules based approach, relying upon observations, current robot state, current object state, and sensor data 2422 determined as illustrated in FIG. 24.

In some cases, a valid pickup strategy may not exist. For example, the robotic control system 2300 illustrated in FIG. 23 may be unable to determine a valid pickup strategy. If it is determined at decision block 6314 that there is no valid pickup strategy, the target object(s) may be marked as failed to pick up at block 6320, as previously noted. The pickup strategy may need to take into account:
An initial default position for the pusher pad arms and the scoop before starting pickup
A floor type detection for hard surfaces versus carpet, which may affect pickup strategies
A final scoop and pusher pad arm position for carrying

If there is a valid pickup strategy determined at decision block 6314, the tidying robot 100 such as that introduced with respect to FIG. 1A may execute a pickup strategy at block 6316. The pickup strategy may follow strategy steps for isolation strategy, pickup strategy, and drop strategy 6400 illustrated in FIG. 64. The pickup strategy may be a reinforcement learning based strategy or a rules based strategy, relying upon observations, current robot state, current object state, and sensor data 2422 determined as illustrated in FIG. 24. Rules based strategies for object pickup may include:
Navigating the robot to a position facing the target object(s), but far enough away to open the pusher pad arms and pusher pads and lower the scoop
Opening the pusher pad arms and pusher pads, lowering the pusher pad arms and pusher pads, and lowering the scoop
Turning the robot slightly in-place so that the target object(s) are centered in the front view
Driving forward until the target object(s) are in a “pickup zone” against the edge of the scoop
Determining a center location of target object(s) against the scoop-on the right, left or center.
   If on the right, closing the right pusher pad arm and pusher pad first with the left pusher pad arm and pusher pad closing behind
   Otherwise, closing the left pusher pad arm and pusher pad first with the right pusher pad arm and pusher pad closing behind
Determining if target object(s) were successfully pushed into the scoop
   If yes, then pickup was successful
   If no, lift pusher pad arms and pusher pads and then try again at an appropriate part of the strategy.

According to some examples, the method includes determining whether or not the target object(s) were picked up at decision block 6318. For example, the robotic control system 2300 illustrated in FIG. 23 may determine whether or not the target object(s) were picked up. Pickup success may be evaluated using:
Object detection within the area of the scoop and pusher pad arms (i.e., the containment area as previously illustrated) to determine if the object is within the scoop/pusher pad arms/containment area
Force feedback from actuator force feedback sensors indicating that the object is retained by the pusher pad arms
Tracking motion of object(s) during pickup into area of scoop and retaining the state of those object(s) in memory (memory is often relied upon as objects may no longer be visible when the scoop is in its carrying position)
Detecting an increased weight of the scoop during lifting indicating the object is in the scoop
Utilizing a classification model for whether an object is in the scoop.
Using force feedback, increased weight, and/or a dedicated camera to re-check that an object is in the scoop while the robot is in motion

If the pickup strategy fails, the target object(s) may be marked as failed to pick up at block 6320, as previously described. If the target object(s) were successfully picked up, the method includes navigating to drop location at block 6322. For example, the tidying robot 100 such as that introduced with respect to FIG. 1A may navigate to a predetermined drop location. The drop location may be a container or a designated area of the ground or floor. Navigation may be controlled by a machine learning model or a rules based approach.

According to some examples, the method includes determining a drop strategy at block 6324. For example, the robotic control system 2300 illustrated in FIG. 23 may determine a drop strategy. The drop strategy may need to take into account the carrying position determined for the pickup strategy. The drop strategy may be determined using a machine learning model or a rules based approach. Rules based strategies for object drop may include:
Navigate the robot to a position 100 centimeters away from the side of a bin
Turn the robot in place to align it facing the bin
Drive toward the bin maintaining an alignment centered on the side of the bin.
Stop three centimeters from the side of the bin
Verify that the robot is correctly positioned against the side of the bin
   If yes, lift the scoop up and back to drop target object(s) into the bin.
   If no, drive away from bin and restart the process

Object drop strategies may involve navigating with a rear camera if attempting a back drop, or with the front camera if attempting a forward drop.

According to some examples, the method includes executing the drop strategy at block 6326. For example, the tidying robot 100 such as that introduced with respect to FIG. 1A may execute the drop strategy. The drop strategy may follow strategy steps for isolation strategy, pickup strategy, and drop strategy 6400 illustrated in FIG. 64. The drop strategy may be a reinforcement learning based strategy or a rules based strategy. Once the drop strategy has been executed at block 6326, the method may proceed to determining the next target object(s) at block 6328. For example, the robotic control system 2300 illustrated in FIG. 23 may determine next target object(s). Once new target object(s) have been determined, the process may be repeated for the new target object(s).

Strategies such as the isolation strategy, pickup strategy, and drop strategy referenced above may be simple strategies, or may incorporate rewards and collision avoidance elements. These strategies may follow general approaches such as the strategy steps for isolation strategy, pickup strategy, and drop strategy 6400 illustrated in FIG. 64.

In some embodiments, object isolation strategies may include:
Using pusher pad arms and pusher pads on the floor in a V-shape to surround object(s) and backing up
Precisely grasping the object(s) and backing up with pusher pad arms and pusher pads in a V-shape
Loosely rolling a large object away with pusher pad arms and pusher pads elevated
Spreading out dense clutter by loosely grabbing a pile and backing up
Placing a single pusher pad arm/pusher pad on the floor between target object(s) and clutter, then turning
Putting small toys in the scoop, then dropping them to separate them
Using a single pusher pad arm/pusher pad to move object(s) away from a wall

In some embodiments, pickup strategies may include:
Closing the pusher pad arms/pusher pads on the floor to pick up a simple object
Picking up piles of small objects like small plastic building blocks by closing pusher pad arms/pusher pads on the ground
Picking up small, rollable objects like balls by batting them lightly on their tops with pusher pad arms/pusher pads, thus rolling them into the scoop
Picking up deformable objects like clothing using pusher pad arms/pusher pads to repeatedly compress the object(s) into the scoop
Grabbing an oversized, soft object like a large stuffed animal by grabbing and compressing it with the pusher pad arms/pusher pads
Grabbing a large ball by rolling it and holding it against the scoop with raised pusher pad arms/pusher pads
Picking up flat objects like puzzle pieces by passing the pusher pads over them sideways to cause instability
Grasping books and other large flat objects
Picking up clothes with pusher pad arms/pusher pads, lifting them above the scoop, and then dropping them into the scoop.
Rolling balls by starting a first pusher pad arm movement and immediately starting a second pusher pad arm movement

In some embodiments, drop strategies may include:
Back dropping into a bin
Front dropping into a bin
Forward releasing onto the floor
Forward releasing against a wall
Stacking books or other flat objects
Directly dropping a large object using pusher pad arms/pusher pads instead of relying on the scoop

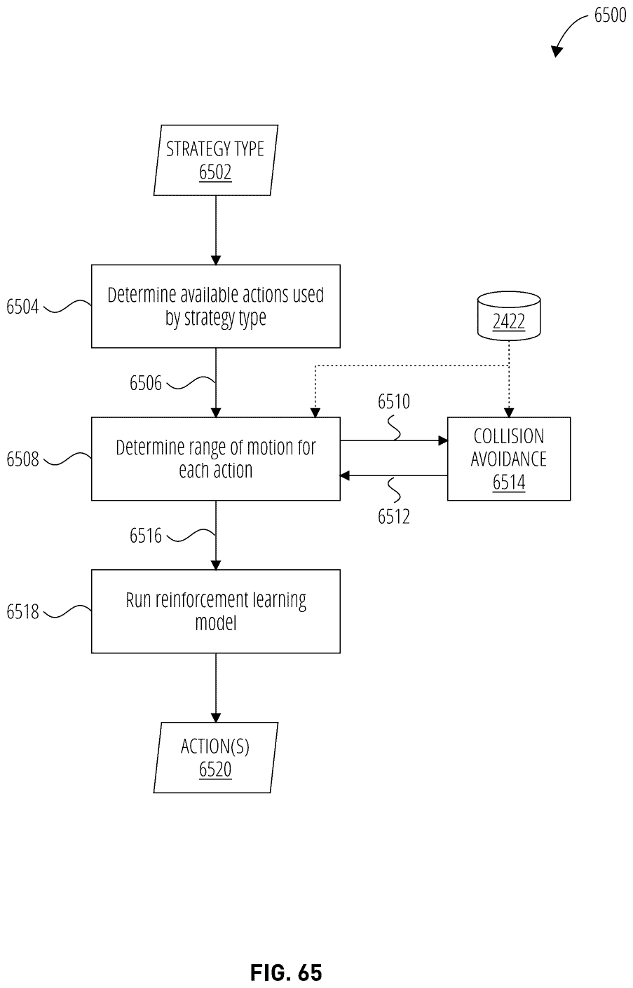

FIG. 64 illustrates strategy steps for isolation strategy, pickup strategy, and drop strategy 6400 in accordance with one embodiment. According to some examples, the method includes determining action(s) from a policy at block 6402. For example, the robotic control system 2300 illustrated in FIG. 23 may determine action(s) from the policy. The next action(s) may be based on the policy along with observations, current robot state, current object state, and sensor data 2422. The determination may be made through the process for determining an action from a policy 6500 illustrated in FIG. 65.

In one embodiment, strategies may incorporate a reward or penalty 6412 in determining action(s) from a policy at block 6402. These rewards or penalties 6412 may primarily be used for training the reinforcement learning model and, in some embodiments, may not apply to ongoing operation of the robot. Training the reinforcement learning model may be performed using simulations or by recording the model input/output/rewards/penalties during robot operation. Recorded data may be used to train reinforcement learning models to choose actions that maximize rewards and minimize penalties. In some embodiments, rewards or penalties 6412 for object pickup using reinforcement learning may include:
Small penalty added every second
Reward when target object(s) first touches edge of scoop
Reward when target object(s) pushed fully into scoop
Penalty when target object(s) lost from scoop
Penalty for collision with obstacle or wall (exceeding force feedback maximum)
Penalty for picking up non-target object
Penalty if robot gets stuck or drives over object

In some embodiments, rewards or penalties 6412 for object isolation (e.g., moving target object(s) away from a wall to the right) using reinforcement learning may include:
Small penalty added every second
Reward when right pusher pad arm is in-between target object(s) and wall
Reward when target object(s) distance from wall exceeds ten centimeters
Penalty for incorrectly colliding with target object(s)
Penalty for collision with obstacle or wall (exceeding force feedback maximum)
Penalty if robot gets stuck or drives over object

In some embodiments, rewards or penalties 6412 for object dropping using reinforcement learning may include:
Small penalty added every second
Reward when robot correctly docks against bin
Reward when target object(s) is successfully dropped into bin
Penalty for collision that moves bin
Penalty for collision with obstacle or wall (exceeding force feedback maximum)
Penalty if robot gets stuck or drives over object

In at least one embodiment, techniques described herein may use a reinforcement learning approach where the problem is modeled as a Markov decision process (MDP) represented as a tuple (S, O, A, P, r, γ), where S is the set of states in the environment, O is the set of observations, A is the set of actions, P: S×A×S→ [symbol] is the state transition probability function, r: S×A→ [symbol] is the reward function, and γ is a discount factor.

In at least one embodiment, the goal of training may be to learn a deterministic policy π: O→A such that taking action aₜ=π(oₜ) at time t maximizes the sum of discounted future rewards from state sₜ:

$${R}_{t} = {\sum }_{i = t}^{∞} {γ}^{i - t} r ( {s}_{i} , {a}_{i} )$$

In at least one embodiment, after taking action aₜ, the environment transitions from state sₜ, to state sₜ₊₁ by sampling from P. In at least one embodiment, the quality of taking action at in state sₜ is measured by Q(sₜ, aₜ)= [symbol] [Rₜ|sₜ, aₜ], known as the Q-function.

In one embodiment, data from a movement collision avoidance system 6414 may be used in determining action(s) from a policy at block 6402. Each strategy may have an associated list of available actions which it may consider. A strategy may use the movement collision avoidance system to determine the range of motion for each action involved in executing the strategy. For example, the movement collision avoidance system may be used to see if the scoop may be lowered to the ground without hitting the pusher pad arms or pusher pads (if they are closed under the scoop), an obstacle such as a nearby wall, or an object (like a ball) that may have rolled under the scoop.

According to some examples, the method includes executing action(s) at block 6404. For example, the tidying robot 100 such as that introduced with respect to FIG. 1A may execute the action(s) determined from block 6402. The actions may be based on the observations, current robot state, current object state, and sensor data 2422. the actions may be performed through motion of the robot motors and other actuators 6410 of the tidying robot 100. The real world environment 2402 may be affected by the motion of the tidying robot 100. The changes in the environment 2402 may be detected as described with respect to FIG. 24.

According to some examples, the method includes checking progress toward a goal at block 6406. For example, the robotic control system 2300 illustrated in FIG. 23 may check the progress of the tidying robot 100 toward the goal. If this progress check determines that the goal of the strategy has been met, or that a catastrophic error has been encountered at decision block 6408, execution of the strategy will be stopped. If the goal has not been met and no catastrophic error has occurred, the strategy may return to block 6402.

FIG. 65 illustrates process for determining an action from a policy 6500 in accordance with one embodiment. The process for determining an action from a policy 6500 may take into account a strategy type 6502, and may, at block 6504 determined the available actions to be used based on the strategy type 6502. Reinforcement learning algorithms or rules based algorithms may take advantage of both simple actions and pre-defined composite actions. Examples of simple actions controlling individual actuators may include:
Moving the left pusher pad arm to a new position (rotating up or down)
Moving the left pusher pad wrist to a new position (rotating left or right)
Moving the right pusher pad arm to a new position (rotating up or down)
Moving the right pusher pad wrist to a new position (rotating left or right)
Lifting the scoop to a new position (rotating up or down)
Changing the scoop angle (with a second motor or actuator for front dropping)
Driving a left wheel
Driving a right wheel

Examples of pre-defined composite actions may include:
Driving the robot following a path to a position/waypoint
Turning the robot in place left or right
Centering the robot with respect to object(s)
Aligning pusher pad arms with objects' top/bottom/middle.
Driving forward until an object is against the edge of the scoop
Closing both pusher pad arms, pushing object(s) with a smooth motion
Lifting the scoop and pusher pad arms together while grasping object(s)
Closing both pusher pad arms, pushing object(s) with a quick tap and slight release.
Setting the scoop lightly against the floor/carpet.
Pushing the scoop down against the floor/into the carpet
Closing the pusher pad arms until resistance is encountered/pressure is applied and hold that position
Closing the pusher pad arms with vibration and left/right turning to create instability and slight bouncing of flat objects over scoop edge

At block 6508, the process for determining an action from a policy 6500 may take the list of available actions 6506 determined at block 6504, and may determine a range of motion 6512 for each action. The range of motion 6512 may be determined based on the observations, current robot state, current object state, and sensor data 2422 available to the robotic control system 2300. Action types 6510 may also be indicated to the movement collision avoidance system 6514, and the movement collision avoidance system 6514 may determine the range of motion 6512.

Block 6508 of process for determining an action from a policy 6500 may determine an observations list 6516 based on the ranges of motion 6512 determined. An example observations list 6516 may include:
Detected and categorized objects in the environment
Global or local environment map
State 1: Left arm position 20 degrees turned in
State 2: Right arm position 150 degrees turned in
State 3: Target object 15 centimeters from scoop edge
State 4: Target object 5 degrees right of center
Action 1 max range: Drive forward 1 centimeter max
Action 2 max range: Drive backward 10 centimeters max
Action 3 max range: Open left arm 70 degrees max
Action 4 max range: Open right arm 90 degrees max
Action 5 max range: Close left arm 45 degrees max
Action 6 max range: Close right arm 0 degrees max
Action 7 max range: Turn left 45 degrees max
Action 8 max range: Turn right 45 degrees max

At block 6518, a reinforcement learning model may be run based on the observations list 6516. The reinforcement learning model may return action(s) 6520 appropriate for the strategy the tidying robot 100 is attempting to complete based on the policy involved.

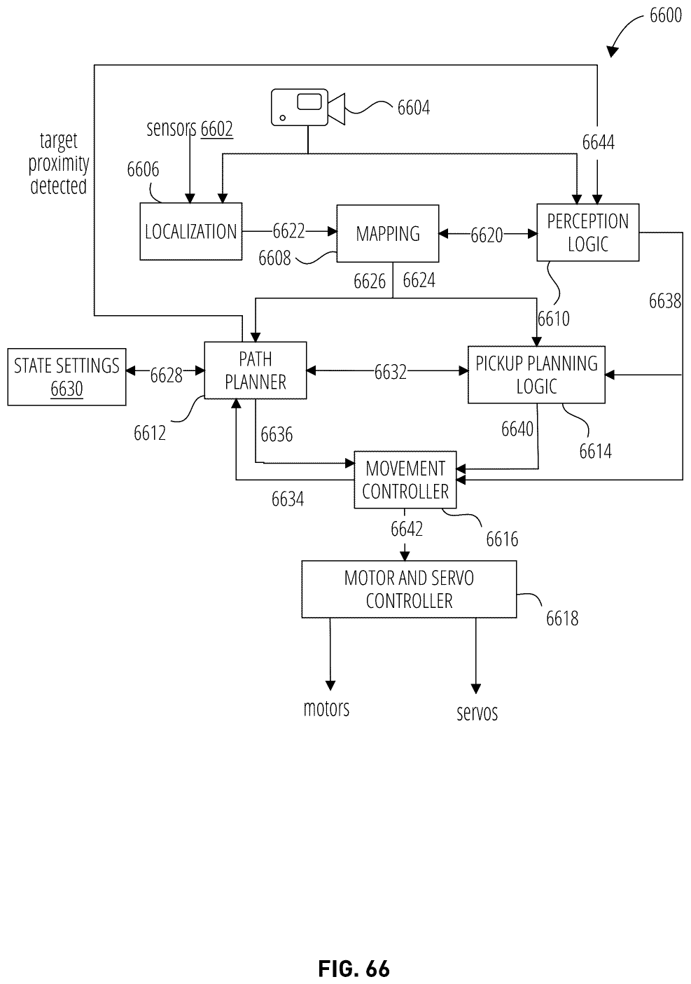

FIG. 66 depicts a robotics system 6600 in one embodiment. The robotics system 6600 receives inputs from one or more sensors 6602 and one or more cameras 6604 and provides these inputs for processing by localization logic 6606, mapping logic 6608, and perception logic 6610. Outputs of the processing logic are provided to the robotics system 6600 path planner 6612, pick-up planner 6614, and motion controller 6616, which in turn drives the system's motor and servo controller 6618.

The cameras may be disposed in a front-facing stereo arrangement, and may include a rear-facing camera or cameras as well. Alternatively, a single front-facing camera may be utilized, or a single front-facing along with a single rear-facing camera. Other camera arrangements (e.g., one or more side or oblique-facing cameras) may also be utilized in some cases.

One or more of the localization logic 6606, mapping logic 6608, and perception logic 6610 may be located and/or executed on a mobile robot, or may be executed in a computing device that communicates wirelessly with the robot, such as a cell phone, laptop computer, tablet computer, or desktop computer. In some embodiments, one or more of the localization logic 6606, mapping logic 6608, and perception logic 6610 may be located and/or executed in the “cloud”, i.e., on computer systems coupled to the robot via the Internet or other network.

The perception logic 6610 is engaged by an image segmentation activation 6644 signal, and utilizes any one or more of well-known image segmentation and objection recognition algorithms to detect objects in the field of view of the camera 6604. The perception logic 6610 may also provide calibration and objects 6620 signals for mapping purposes. The localization logic 6606 uses any one or more of well-known algorithms to localize the mobile robot in its environment. The localization logic 6606 outputs a local to global transform 6622 reference frame transformation and the mapping logic 6608 combines this with the calibration and objects 6620 signals to generate an environment map 6624 for the pick-up planner 6614, and object tracking 6626 signals for the path planner 6612.

In addition to the object tracking 6626 signals from the mapping logic 6608, the path planner 6612 also utilizes a current state 6628 of the system from the system state settings 6630, synchronization signals 6632 from the pick-up planner 6614, and movement feedback 6634 from the motion controller 6616. The path planner 6612 transforms these inputs into navigation waypoints 6636 that drive the motion controller 6616. The pick-up planner 6614 transforms local perception with image segmentation 6638 inputs from the perception logic 6610, the 6624 from the mapping logic 6608, and synchronization signals 6632 from the path planner 6612 into manipulation actions 6640 (e.g., of robotic graspers, scoops) to the motion controller 6616. Embodiments of algorithms utilized by the path planner 6612 and pick-up planner 6614 are described in more detail below.

In one embodiment simultaneous localization and mapping (SLAM) algorithms may be utilized to generate the global map and localize the robot on the map simultaneously. A number of SLAM algorithms are known in the art and commercially available.

The motion controller 6616 transforms the navigation waypoints 6636, manipulation actions 6640, and local perception with image segmentation 6638 signals to target movement 6642 signals to the motor and servo controller 6618.

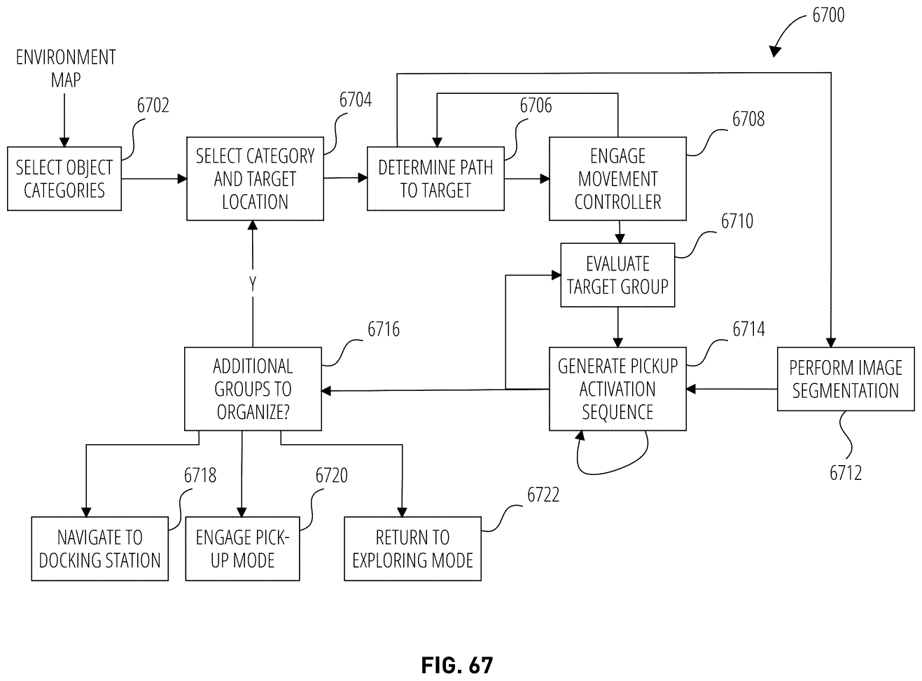

FIG. 67 depicts a robotic control algorithm 6700 for a robotic system in one embodiment. The robotic control algorithm 6700 begins by selecting one or more category of objects to organize (block 6702). Within the selected category or categories, a grouping is identified that determines a target category and starting location for the path (block 6704). Any of a number of well-known clustering algorithms may be utilized to identify object groupings within the category or categories.

A path is formed to the starting goal location, the path comprising zero or more waypoints (block 6706). Movement feedback is provided back to the path planning algorithm. The waypoints may be selected to avoid static and/or dynamic (moving) obstacles (objects not in the target group and/or category). The robot's movement controller is engaged to follow the waypoints to the target group (block 6708). The target group is evaluated upon achieving the goal location, including additional qualifications to determine if it may be safely organized (block 6710).

The robot's perception system is engaged (block 6712) to provide image segmentation for determination of a sequence of activations generated for the robot's manipulators (e.g., arms) and positioning system (e.g., wheels) to organize the group (block 6714). The sequencing of activations is repeated until the target group is organized, or fails to organize (failure causing regression to block 6710). Engagement of the perception system may be triggered by proximity to the target group. Once the target group is organized, and on condition that there is sufficient battery life left for the robot and there are more groups in the category or categories to organize, these actions are repeated (block 6716).

In response to low battery life the robot navigates back to the docking station to charge (block 6718). However, if there is adequate battery life, and on condition that the category or categories are organized, the robot enters object pick-up mode (block 6720), and picks up one of the organized groups for return to the drop-off container. Entering pickup mode may also be conditioned on the environment map comprising at least one drop-off container for the target objects, and the existence of unobstructed objects in the target group for pick-up. On condition that no group of objects is ready for pick up, the robot continues to explore the environment (block 6722).

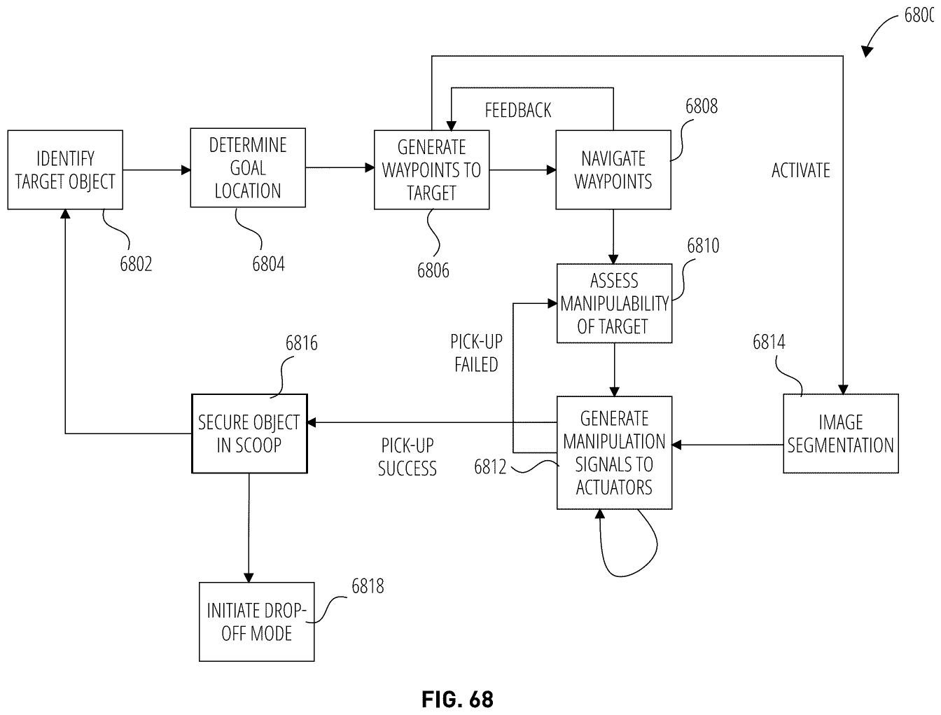

FIG. 68 depicts a robotic control algorithm 6800 for a robotic system in one embodiment. A target object in the chosen object category is identified (block 6802) and a goal location for the robot is determined as an adjacent location of the target object (block 6804). A path to the target object is determined as a series of waypoints (block 6806) and the robot is navigated along the path while avoiding obstacles (block 6808).

Once the adjacent location is reached, as assessment of the target object is made to determine if may be safely manipulated (block 6810). On condition that the target object may be safely manipulated, the robot is operated to lift the object using the robot's manipulator arm, e.g., scoop (block 6812). The robot's perception module may by utilized at this time to analyze the target object and nearby objects to better control the manipulation (block 6814).

The target object, once on the scoop or other manipulator arm, is secured (block 6816). On condition that the robot does not have capacity for more objects, or it's the last object of the selected category(ies), object drop-off mode is initiated (block 6818). Otherwise the robot may begin the process again (6802).

The following figures set forth, without limitation, exemplary cloud-based systems that may be used to implement at least one embodiment.

In at least one embodiment, cloud computing is a style of computing in which dynamically scalable and often virtualized resources are provided as a service over the Internet. In at least one embodiment, users need not have knowledge of, expertise in, or control over technology infrastructure, which may be referred to as “in the cloud,” that supports them. In at least one embodiment, cloud computing incorporates infrastructure as a service, platform as a service, software as a service, and other variations that have a common theme of reliance on the Internet for satisfying the computing needs of users. In at least one embodiment, a typical cloud deployment, such as in a private cloud (e.g., enterprise network), or a data center in a public cloud (e.g., Internet) may consist of thousands of servers (or alternatively, virtual machines (VMs)), hundreds of Ethernet, Fiber Channel or Fiber Channel over Ethernet (FCoE) ports, switching and storage infrastructure, etc. In at least one embodiment, cloud may also consist of network services infrastructure like IPsec virtual private network (VPN) hubs, firewalls, load balancers, wide area network (WAN) optimizers etc. In at least one embodiment, remote subscribers may access cloud applications and services securely by connecting via a VPN tunnel, such as an IPsec VPN tunnel.

In at least one embodiment, cloud computing is a model for enabling convenient, on-demand network access to a shared pool of configurable computing resources (e.g., networks, servers, storage, applications, and services) that may be rapidly provisioned and released with minimal management effort or service provider interaction.

In at least one embodiment, cloud computing is characterized by on-demand self-service, in which a consumer may unilaterally provision computing capabilities, such as server time and network storage, as needed automatically without needing human interaction with each service's provider. In at least one embodiment, cloud computing is characterized by broad network access, in which capabilities are available over a network and accessed through standard mechanisms that promote use by heterogeneous thin or thick client platforms (e.g., mobile phones, laptops, and personal digital assistants (PDAs)). In at least one embodiment, cloud computing is characterized by resource pooling, in which a provider's computing resources are pooled to serve multiple consumers using a multi-tenant model, with different physical and virtual resources dynamically assigned and reassigned according to consumer demand. In at least one embodiment, there is a sense of location independence in that a customer generally has no control or knowledge over an exact location of provided resources, but may be able to specify location at a higher level of abstraction (e.g., country, state, or datacenter). In at least one embodiment, examples of resources include storage, processing, memory, network bandwidth, and virtual machines. In at least one embodiment, cloud computing is characterized by rapid elasticity, in which capabilities may be rapidly and elastically provisioned, in some cases automatically, to quickly scale out and rapidly released to quickly scale in. In at least one embodiment, to a consumer, capabilities available for provisioning often appear to be unlimited and may be purchased in any quantity at any time. In at least one embodiment, cloud computing is characterized by measured service, in which cloud systems automatically control and optimize resource use by leveraging a metering capability at some level of abstraction appropriate to a type of service (e.g., storage, processing, bandwidth, and active user accounts). In at least one embodiment, resource usage may be monitored, controlled, and reported providing transparency for both a provider and consumer of a utilized service.

In at least one embodiment, cloud computing may be associated with various services. In at least one embodiment, cloud Software as a Service (SaaS) may refer to a service in which a capability provided to a consumer is to use a provider's applications running on a cloud infrastructure. In at least one embodiment, applications are accessible from various client devices through a thin client interface such as a web browser (e.g., web-based email). In at least one embodiment, the consumer does not manage or control underlying cloud infrastructure including network, servers, operating systems, storage, or even individual application capabilities, with a possible exception of limited user-specific application configuration settings.

In at least one embodiment, cloud Platform as a Service (PaaS) may refer to a service in which capability is provided to a consumer to deploy onto the cloud infrastructure consumer-created or acquired applications created using programming languages and tools supported by a provider. In at least one embodiment, a consumer does not manage or control underlying cloud infrastructure including networks, servers, operating systems, or storage, but has control over deployed applications and possibly application hosting environment configurations.

In at least one embodiment, cloud Infrastructure as a Service (IaaS) may refer to a service in which a capability provided to a consumer is to provision processing, storage, networks, and other fundamental computing resources where a consumer is able to deploy and run arbitrary software, which may include operating systems and applications. In at least one embodiment, a consumer does not manage or control underlying cloud infrastructure, but has control over operating systems, storage, deployed applications, and possibly limited control of select networking components (e.g., host firewalls).

In at least one embodiment, cloud computing may be deployed in various ways. In at least one embodiment, a private cloud may refer to a cloud infrastructure that is operated solely for an organization. In at least one embodiment, a private cloud may be managed by an organization or a third party and may exist on-premises or off-premises. In at least one embodiment, a community cloud may refer to a cloud infrastructure that is shared by several organizations and supports a specific community that has shared concerns (e.g., mission, security, policy, and compliance considerations). In at least one embodiment, a community cloud may be managed by organizations or a third party and may exist on-premises or off-premises. In at least one embodiment, a public cloud may refer to a cloud infrastructure that is made available to the general public or a large industry group and is owned by an organization providing cloud services. In at least one embodiment, a hybrid cloud may refer to a cloud infrastructure that is a composition of two or more clouds (private, community, or public) that remain unique entities but are bound together by standardized or proprietary technology that supports data and application portability (e.g., cloud bursting for load-balancing between clouds). In at least one embodiment, a cloud computing environment is service-oriented with a focus on statelessness, low coupling, modularity, and semantic interoperability.

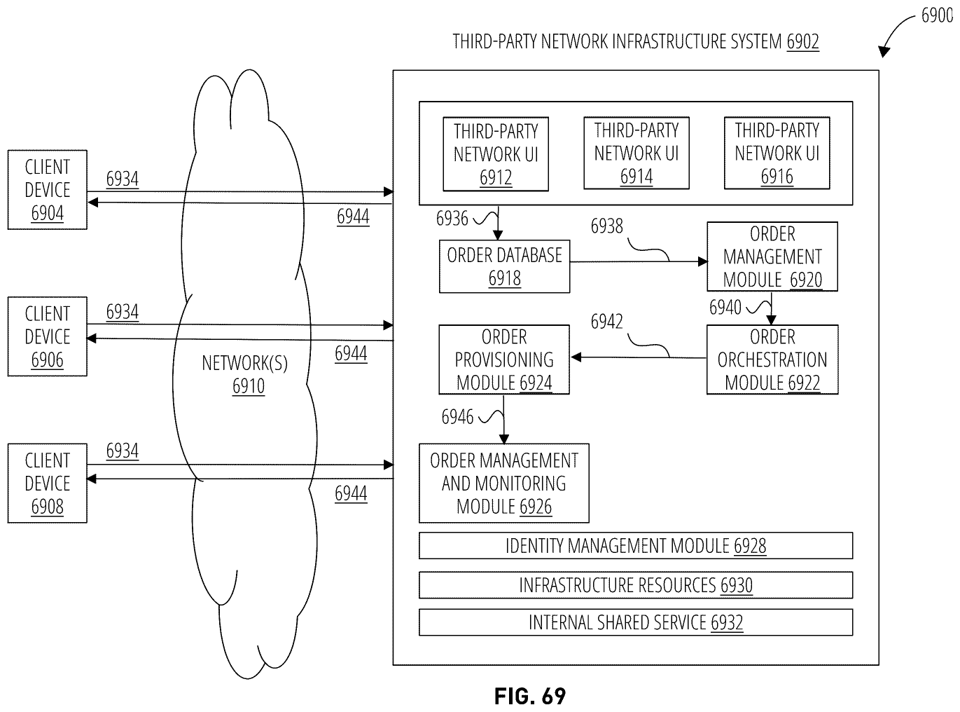

FIG. 69 illustrates one or more components of a system environment 6900 in which services may be offered as third-party network services, in accordance with at least one embodiment. In at least one embodiment, a third-party network may be referred to as a cloud, cloud network, cloud computing network, and/or variations thereof. In at least one embodiment, system environment 6900 includes one or more client computing devices 6904, 6906, and 6908 that may be used by users to interact with a third-party network infrastructure system 6902 that provides third-party network services, which may be referred to as cloud computing services. In at least one embodiment, third-party network infrastructure system 6902 may comprise one or more computers and/or servers.

It may be appreciated that third-party network infrastructure system 6902 depicted in FIG. 69 may have other components than those depicted. Further, FIG. 69 depicts an embodiment of a third-party network infrastructure system. In at least one embodiment, third-party network infrastructure system 6902 may have more or fewer components than depicted in FIG. 69, may combine two or more components, or may have a different configuration or arrangement of components.

In at least one embodiment, client computing devices 6904, 6906, and 6908 may be configured to operate a client application such as a web browser, a proprietary client application, or some other application, which may be used by a user of a client computing device to interact with third-party network infrastructure system 6902 to use services provided by third-party network infrastructure system 6902. Although exemplary system environment 6900 is shown with three client computing devices, any number of client computing devices may be supported. In at least one embodiment, other devices such as devices with sensors, etc. may interact with third-party network infrastructure system 6902. In at least one embodiment, network 6910 may facilitate communications and exchange of data between client computing devices 6904, 6906, and 6908 and third-party network infrastructure system 6902.

In at least one embodiment, services provided by third-party network infrastructure system 6902 may include a host of services that are made available to users of a third-party network infrastructure system on demand. In at least one embodiment, various services may also be offered including, without limitation, online data storage and backup solutions, Web-based e-mail services, hosted office suites and document collaboration services, database management and processing, managed technical support services, and/or variations thereof. In at least one embodiment, services provided by a third-party network infrastructure system may dynamically scale to meet the needs of its users.

In at least one embodiment, a specific instantiation of a service provided by third-party network infrastructure system 6902 may be referred to as a “service instance.” In at least one embodiment, in general, any service made available to a user via a communication network, such as the Internet, from a third-party network service provider's system is referred to as a “third-party network service.” In at least one embodiment, in a public third-party network environment, servers and systems that make up a third-party network service provider's system are different from a customer's own on-premises servers and systems. In at least one embodiment, a third-party network service provider's system may host an application, and a user may, via a communication network such as the Internet, on demand, order and use an application.

In at least one embodiment, a service in a computer network third-party network infrastructure may include protected computer network access to storage, a hosted database, a hosted web server, a software application, or other service provided by a third-party network vendor to a user. In at least one embodiment, a service may include password-protected access to remote storage on a third-party network through the Internet. In at least one embodiment, a service may include a web service-based hosted relational database and a script-language middleware engine for private use by a networked developer. In at least one embodiment, a service may include access to an email software application hosted on a third-party network vendor's website.

In at least one embodiment, third-party network infrastructure system 6902 may include a suite of applications, middleware, and database service offerings that are delivered to a customer in a self-service, subscription-based, elastically scalable, reliable, highly available, and secure manner. In at least one embodiment, third-party network infrastructure system 6902 may also provide “big data” related computation and analysis services. In at least one embodiment, the term “big data” is generally used to refer to extremely large data sets that may be stored and manipulated by analysts and researchers to visualize large amounts of data, detect trends, and/or otherwise interact with data. In at least one embodiment, big data and related applications may be hosted and/or manipulated by an infrastructure system on many levels and at different scales. In at least one embodiment, tens, hundreds, or thousands of processors linked in parallel may act upon such data in order to present it or simulate external forces on data or what it represents. In at least one embodiment, these data sets may involve structured data, such as that organized in a database or otherwise according to a structured model, and/or unstructured data (e.g., emails, images, data blobs (binary large objects), web pages, complex event processing). In at least one embodiment, by leveraging the ability of an embodiment to relatively quickly focus more (or fewer) computing resources upon an objective, a third-party network infrastructure system may be better available to carry out tasks on large data sets based on demand from a business, government agency, research organization, private individual, group of like-minded individuals or organizations, or other entity.

In at least one embodiment, third-party network infrastructure system 6902 may be adapted to automatically provision, manage and track a customer's subscription to services offered by third-party network infrastructure system 6902. In at least one embodiment, third-party network infrastructure system 6902 may provide third-party network services via different deployment models. In at least one embodiment, services may be provided under a public third-party network model in which third-party network infrastructure system 6902 is owned by an organization selling third-party network services, and services are made available to the general public or different industry enterprises. In at least one embodiment, services may be provided under a private third-party network model in which third-party network infrastructure system 6902 is operated solely for a single organization and may provide services for one or more entities within an organization. In at least one embodiment, third-party network services may also be provided under a community third-party network model in which third-party network infrastructure system 6902 and services provided by third-party network infrastructure system 6902 are shared by several organizations in a related community. In at least one embodiment, third-party network services may also be provided under a hybrid third-party network model, which is a combination of two or more different models.

In at least one embodiment, services provided by third-party network infrastructure system 6902 may include one or more services provided under Software as a Service (Saas) category, Platform as a Service (PaaS) category, Infrastructure as a Service (IaaS) category, or other categories of services including hybrid services. In at least one embodiment, a customer, via a subscription order, may order one or more services provided by third-party network infrastructure system 6902. In at least one embodiment, third-party network infrastructure system 6902 then performs processing to provide services in a customer's subscription order.

In at least one embodiment, services provided by third-party network infrastructure system 6902 may include, without limitation, application services, platform services, and infrastructure services. In at least one embodiment, application services may be provided by a third-party network infrastructure system via a SaaS platform. In at least one embodiment, the SaaS platform may be configured to provide third-party network services that fall under the SaaS category. In at least one embodiment, the SaaS platform may provide capabilities to build and deliver a suite of on-demand applications on an integrated development and deployment platform. In at least one embodiment, the SaaS platform may manage and control underlying software and infrastructure for providing SaaS services. In at least one embodiment, by utilizing services provided by a SaaS platform, customers may utilize applications executing on a third-party network infrastructure system. In at least one embodiment, customers may acquire application services without a need for customers to purchase separate licenses and support. In at least one embodiment, various different SaaS services may be provided. In at least one embodiment, examples include, without limitation, services that provide solutions for sales performance management, enterprise integration, and business flexibility for large organizations.

In at least one embodiment, platform services may be provided by third-party network infrastructure system 6902 via a PaaS platform. In at least one embodiment, the PaaS platform may be configured to provide third-party network services that fall under the PaaS category. In at least one embodiment, examples of platform services may include without limitation services that allow organizations to consolidate existing applications on a shared, common architecture, as well as an ability to build new applications that leverage shared services provided by a platform. In at least one embodiment, the PaaS platform may manage and control underlying software and infrastructure for providing PaaS services. In at least one embodiment, customers may acquire PaaS services provided by third-party network infrastructure system 6902 without a need for customers to purchase separate licenses and support.

In at least one embodiment, by utilizing services provided by a PaaS platform, customers may employ programming languages and tools supported by a third-party network infrastructure system and also control deployed services. In at least one embodiment, platform services provided by a third-party network infrastructure system may include database third-party network services, middleware third-party network services, and third-party network services. In at least one embodiment, database third-party network services may support shared service deployment models that allow organizations to pool database resources and offer customers a Database as a Service in the form of a database third-party network. In at least one embodiment, middleware third-party network services may provide a platform for customers to develop and deploy various business applications, and third-party network services may provide a platform for customers to deploy applications, in a third-party network infrastructure system.

In at least one embodiment, various different infrastructure services may be provided by an IaaS platform in a third-party network infrastructure system. In at least one embodiment, infrastructure services facilitate management and control of underlying computing resources, such as storage, networks, and other fundamental computing resources for customers utilizing services provided by a SaaS platform and a PaaS platform.

In at least one embodiment, third-party network infrastructure system 6902 may also include infrastructure resources 6930 for providing resources used to provide various services to customers of a third-party network infrastructure system. In at least one embodiment, infrastructure resources 6930 may include pre-integrated and optimized combinations of hardware, such as servers, storage, and networking resources to execute services provided by a PaaS platform and a SaaS platform, and other resources.

In at least one embodiment, resources in third-party network infrastructure system 6902 may be shared by multiple users and dynamically re-allocated per demand. In at least one embodiment, resources may be allocated to users in different time zones. In at least one embodiment, third-party network infrastructure system 6902 may allow a first set of users in a first time zone to utilize resources of a third-party network infrastructure system for a specified number of hours and then allow a re-allocation of the same resources to another set of users located in a different time zone, thereby maximizing utilization of resources.

In at least one embodiment, a number of internal shared services 6932 may be provided that are shared by different components or modules of third-party network infrastructure system 6902 to support the provision of services by third-party network infrastructure system 6902. In at least one embodiment, these internal shared services may include, without limitation, a security and identity service, an integration service, an enterprise repository service, an enterprise manager service, a virus scanning and white list service, a high availability, backup and recovery service, service for enabling third party network support, an email service, a notification service, a file transfer service, and/or variations thereof.

In at least one embodiment, third-party network infrastructure system 6902 may provide comprehensive management of third-party network services (e.g., SaaS, PaaS, and IaaS services) in a third-party network infrastructure system. In at least one embodiment, third-party network management functionality may include capabilities for provisioning, managing, and tracking a customer's subscription received by third-party network infrastructure system 6902, and/or variations thereof.

In at least one embodiment, as depicted in FIG. 69, third-party network management functionality may be provided by one or more modules, such as an order management module 6920, an order orchestration module 6922, an order provisioning module 6924, an order management and monitoring module 6926, and an identity management module 6928. In at least one embodiment, these modules may include or be provided using one or more computers and/or servers, which may be general-purpose computers, specialized server computers, server farms, server clusters, or any other appropriate arrangement and/or combination.

In at least one embodiment, at a service request step 6934, a customer using a client device, such as client computing devices 6904, 6906, or 6908, may interact with third-party network infrastructure system 6902 by requesting one or more services provided by third-party network infrastructure system 6902 and placing an order for a subscription for one or more services offered by third-party network infrastructure system 6902. In at least one embodiment, a customer may access a third-party network User Interface (UI) such as third-party network UI 6912, third-party network UI 6914, and/or third-party network UI 6916 and place a subscription order via these UIs. In at least one embodiment, order information received by third-party network infrastructure system 6902 in response to a customer placing an order may include information identifying a customer and one or more services offered by a third-party network infrastructure system 6902 that a customer intends to subscribe to.

In at least one embodiment, at a storing information step 6936, order information received from a customer may be stored in an order database 6918. In at least one embodiment, if this is a new order, a new record may be created for an order. In at least one embodiment, order database 6918 may be one of several databases operated by third-party network infrastructure system 6902 and operated in conjunction with other system elements.

In at least one embodiment, at a forwarding information step 6938, order information may be forwarded to an order management module 6920 that may be configured to perform billing and accounting functions related to an order, such as verifying an order, and upon verification, booking an order.

In at least one embodiment, at a communicating information step 6940, information regarding an order may be communicated to an order orchestration module 6922 that is configured to orchestrate the provisioning of services and resources for an order placed by a customer. In at least one embodiment, order orchestration module 6922 may use services of order provisioning module 6924 for provisioning. In at least one embodiment, order orchestration module 6922 supports the management of business processes associated with each order and applies business logic to determine whether an order may proceed to provisioning.

In at least one embodiment, at a receiving a new order step 6942, upon receiving an order for a new subscription, order orchestration module 6922 sends a request to order provisioning module 6924 to allocate resources and configure resources needed to fulfill a subscription order. In at least one embodiment, an order provisioning module 6924 supports an allocation of resources for services ordered by a customer. In at least one embodiment, an order provisioning module 6924 provides a level of abstraction between third-party network services provided by third-party network infrastructure system 6902 and a physical implementation layer that is used to provision resources for providing requested services. In at least one embodiment, this allows order orchestration module 6922 to be isolated from implementation details, such as whether or not services and resources are actually provisioned in real-time or pre-provisioned and allocated/assigned upon request.

In at least one embodiment, at a service provided step 6944, once services and resources are provisioned, a notification may be sent to subscribing customers indicating that a requested service is now ready for use. In at least one embodiment, information (e.g., a link) may be sent to a customer that allows a customer to start using the requested services.

In at least one embodiment, at a notification step 6946, a customer's subscription order may be managed and tracked by an order management and monitoring module 6926. In at least one embodiment, order management and monitoring module 6926 may be configured to collect usage statistics regarding a customer's use of subscribed services. In at least one embodiment, statistics may be collected for the amount of storage used, the amount of data transferred, the number of users, the amount of system up time and system down time, and/or variations thereof.

In at least one embodiment, third-party network infrastructure system 6902 may include an identity management module 6928 that is configured to provide identity services, such as access management and authorization services in third-party network infrastructure system 6902. In at least one embodiment, identity management module 6928 may control information about customers who wish to utilize services provided by third-party network infrastructure system 6902. In at least one embodiment, such information may include information that authenticates the identities of such customers and information that describes which actions those customers are authorized to perform relative to various system resources (e.g., files, directories, applications, communication ports, memory segments, etc.). In at least one embodiment, identity management module 6928 may also include management of descriptive information about each customer and about how and by whom that descriptive information may be accessed and modified.

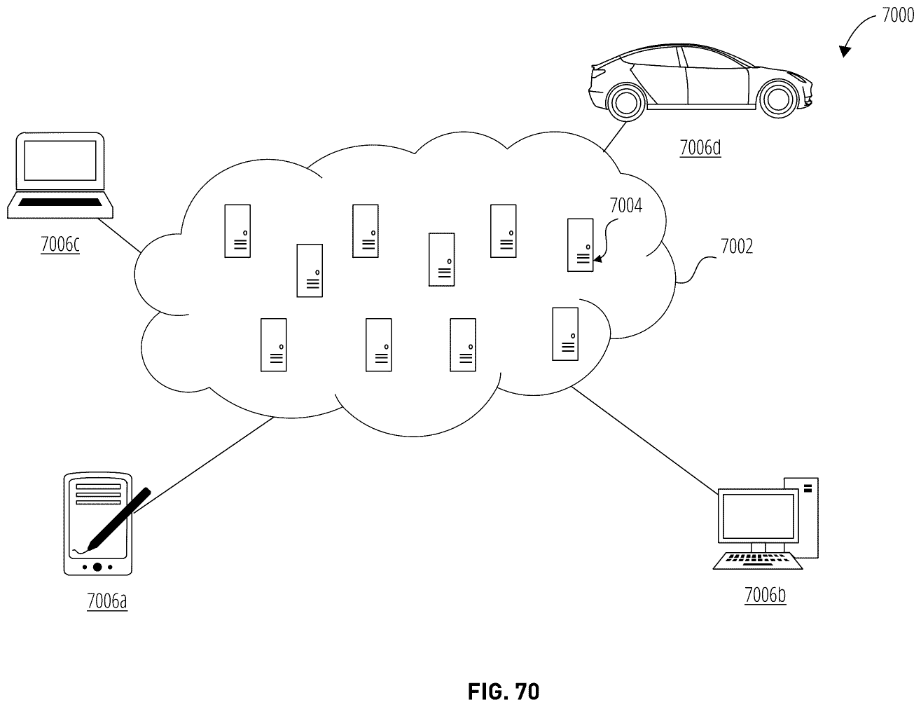

FIG. 70 illustrates a computing environment 7000 including cloud computing environment 7002, in accordance with at least one embodiment. In at least one embodiment, cloud computing environment 7002 comprises one or more cloud servers 7004 with which computing devices such as, personal digital assistant (PDA) or computing device 7006a, computing device 7006b, computing device 7006c, and/or computing device 7006d communicate. In at least one embodiment, this allows for infrastructure, platforms, and/or software to be offered as services from cloud computing environment 7002, so as to not require each client to separately maintain such resources. It is understood that the types of computing devices 7006a-7006d shown in FIG. 70 (a mobile or handheld device, a desktop computer, a laptop computer, and an automobile computer system) are intended to be illustrative, and that cloud computing environment 7002 may communicate with any type of computerized device over any type of network and/or network/addressable connection (e.g., using a web browser).

In at least one embodiment, a cloud server 7004, which may be denoted as a cloud computing node, is operational with numerous other general purpose or special purpose computing system environments or configurations. In at least one embodiment, examples of computing systems, environments, and/or configurations that may be suitable for use with cloud server 7004 include, but are not limited to, personal computer systems, server computer systems, thin clients, thick clients, hand-held or laptop devices, multiprocessor systems, microprocessor-based systems, set-top boxes, programmable consumer electronics, network personal computers (PCs), minicomputer systems, mainframe computer systems, and distributed cloud computing environments that include any of the above systems or devices, and/or variations thereof.

In at least one embodiment, cloud server 7004 may be described in a general context of computer system-executable instructions, such as program modules, being executed by a computer system. In at least one embodiment, program modules include routines, programs, objects, components, logic, data structures, and so on, that perform particular tasks or implement particular abstract data types. In at least one embodiment, an exemplary cloud server 7004 may be practiced in distributed cloud computing environments where tasks are performed by remote processing devices that are linked through a communications network. In at least one embodiment, in a distributed cloud computing environment, program modules may be located in both local and remote computer system storage media including memory storage devices.

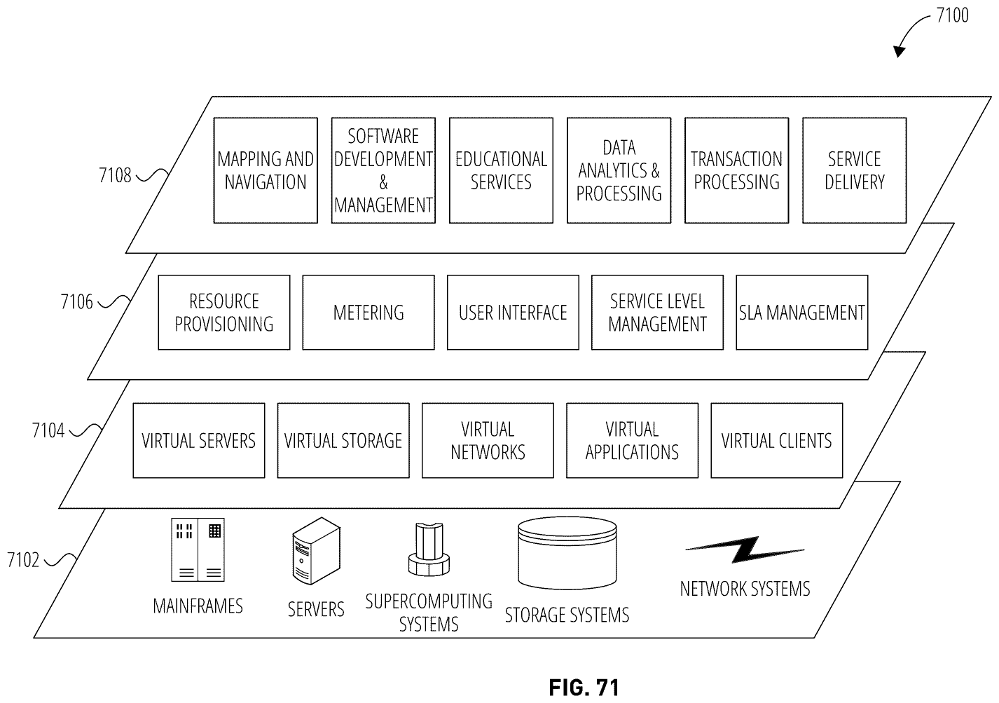

FIG. 71 illustrates a set of functional abstraction layers 7100 provided by cloud computing environment 7002 (FIG. 70), in accordance with at least one embodiment. It may be understood in advance that the components, layers, and functions shown in FIG. 71 are intended to be illustrative, and components, layers, and functions may vary.

In at least one embodiment, hardware and software layer 7102 includes hardware and software components. In at least one embodiment, examples of hardware components include mainframes, various RISC (Reduced Instruction Set Computer) architecture-based servers, various computing systems, supercomputing systems, storage devices, networks, networking components, and/or variations thereof. In at least one embodiment, examples of software components include network application server software, various application server software, various database software, and/or variations thereof.

In at least one embodiment, virtualization layer 7104 provides an abstraction layer from which the following exemplary virtual entities may be provided: virtual servers, virtual storage, virtual networks, including virtual private networks, virtual applications, virtual clients, and/or variations thereof.

In at least one embodiment, management layer 7106 provides various functions. In at least one embodiment, resource provisioning provides dynamic procurement of computing resources and other resources that are utilized to perform tasks within a cloud computing environment. In at least one embodiment, metering provides usage tracking as resources are utilized within a cloud computing environment, and billing or invoicing for consumption of these resources. In at least one embodiment, resources may comprise application software licenses. In at least one embodiment, security provides identity verification for users and tasks, as well as protection for data and other resources. In at least one embodiment, a user interface provides access to a cloud computing environment for both users and system administrators. In at least one embodiment, service level management provides cloud computing resource allocation and management such that the needed service levels are met. In at least one embodiment, Service Level Agreement (SLA) management provides pre-arrangement for, and procurement of, cloud computing resources for which a future need is anticipated in accordance with an SLA.

In at least one embodiment, workloads layer 7108 provides functionality for which a cloud computing environment is utilized. In at least one embodiment, examples of workloads and functions which may be provided from this layer include mapping and navigation, software development and management, educational services, data analytics and processing, transaction processing, and service delivery.

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure may be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed field programmable gate array (FPGA), for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” may be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the disclosure as claimed. The scope of inventive subject matter is not limited to the depicted embodiments but is rather set forth in the following Claims.

What is claimed is:

1. A scoop for a tidying robot, the scoop comprising:
a scoop base configured to couple to a scoop arm on the tidying robot;
a scoop back secured to the scoop base;
a scoop bottom including an expandable scoop bottom, secured to the scoop base; and
a scoop bottom linear actuator configured to extend or retract at least one side of the expandable scoop bottom.

2. The scoop of claim 1, further comprising at least one foldable scoop wall, attached to the expandable scoop bottom; and
a scoop side actuator configured to rotate the at least one foldable scoop wall to a position above or below the expandable scoop bottom.

3. The scoop of claim 1, further comprising a scoop lip along at least a portion of a front of the scoop bottom.

4. The scoop of claim 1, further comprising a scoop front forward pushing linear actuator configured to push at least a front portion of the expandable scoop bottom toward the front of the scoop.

5. The scoop of claim 4, the scoop bottom further including a structural scoop bottom, and a central expandable scoop bottom, the structural scoop bottom attached to the scoop base, wherein the structural scoop bottom is configured to slidably interface with the central expandable scoop bottom and the at least one side expandable scoop bottom.

6. The scoop of claim 5, wherein the scoop front forward pushing linear actuator is configured to push the central expandable scoop bottom and the at least one side expandable scoop bottom toward the front of the scoop.

7. The scoop of claim 5, wherein the central expandable scoop bottom and the at least one side expandable scoop bottom include a rack and pinion gear system allowing the central expandable scoop bottom and the at least one side expandable scoop bottom to be pushed forward toward the front of the scoop.

8. The scoop of claim 1, wherein the scoop back is an expandable scoop back, the scoop bottom linear actuator configured to also extend or retract at least one side of the expandable scoop back.

9. The scoop of claim 8, the scoop back including a static scoop back and the expandable scoop back, the static scoop back secured to the scoop base, wherein the static scoop back is configured to slidably interface with the expandable scoop back.

10. A method comprising:
extending a scoop bottom of a scoop for a tidying robot by actuating a scoop bottom linear actuator,
the scoop comprising:
a scoop base configured to couple to a scoop arm on the tidying robot;
a scoop back secured to the scoop base;
the scoop bottom including an expandable scoop bottom, secured to the scoop base; and
the scoop bottom linear actuator configured to extend or retract at least one side of the expandable scoop bottom.

11. The method of claim 10, further comprising rotating an at least one foldable scoop wall, using a scoop side actuator, to a position above or below the expandable scoop bottom,
the scoop further comprising:
the at least one foldable scoop wall, attached to the expandable scoop bottom; and
the scoop side actuator configured to rotate the at least one foldable scoop wall.

12. The method of claim 10, further comprising pushing at least a front portion of the expandable scoop bottom toward the front of the scoop by activating a scoop front forward pushing linear actuator,
the scoop further comprising: the scoop front forward pushing linear actuator.

13. The method of claim 10, pushing at least a front portion of the expandable scoop bottom and a central expandable scoop bottom, toward the front of the scoop by activating a scoop front forward pushing linear actuator,
the scoop further comprising: the scoop front forward pushing linear actuator, wherein the scoop front forward pushing linear actuator is configured to push the central expandable scoop bottom and the at least one side expandable scoop bottom toward the front of the scoop,
the scoop bottom further comprising:
a structural scoop bottom, and the central expandable scoop bottom, the structural scoop bottom attached to the scoop base, wherein the structural scoop bottom is configured to slidably interface with the central expandable scoop bottom and the at least one side expandable scoop bottom.

14. The method of claim 10, further comprising:
operating the scoop bottom linear actuator to extend the at least one side of the expandable scoop bottom;
loading a first object load on the at least one side of the expandable scoop bottom;
loading a second object load on a portion of the scoop bottom that has not been extended;
transporting the first object load and the second object load to a first location;
unloading the first object load at the first location;
operating the scoop bottom linear actuator to retract the at least one side of the expandable scoop bottom;
transporting the second object load to a second location; and
unloading the second object load at the second location.

15. The method of claim 14, further comprising operating a pusher pad on the tidying robot to unload the first object load at the first location.

16. A scoop for a tidying robot, the scoop comprising:
a scoop base configured to couple to a scoop arm on the tidying robot;
a scoop back including a static scoop back and an expandable scoop back, the static scoop back secured to the scoop base, wherein the static scoop back is configured to slidably interface with the expandable scoop back;
a scoop bottom including a structural scoop bottom, a central expandable scoop bottom and at least one side expandable scoop bottom, the structural scoop bottom attached to the scoop base, wherein the structural scoop bottom is configured to slidably interface with the central expandable scoop bottom and the at least one side expandable scoop bottom;
at least one foldable scoop wall, attached to the side expandable scoop bottom;
a scoop bottom and back linear actuator configured to extend or retract the at least one side expandable scoop bottom and the expandable scoop back; and
a scoop side actuator configured to rotate the at least one foldable scoop wall to a position above or below the side expandable scoop bottom.

17. The scoop of claim 16, further comprising a scoop front forward pushing linear actuator configured to push the central expandable scoop bottom and the at least one side expandable scoop bottom toward a front of the scoop.

18. The scoop of claim 17, wherein the central expandable scoop bottom and the at least one side expandable scoop bottom include a rack and pinion gear system allowing the central expandable scoop bottom and the at least one side expandable scoop bottom to be pushed forward toward the front of the scoop.
